(19) United States
(12) Patent Application Publication
(10) Pub. No.: US 2008/0057227 A1
(43) Pub. Date: Mar. 6, 2008

(54) Manufacturing method of cellulose acylate film, cellulose acylate film, polarizing plate and liquid crystal display

(75) Inventors: Takayuki Suzuki, Tokyo (JP); Norio Miura, Sagamihara-shi (JP); Kazuaki Nakamura, Kyoto-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA OPTO, INC., Tokyo (JP)

(21) Appl. No.: 11/895,734

(22) Filed: Aug. 27, 2007

(30) Foreign Application Priority Data
Sep. 1, 2006 (JP) JP2006-237564

(51) Int. Cl. C09K 19/00

(52) U.S. Cl. 428/1.1

(57) ABSTRACT

A cellulose acylate film manufacturing method based on melt-casting film formation technique, the comprising steps of: extruding a cellulose acylate film from a casting die, and sandwiching the cellulose acylate film between an elastically deformable touch roll and a cooling roll, wherein the cellulose acylate film includes at least one kind of compounds expressed by the following general formula (1) and at least one kind of phosphoric acid compounds selected from among phosphite, phosphonite, phosphinite and phosphane, 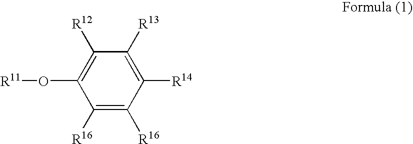
wherein R¹¹ through R¹⁶ each indicate a hydrogen atom or substituents.

### TECHNICAL FIELD

The present invention relates to a cellulose acylate film manufacturing method, a cellulose acylate film, a polarizing plate using said cellulose acylate film and a liquid crystal display apparatus.

### TECHNICAL BACKGROUND

The cellulose acylate film characterized by high transparency, low double refraction property and excellent bondability with a polarizer has been used as the supporting member of a photographic negative film as well as the optical film used for liquid crystal display such as a polarizer protecting film or a polarizing plate.

In recent years, there has been a substantial increase in the production of the liquid crystal displays for the small depth and light weight thereof, and the liquid crystal displays are now in increasing demand. Further, the TV set using the liquid crystal display is characterized by thin and light-weight configuration and the size of this TV set has increased to such a level that could not have been realized in the case of the TV set using a cathode ray tube. This has led to a growing demand for an optical film constituting the liquid crystal display.

The cellulose acylate film has been produced exclusively by the solution casting method. In the solution casting method, the solution obtained by dissolving the cellulose acylate in a solvent is cast to get a web, which is then evaporated and dried to produce a film. The film produced by the solution casting method has a high degree of flatness, and is used to produce a liquid crystal display capable of displaying a high quality image free from irregularity.

However, the solution casting method requires a large quantity of organic solvent and involves a problem of environmental load, for its dissolution characteristics, the cellulose acylate film is formed using the halogen based solvent having a great environmental load, and reduction in the amount of solvent to be used is particularly required, when this method is used. Thus, it is getting more and more difficult to increase the production of cellulose acylate films by the solution casting method.

In recent years, an attempt has been made to melt the cellulose acylate to form a silver halide photographic film (e.g. Unexamined Japanese Patent Application Publication No. 6-501040 (Tokuhyohei)) or polarizer protective film (e.g. Unexamined Japanese Patent Application Publication No. 2000-352620). However, the cellulose acylate is a polymer having a very high viscosity at the time of melting, and a high glass transition temperature. Even when the cellulose acylate is melted, is extruded through the dies, and is cast on a cooling drum or cooling belt, leveling is very difficult. Since it is cured in a short time after extrusion, the flatness of the film obtained is lower than that of the solution casting film.

A proposal has been made of a technique of manufacturing an optical film using the melt-casting film formation method, wherein a molten resin is sandwiched in a circular arc between a cooling roll kept at a uniform temperature across the width and an endless belt (e.g., the Unexamined Japanese Patent Application Publication No. H10-10321). In another proposed technique, a molten resin is sandwiched between two cooling drums (e.g., the Unexamined Japanese Patent Application Publication No. 2002-212312). However, the melt produced by heating and melting the cellulose resin has a high degree of viscosity, and therefore, the film produced by the melt-casting film formation method is less flat than that formed by the solution casting method. To put it more specifically, the die line or irregularity in thickness is likely to occur.

Further, the melting film forming method is a process of high temperature in excess of 150° C., and therefore, it involves such problems fatal to the cellulose acylate film as reduction in the processing stability or coloring based on the molecular weight resulting from the pyrolysis of the cellulose acylate. A technique of adding a certain percentage of the hindered phenol compound, hindered amine compound or acid scavenger has been disclosed as a stabilizer to enhance the stability against the deterioration of both the spectral and mechanical characteristics of the cellulose resin in an enclosed environment during the long-term use under the conditions of high temperature and high humidity (e.g., the Unexamined Japanese Patent Application Publication No. 2003-192920). A technique of using a polyvalent alcohol ester plasticizer is also disclosed as a plasticizer characterized by excellent moisture permeability and retentivity (e.g., the unexamined Japanese Patent Application Publication No. 2003-12823). However, any of these conventionally known techniques has failed to solve the aforementioned problems, especially the problem related to deterioration of the processing stability and coloring due to the reduction of molecular weight as well as the problem of flatness.

Further, the increasing size of the screen of the liquid crystal display apparatus has been requiring an increase in the width of a film web and the winding length. This requirement has resulted in a wider film web and a greater load on the film web. If such film web is stored for a long time, a trouble known by the name of “horseback failure” is likely to occur. In the horseback failure, the film web is deformed in the shape of a letter U similar to the shape of a horseback, and belt-shaped projections are produced close to the center at a pitch of about 2 through 3 cm. Since deformation remains unremoved on the film, the surface appears distorted when it is processed to a polarizing plate. Further, the cellulose acylate film placed on the outermost surface of the liquid crystal display is subjected to clear-hard processing, anti-glare processing or anti-reflection processing. If the surface of the cellulose acylate film is deformed at the time of such processing, irregular coating or evaporation will be caused, and hence the product yield rate will be reduced substantially. So far the recurrence of a horseback failure has been avoided by reducing a dynamic friction coefficient between bases or by adjusting the height in knurling (embossing) on both sides. A proposal for improvement has been made based on the finding that the horseback failure is caused by the winding core being deflected by the film load (e.g., the Unexamined Japanese Patent Application Publication No. 2002-3083). However, the requirements of the liquid crystal television set in recent years have created a demand for a cellulose acylate film of still greater width. These conventional techniques have been unable to meet the requirements. There is an active demand for more advanced technology.

In the meantime, the conventionally known composition is a resin composition containing a phosphoric acid compound and hindered phenol compound as stabilizers (e.g., the Unexamined Japanese Patent Application Publication No. 2001-261943 and International Publication No. 99/54394 (leaflet)).

However, there has been no example of applying the aforementioned stabilizer to the means of improving the flatness of the cellulose acylate film and horseback failure.

### SUMMARY OF THE INVENTION

The object of the present invention is to provide a cellulose acylate film of a high degree of uniformity characterized by minimized coloring and deterioration in processing stability, excellent flatness, and suppressed streak irregularity, and to offer a liquid crystal display of high image quality. Another object of the present invention is to provide a cellulose acylate film of high productivity wherein deformation of the film web including a horseback failure or convex failure does not occur despite long-term storage. The advantage is fully demonstrated in a thin cellulose acylate film having a width exceeding 1350 mm. Further, in the present invention, the cellulose acylate film is provided by the melting film formation method without using a halogen based solvent with heavy environmental load.

The present inventors have made efforts to solve the aforementioned problems, and have found out that, by a concurrent use of the cooling method using an elastic touch roll wherein a specific phenol compound and a specific phosphoric acid compound are contained, the manufacturing method using the melt casting method can provide a cellulose acylate film characterized by minimized coloring and deterioration in processing stability, suppressed streak irregularity, and excellent flatness, wherein this cellulose acylate film is further characterized in that deformation of the film web including a horseback failure or convex failure does not occur despite long-term storage. This finding has led to the present invention.

To be more specific, the following structure solves the aforementioned problems:

The first configuration of the present invention is a cellulose acylate film manufacturing method, comprising the steps of:

extruding a heated and melted cellulose acylate material from a casting die in a form of a film, and

sandwiching the cellulose acylate film extruded from the casting die between an elastically deformable touch roll and a cooling roll with a pressure,

wherein the cellulose acylate film material includes at least one kind of a compound represented by the following general formula (1) and at least one kind of a phosphorus compound selected from a group consisting of phosphite, phosphonite, phosphinite and phosphane.

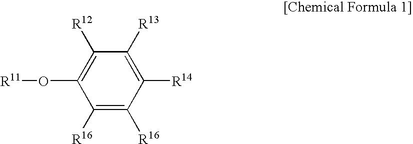

In the formula, R¹¹ through R¹⁶ each represents independently a hydrogen atom or substituents.

It is preferable that the cellulose acylate in the cellulose acylate material used in the cellulose acylate film manufacturing method has an acyl group total carbon number of 6.2 or more and 7.5 or less, wherein the acyl group total carbon number is a total of a product of the substitution degree of each acyl group substituted into a glucose unit in the cellulose acylate and the number of carbons.

The second configuration of the present invention is a cellulose acylate film manufactured by the above manufacturing method.

It is preferable that an actinic ray curable resin layer is provided on at least one surface of the cellulose acylate film, and more preferable that an antireflection layer is provided on the actinic ray curable resin layer.

The third configuration of the present invention is a polarizing plate employing the above cellulose acylate film as a polarizing plate protective film.

The fourth configuration is a liquid crystal display device employing a polarizing plate described in the fourth configuration.

### EFFECTS OF THE ABOVE CONFIGURATION OF THE INVENTION

The present invention provides a manufacturing method, a cellulose acylate film and a polarizing plate, this manufacturing method being based on the melt casting technique without using the halogen based solvent of a high environmental load, wherein this manufacturing method provides a cellulose acylate film characterized by minimized coloring and deterioration in processing stability, suppressed streak irregularity, and excellent flatness, without any deformation trouble such as a horseback failure or convex failure despite long-term storage. Further, use of this polarizing plate provides a liquid crystal display of high image quality.

### BRIEF DESCRIPTION OF THE DRAWINGS

FIG. 1 is a schematic flowchart representing an embodiment of the apparatus that embodies the manufacturing method of the cellulose acylate film according to the present invention;

FIG. 2 is a flowchart showing an enlarged view of the major portions of the manufacturing apparatus;

FIG. 3 (a) is an external view of the major portions of the casting die, and FIG. 3 (b) is a cross sectional view of the major portions of the casting die;

FIG. 4 is a cross sectional view of the first embodiment of a pressure rotary member;

FIG. 5 is a cross sectional view on the plane surface perpendicular to the rotary axis of the second embodiment of a pressure rotary member;

FIG. 6 is a cross sectional view on the plane surface including the rotary axis of the second embodiment of a pressure rotary member; and

FIG. 7 is an exploded perspective view of the schematic diagram of the liquid crystal display apparatus.

FIG. 8(a) is a perspective view of a cellulose acylate film web material which is rolled up around the winding core, FIG. 8(b) is a perspective view of a cellulose acylate film web material which is held on the counter, FIG. 8(c) is a cross sectional view of the cellulose acylate film web material which mounted on the counter.

### PREFERABLE EMBODIMENT OF THE INVENTION

The following describes the best form of the embodiment of the present invention, without the present invention being restricted thereto.

The present invention relates to a cellulose acylate film and the manufacturing method thereof, this film being formed by a melting film formation technique, and being characterized by the minimum coloring and deterioration of processing stability, and sufficient flatness without deformation trouble of a film web.

Use of the cellulose acylate film of the present invention provides such an optical film as a high quality polarizing plate protective film, anti-reflection film and phase difference film. It also provides a liquid crystal display apparatus of excellent display quality.

The optical film as an object of the present invention refers to a functional film used in various display apparatuses such as a liquid crystal display, plasma display and organic electroluminescence display—a liquid crystal display in particular. It includes a polarizing plate protective film, phase difference film, anti-reflection film, luminance enhancing film, and optical correction film for viewing angle expansion.

The present inventors have made efforts to find out that, in the film manufacturing method for manufacturing a film using the hot melting technique, namely, melt casting technique, a drastic improvement in the flatness of the cellulose acylate film to be obtained can be achieved and the coloring and deterioration of processing stability are reduced, when a specific compound is selected as the additive to be contained in the cellulose acylate, and a cooling method using an elastic touch roll is used in combination. It has also been found out that the film obtained by this manufacturing method is free from deformation problems of a film web such as horseback failure or convex failure, even when the film is stored for a long period of time.

A manufacturing method of a cellulose acylate film according to the present invention is characterized by containing a compound represented by Formula (1) as additives.

In Formula (A), R¹¹, R¹², R¹³, R¹⁴, R¹⁵ and R¹⁶ each represent a hydrogen atom or a substituent. Examples of the substituents include: a halogen atom (for example, a fluorine atom and a chlorine atom), an alkyl group (for example, a methyl group, an ethyl group, an isopropyl group, a hydroxyethyl group, a methoxy methyl group, a trifluoro methyl group and a t-butyl group), a cycloalkyl group (for example, a cyclopentyl group and a cyclohexyl group), an aralkyl group (for example, a benzyl group and a 2-phenethyl group), an aryl group (for example, a phenyl group, a naphthyl group, p-tolyl group and a p-chlorophenyl group), an alkoxy group (for example, a methoxy group, an ethoxy group, an isopropoxy group and a butoxy group), an aryloxy groups (for example, a phenoxy group), a cyano group, an acylamino group (for example, an acetylamino group and a propionylamino group), an alkylthio group (for example, a methylthio group, an ethylthio group and a butylthio group), an arylthio group (for example, a phenylthio group), a sulfonylamino group (for example, a methanesulfonylamino group and a benzene sulfonyl amino group), an ureido group (for example, a 3-methylureido group, a 3,3-dimethylureido group and a 1,3-dimethylureido group), a sulfamoylamino group (for example, a dimethylsulfamoyl amino group), a carbamoyl group (for example, a methylcarbamoyl group, an ethylcarbamoyl group and a dimethylcarbamoyl group), a sulfamoyl group (for example, an ethylsulfamoyl group and a dimethylsulfamoyl group), an alkoxycarbonyl group (for example, a methoxycarbonyl group and an ethoxycarbonyl group), an aryloxycarbonyl group, (for example, a phenoxycarbonyl group), a sulfonyl group (for example, a methanesulfonyl group, a butane sulfonyl group and a phenylsulfonyl group), an acyl group (for example, an acetyl group, a propanoyl group and a butyroyl group), an amino group (for example, a methylamino group, an ethylamino group and a dimethylamino group), a cyano group, a hydroxy group, a nitro group, a nitroso group, an amineoxide group (for example, a pyridine oxide group), an imide group (for example, a phthalimide group), disulfide group (for example, a benzene disulfide group and a benzothiazolyl-2-disulfide group), a carboxyl group, a sulfo group and a heterocycle group (for example, a pyrrole group, a pyrrolidyl group, a pyrazolyl group, an imidazolyl group, a pyridyl group, a benzimidazolyl group, a benzthiazolyl group and a benzoxazolyl group). These substituents may be further substituted. Further, R¹¹ is preferably a hydrogen atom, and R¹² and R¹⁶ each is preferably a phenol compound being a t-butyl group.

The phenol type compound is a compound well known in the art and is described, for example, in columns 12-14 of U.S. Pat. No. 4,839,405 including 2,6-dialkylphenol derivatives.

Concrete examples of the compound represented by Formula (1) include: n-octadecyl-3-(3,5-di-t-butyl-4-hydroxyphenyl)propionate, n-octadecyl-3-(3,5-di-t-butyl-4-hydroxyphenyl)acetate, n-octadecyl-3,5-di-t-butyl-4-hydroxybenzoate, n-hexyl-3,5-di-t-butyl-4-hydroxyphenylbenzoate, n-dodecyl-3,5-di-t-butyl-4-hydroxyphenylbenzoate, neo-dodecyl-3-(3,5-di-t-butyl-4-hydroxyphenyl)propionate, dodecyl-β-(3,5-di-t-butyl-4-hydroxyphenyl)propionate, ethyl-α-(4-hydroxy-3,5-di-t-butylphenyl)isobutyrate, octadecyl-α-(4-hydroxy-3,5-di-t-butylphenyl)isobutyrate, octadecyl-α-(4-hydroxy-3,5-di-t-butyl-4-hydroxyphenyl)propionate, 2-(n-octylthio)ethyl-3,5-di-t-butyl-4-hydroxy-benzoate, 2-(n-octylthio)ethyl-3,5-di-t-butyl-4-hydroxyphenylacetate, 2-(n-octadecylthio)ethyl-3,5-di-t-butyl-4-hydroxyphenylacetate, 2-(n-octadecylthio)ethyl-3,5-di-t-butyl-4-hydroxybenzoate, 2-(2-hydroxyethylthio)-ethyl-3,5-di-t-butyl-4-hydroxybenzoate, diethylglycol-bis-(3,5-di-t-butyl-4-hydroxyphenyl)propionate, 2-(n-octadecylthio)ethyl-3,5-di-t-butyl-4-hydroxyphenyl)-propionate, stearamide-N,N-bis-[ethylene-3-(3,5-di-t-butyl-4-hydroxyphenyl)propionate], N-butylimino-N,N-bis-[ethylene-3-(3,5-di-t-butyl-4-hydroxyphenyl)propionate], 2-(2-stearoyloxyethylthio)ethyl-3,5-di-t-butyl-4-hydroxybenzoate, 2-(2-stearoyloxyethylthio)ethyl-7-(3-methyl-5-t-butyl-4-hydroxyphenyl)heptanoate, 1,2-propyleneglycol-bis-[3-(3,5-di-t-butyl-4-hydroxyphenyl)propionate], ethyleneglycol-bis-[3-(3,5-di-t-butyl-4-hydroxyphenyl)propionate], neopentylglycol-bis-[3-(3,5-di-t-butyl-4-hydroxyphenyl)propionate], ethyleneglycol-bis-(3,5-di-t-butyl-4-hydroxyphenylacetate), glycerol-l-n-octadecanoate-2,3-bis-(3,5-di-t-butyl-4-hydroxyphenylacetate), pentaerythritoltetrakis[3-(3′,5′-di-t-butyl-4′-hydroxyphenyl)propionate], 1,1,1-trimethylolethane-tris-[3-(3,5-di-t-butyl-4-hydroxyphenyl)propionate], sorbitol-hexa-[3-(3,5-di-t-butyl-4-hydroxyphenyl)propionate], 2-hydroxyethyl-7-(3-methyl-5-t-butyl-4-hydroxyphenyl)propionate, 2-stearoyloxyethyl-7-(3-methyl-5-t-butyl-4-hydroxyphenyl)heptanoate, 1,6-n-hexanediol-bis-[(3′,5′-di-butyl-4-hydroxyphenyl)propionate] and pentaerythritoltetrakis(3,5-di-t-butyl-4-hydroxyhydrocinnamate). Above phenol compounds have been commercialized, for example, as “Irganox1076” and “Irganox1010” from Ciba Specialty Chemicals, Inc. Incidentally, it may be preferable to contain the compound represented by Formula (1) in an amount of from 0.01 to 10 parts by weight based on 100 parts by weight of the cellulose ester, preferably, 0.1 to 3 parts by weight.

The cellulose acylate film manufacturing method of the present invention is characterized in that at least one of the phosphoric acid compounds selected from among the phosphite, phosphonite, phosphinite or tertiary phosphane is contained as an additive. The phosphoric acid compound is a known compound, and the preferably used one includes the compounds disclosed in the Specifications of the Unexamined Japanese Patent Application Publication No. 2002-138188, Unexamined Japanese Patent Application Publication No. 2005-344044 (paragraphs 0022 through 0027), Unexamined Japanese Patent Application Publication No. 2004-182979 (paragraphs 0023 through 0039), Unexamined Japanese Patent Application Publication No. H10-306175, Unexamined Japanese Patent Application Publication No. H1-254744, Unexamined Japanese Patent Application Publication No. H2-270892, Unexamined Japanese Patent Application Publication No. H5-202078, Unexamined Japanese Patent Application Publication No. H5-0.178870, Tokuhyo No. 2004-504435, Tokuhyo No. 2004-530759, and Tokugan No. 2005-353229. The phosphoric acid compound is exemplified by phosphite in the general formulas (1) through (V), phosphonite in the general formulas (VI) through (XII), phosphinite in the general formulas (XIII) through (XV) and phosphane in the general formulas (XVI) through (XIX).

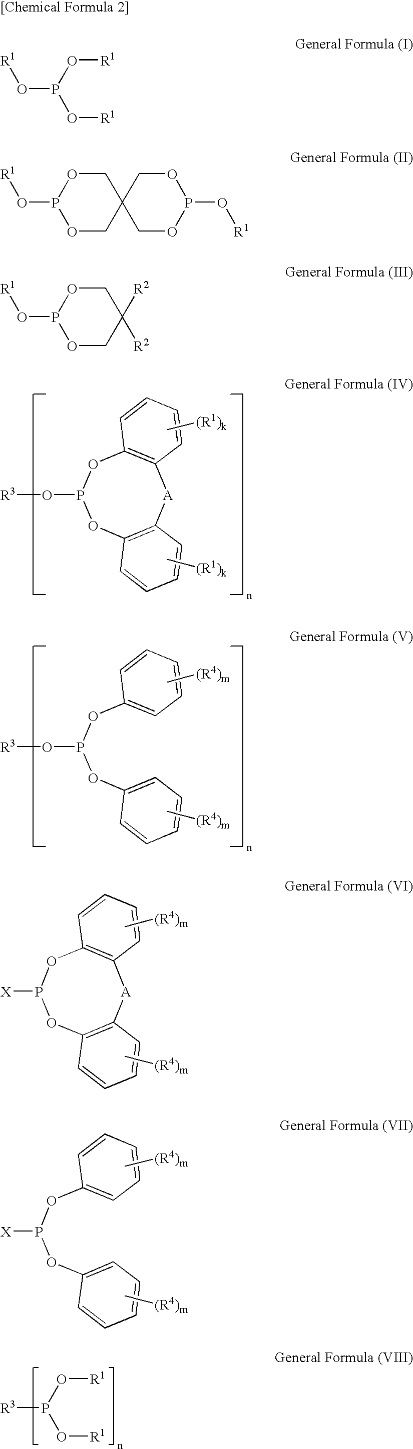

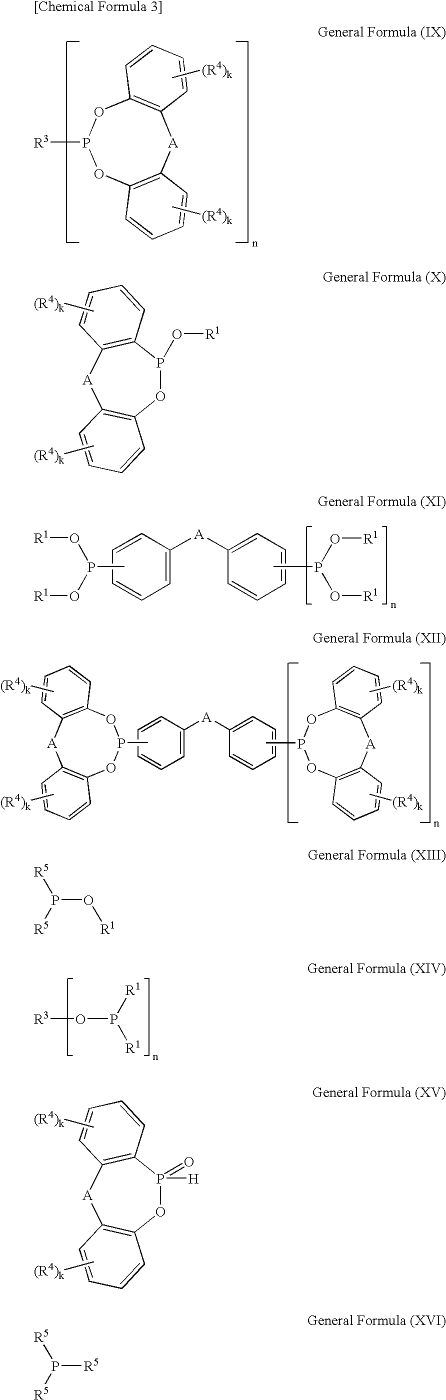

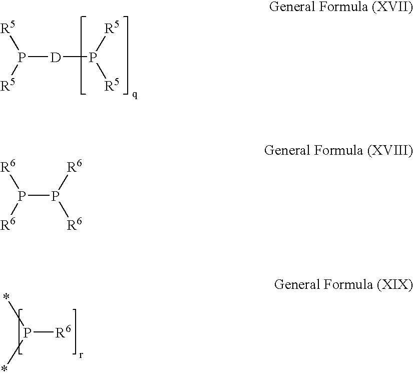

The groups are independently of each other.

R¹ represents:

alkyl of C1 through C24 (straight chain or branched chain, hetero atom, N, O, P and S may be included);

cycloalkyl of C5 through C30 (hetero atom, N, O, P and S may be included);

alkyl aryl of C1 through C30;

aryl or hetero aryl of C6 through C24;

aryl or hetero aryl of C6 through C24 (replaced by alkyl of C1 through C18 (straight chain or branched chain); and

cycloalkyl of C5 through C12, or alkoxy group of C1 through C18).

R² represents:

alkyl of H and C1 through C24 (straight chain or branched chain; hetero atom, N, O, P and S may be included);

cycloalkyl of C5 through C30 (hetero atom, N, O, P and S may be included);

alkyl aryl of C1 through C30;

aryl or hetero aryl of C6 through C24;

aryl or hetero aryl of C6 through C24 (alkyl of C1 through C18 (straight chain or branched chain); and

cycloalkyl of C5 through C12 or alkoxy group of C1 through C18).

R³ represents:

alkylene type group of C1 through C30 having a valency of “n” (straight chain or branched chain, hetero atom, N, O, P and S may be included);

alkylidene of C1 through C30 (hetero atom, N, O, P and S may be included);

cycloalkylene of C5 through C12, or arylene of C6 through C24 (replaced by alkyl of C1 through C18 (straight chain or branched chain); and

cycloalkyl of C5 through C12 or alkoxy of C1 through C18).

R⁴ represents:

alkyl of C1 through C24 (straight chain or branched chain, hetero atom, N, O, P and S may be included);

cycloalkyl of C5 through C30 (hetero atom, N, O, P and S may be included);

alkyl aryl of C1 through C30;

aryl or hetero aryl of C6 through C24;

aryl or hetero aryl of C6 through C24 (replaced by alkyl of C1 through C18 (straight chain or branched chain); and

cycloalkyl of C5 through C12 or alkoxy group of C1 through C18).

R⁵ represents:

alkyl of C1 through C24 (straight chain or branched chain, hetero atom, N, O, P and S may be included);

cycloalkyl of C5 through C30 (hetero atom, N, O, P and S may be included);

alkyl aryl of C1 through C30;

aryl or hetero aryl of C6 through C24; and

aryl or hetero aryl of C6 through C24 (replaced by alkyl of C1 through C18 (straight chain or branched chain); and

cycloalkyl of C5 through C12 or alkoxy group of C1 through C18).

R⁶ represents:

alkyl of C1 through C24 (straight chain or branched chain; hetero atom, N, O, P and S may be included);

cycloalkyl of C5 through C30 (hetero atom, N, O, P and S may be included);

alkyl aryl of C1 through C30;

aryl or hetero aryl of C6 through C24;

aryl or hetero aryl of C6 through C24 (replaced by alkyl of C1 through C18 (straight chain or branched chain); and

cycloalkyl of C5 through C12 or alkoxy group of C1 through C18).

A indicates a direct bond, and represents alkylidene of C1 through C30 (hetero atom, N, O, P and S may be included), >NH, >NR¹, —S—, >S(O), >S(O)2, —O—.

D shows the alkylene type group having a valence of “q” of C1 through C30 (straight chain or branched chain, hetero atom, N, O, P and S may be included);

alkylidene of C1 through C30 (hetero atom, N, O, P, S may be included);

cycloalkylene of C5 through C12 (hetero atom, N, O, P and S may be included); or

arylene of C6 through C24 (replaced by alkyl of C1 through C18 (straight chain or branched chain);

cycloalkyl of C5 through C12, or alkoxy of C1 through C18);

—O—; and

—S—.

“X” represents Cl, Br, F and OH (including the tautomer>P(O)H that occurs as a result). “k” indicates 0 through 4, “n” 1 through 4, “m” 0 through 5, “p” 0 or 1, “q” 1 through 5, and “r” 3 through 6. The group P—R⁶ of the formula (XIX) represents a constituent element of the phosphacycle expressed by “*” on the bond issued from P.

The particularly preferred ones of these compounds are exemplified by the following. Two or more of these compounds can be used in combination. The amount of the phosphoric acid compound to be added is normally 0.01 through 10 parts by mass, preferably 0.05 through 5 parts by mass, more preferably 0.1 through 3 parts by mass with respect to 100 parts by mass of cellulose ester.

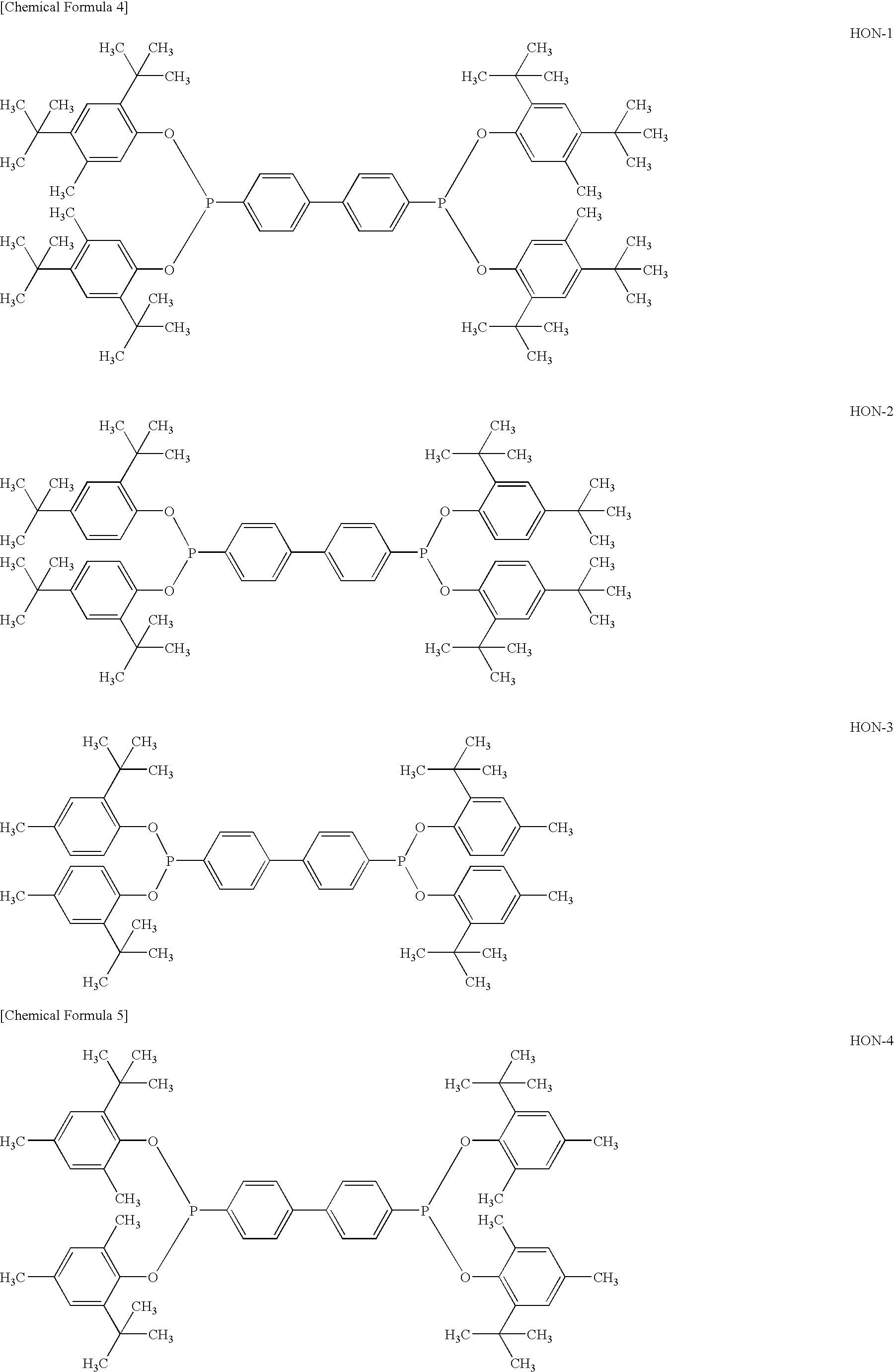

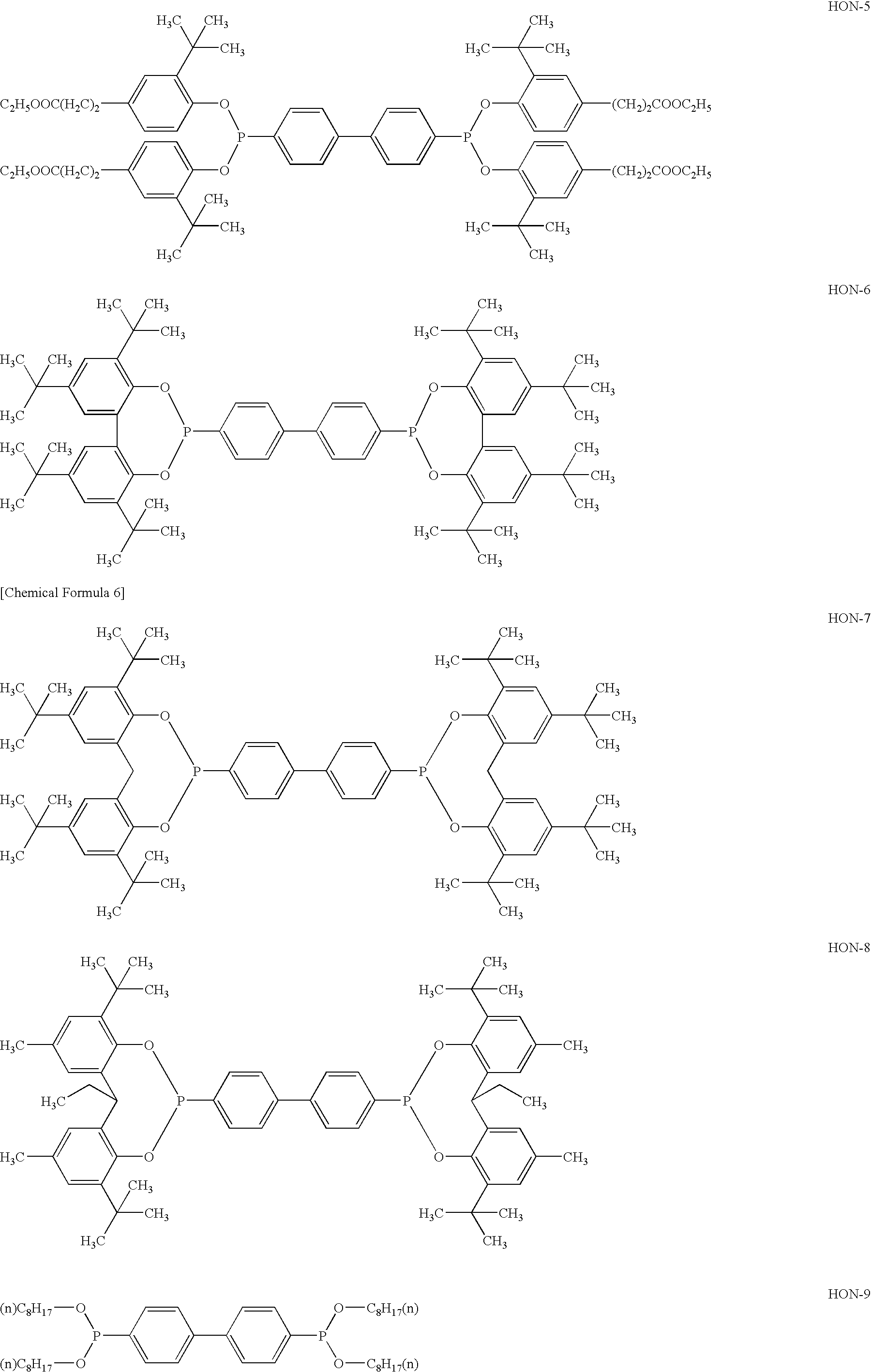

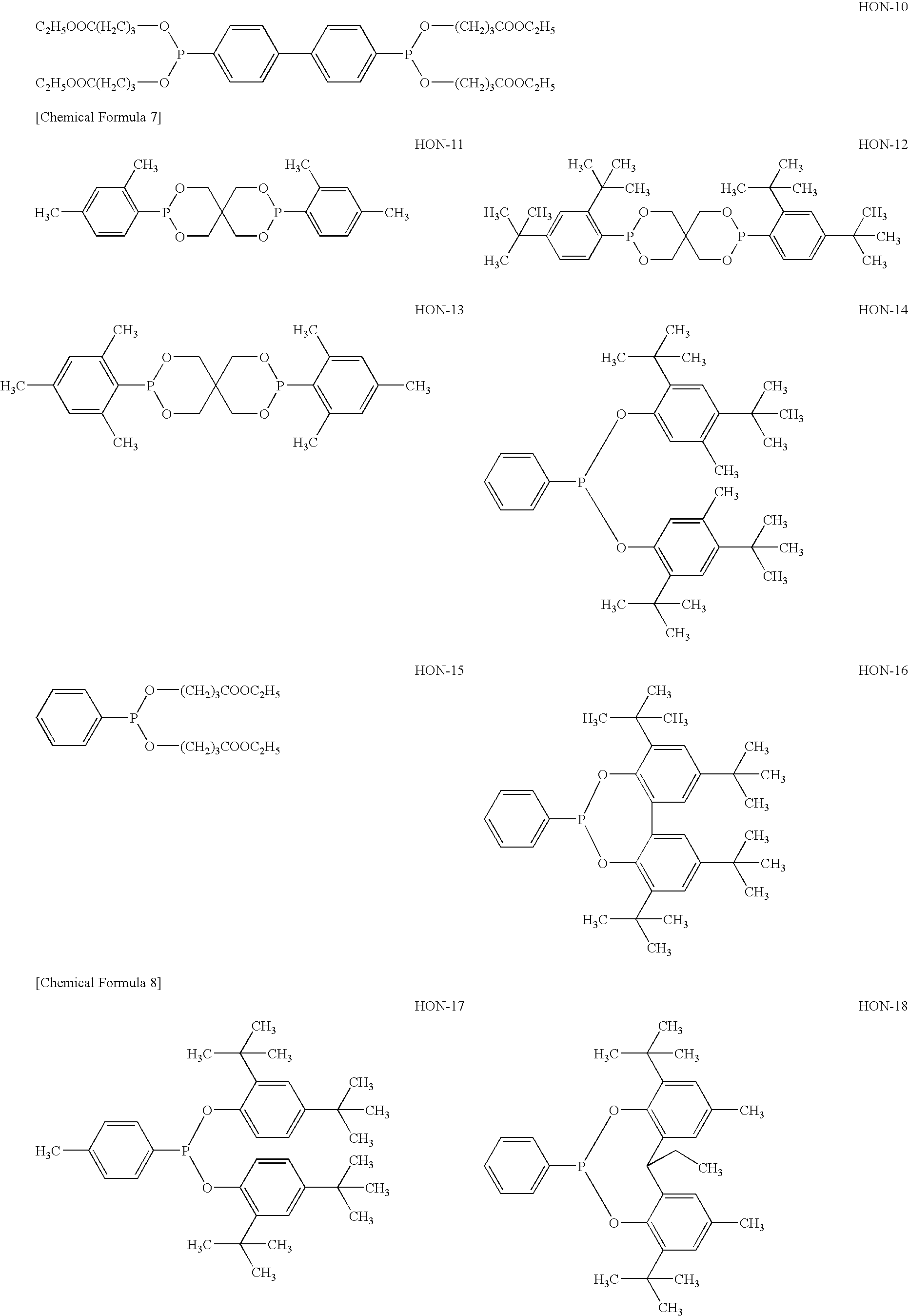

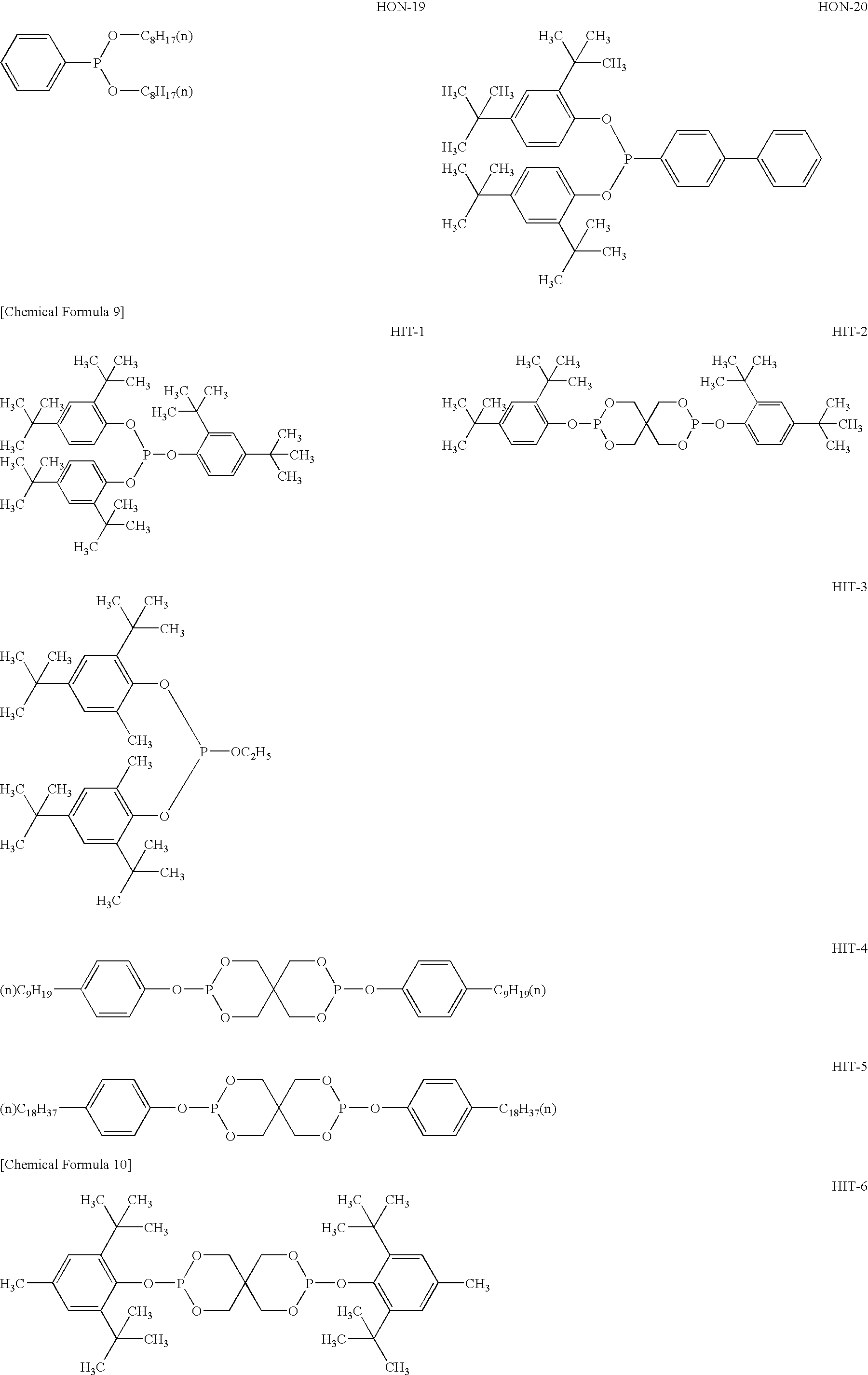

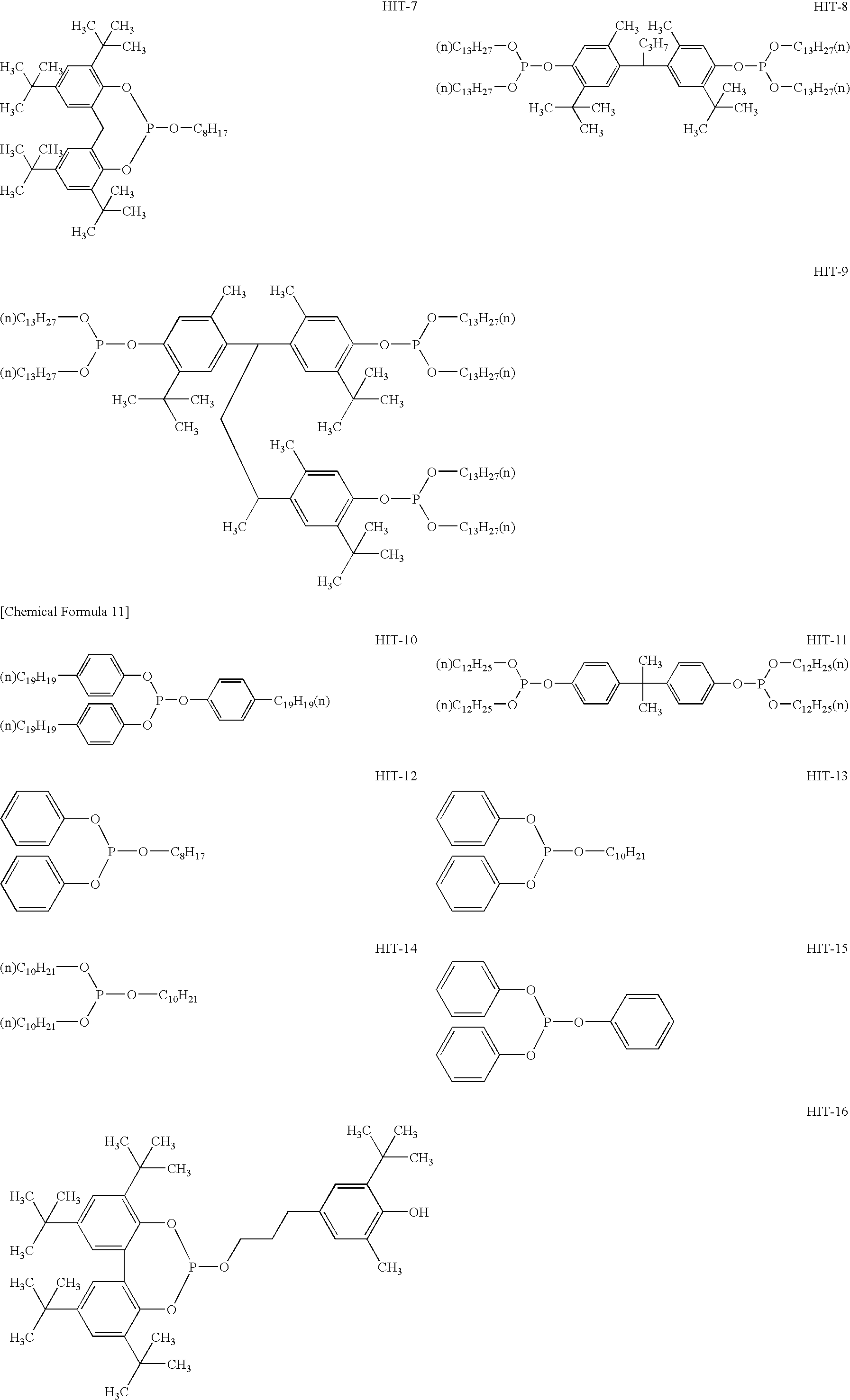

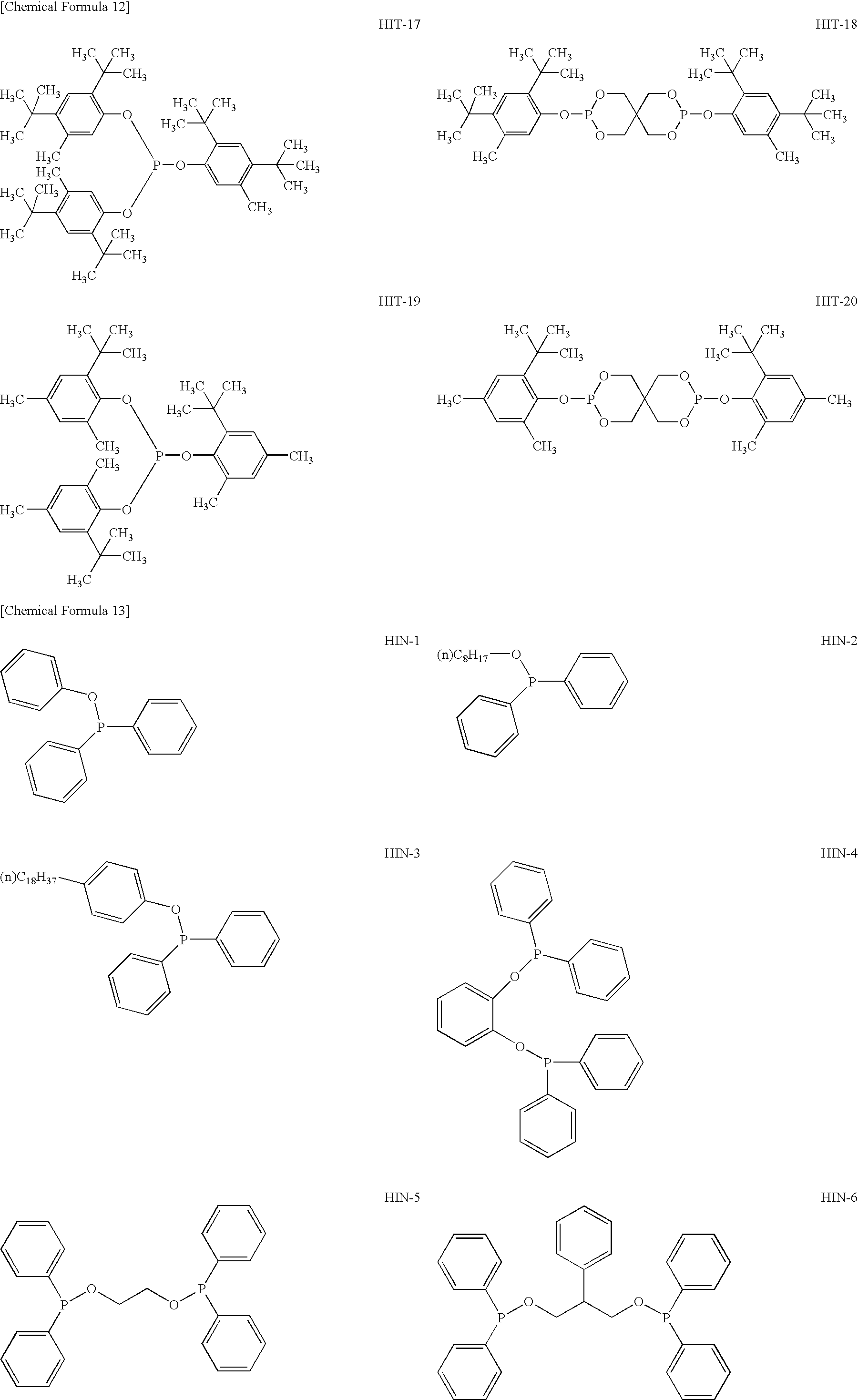

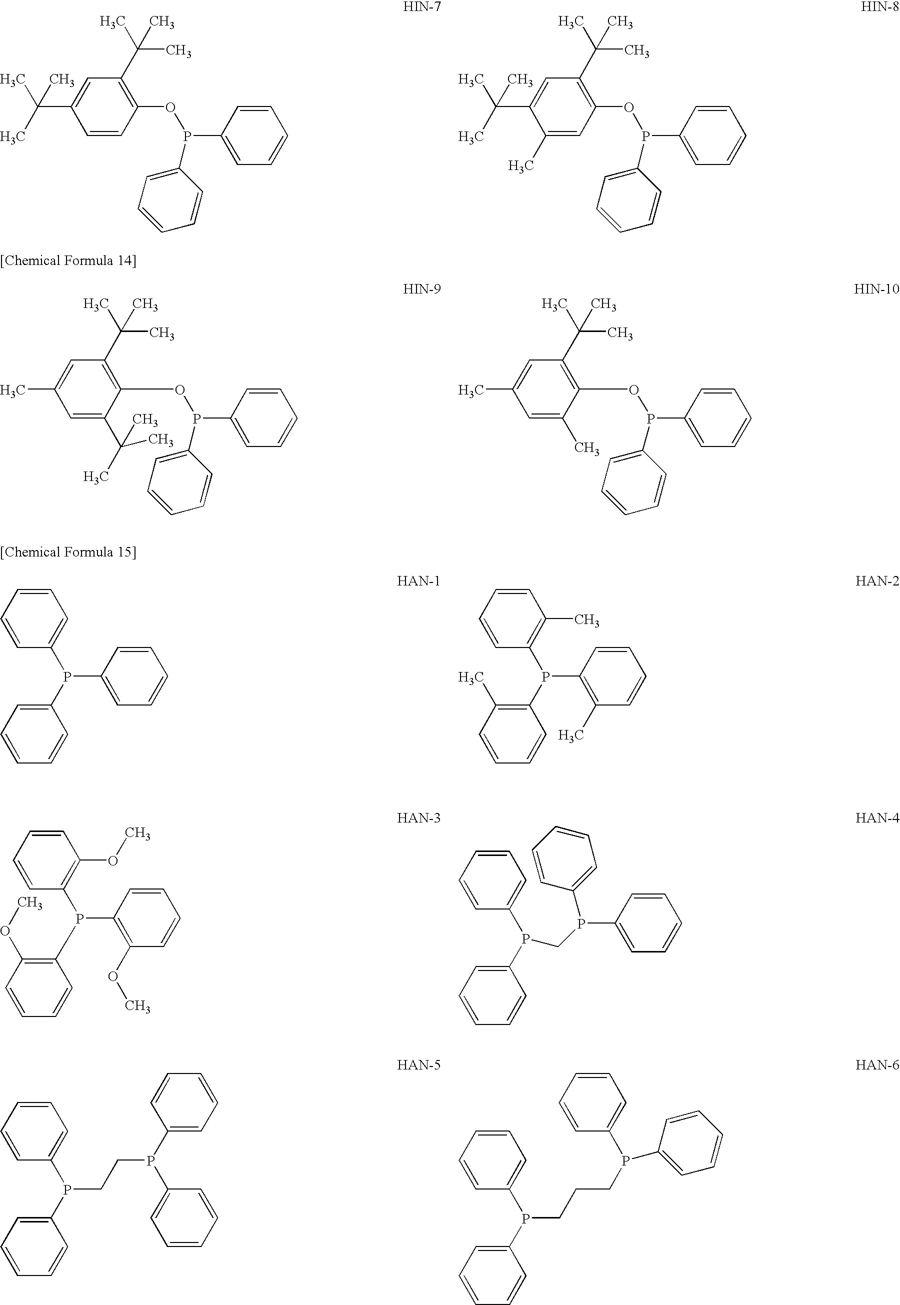

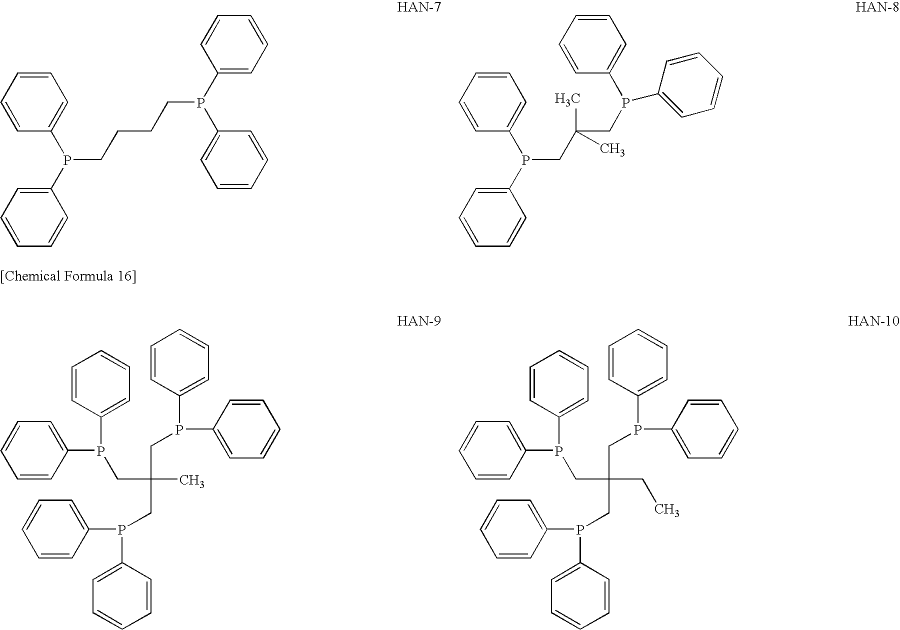

If a cellulose acylate film of the present invention is colored, since the colored film provides some influence for an optical use, the degree of yellow (an yellow index, YI) is preferably 3.0 or less, more preferably 3.0 or less. The degree of yellow can be measured based on JIS-K7103.

(Cellulose Acylate)

The cellulose acylate used for the present invention is explained in full detail. In the present invention, the cellulose acylate constituting a film is preferably a cellulose acylate including an aliphatic acyl group having a carbon number of 2 or more, and still more preferably a cellulose acylate in which a total substitution degree with an acyl group is 2.9 or less and an acyl group total carbon number is 6.2 or more and 7.5 or less. The acyl group total carbon number of the cellulose acylate is preferably 6.5 or more and 7.2 or less, more preferably 6.7 or more and 7.1 or less. Here, the acyl group total carbon number is a total of a product of the substitution degree of each acyl group substituted to a glucose unit in a cellulose acylate and a carbon number.

For example, an acyl group total carbon number of a cellulose acetate propionate is calculated by the following formula:
An acyl group total carbon number=2×acetyl group substitution degree+3×propionyl group substitution degree

Further, from the viewpoints of a productivity of cellulose synthesis and a cost, the carbon number of an aliphatic acyl group is preferably 2 or more and 6 or less, and more preferably 2 or more and 4 or less. In this regard, a portion not substituted with an acyl group usually exists as a hydroxyl group. These can be synthesized by a well-known method.

A glucose unit constituting cellulose with a β-1,4-glycosidic linkage has a free hydroxyl group at the 2nd, 3rd and 6th positions. The cellulose acylate in the present invention is a polymer in which a part or all of theses hydroxyl groups are esterified with an acyl group. A degree of substitution represents a sum total of a rate which the 2nd, 3rd and 6th positions of a repetition unit of a cellulose are esterified. Concretely, when the hydroxyl group of each of the 2nd, 3rd and 6th positions of cellulose are esterified by 100%, the substitution degree of each position is made 1. Therefore, when the hydroxyl group of each of the 2nd, 3rd and 6th positions of cellulose are esterified by 100%, the substitution degree becomes the maximum of 3. Here, the substitution degree of an acyl group can be measured by the method specified in ASTM-D817.

Examples of the acyl group include an acetyl group, a propionyl group, a butyryl group, a pentanate group, a hexanate group, and examples of a cellulose acylate include a cellulose propionate, a cellulose butylate, and a cellulose pentanate. Moreover, as long as the above-mentioned side chain carbon number is satisfied, a mixed fatty acid ester such as, a cellulose acetate propionate, a cellulose acetate butylate and a cellulose acetate pentanate may be employed. Among these, a cellulose acetate propionate and a cellulose acetate butylate are preferable.

The present inventor have grasped that the mechanical physical properties and the saponification properties of a cellulose acylate film and the melting and film forming ability of the cellulose acylate film has a relationship of a trade-off for the acyl group total carbon number of the cellulose acylate film. For example, in the cellulose acetate propionate, an increase in the total number of carbon atoms contained in the acyl group denotes a decrease in the mechanical property and improvement in melt film formation property. Thus, compatibility is difficult to achieve. However, in the present invention, the total substitution degree of the acyl group in the cellulose acylate is made 2.9 or less and the total number of carbon atoms contained in the acyl group is 6.5 or more and 7.2 or less, whereby compatibility among the film mechanical property, saponifiability and melt film formation property can be ensured, according to the findings by the present inventors. Although the details of this arrangement are not very clear, it is considered that there are differences in the degree of impact upon the film mechanical property, saponifiability and melt film formation property, depending on the number of carbon atoms contained in the acyl group. To be more specific, if the total substitution degree of the acyl group remains the same, a long-chained acyl group such as propionyl group, butyryl group rather than acetyl group provides a higher degree of hydrophobicity, and hence more enhanced melt film formation property. Thus, to achieve the same level of melt film formation property, the substitution degree of the long-chained acyl group such as propionyl group, butyryl group becomes lower than that of the acetyl group, and the total substitution degree also becomes lower, it is considered that this suppresses reduction in the mechanical property and saponifiability.

The cellulose ester concerning the present invention preferably a number average molecular weight (Mn) of 50,000 to 150,000, more preferably a number average molecular weight of 55,000 to 120,000, and still more preferably a number average molecular weight of 60,000 to 100,000.

Further, the cellulose ester used in the present invention preferably a ratio of a weight average molecular weight (Mw)/a number average molecular weight (Mn) of 1.3 to 5.5, more preferably 1.5 to 5.0, still more preferably 1.7 to 3.5, and still more preferably 2.0 to 3.0.

Here, the number average molecular weight (Mn) and the ratio of Mw/Mn was calculated by a gel permeation chromatography with the following procedures.

The measuring conditions are as follows:

Solvent: tetrahydrofuran

Device: HKC-8220 (manufactured by Toso KK)

Column: TSK-gel SuperHM-M (manufactured by Toso KK)

Column temperature: 40° C.

Sample temperature: 0.1% by weight

Feed amount: 10 μl

Flow: 0.6 ml/min

Calibration curve: prepared by 9 samples of standard polystyrene: PS-1 (manufactured by Polymer Laboratories KK), Mw=2,560,000 to 580

Although a wood pulp or a cotton linter is suitable as a raw material of the cellulose ester used in the present invention, and the wood pulp may be a needle-leaf tree or a broadleaf tree, the needle-leaf tree is more desirable. From a point of the peel property in the case of film production, the cotton linter is usable preferably. The cellulose ester made from these may be mixes appropriately or may be used independently.

For example, a cotton linter-originated cellulose resin a wood-pulp (needle-leaf tree)-originated cellulose resin a wood pulp (broadleaf tree)-originate cellulose resin may be used with a ratio of 100:0:0, 90:10:0, 85:15:0, 50:50:0, 20:80:0, 10:90:0, 0:100:0, 0:0:100, 80:10:10, 85:0:15 and 40:30:30.

The cellulose ester can be obtained by substituting hydroxyl groups in a raw material of cellulose with an acetyl group, a propionyl group and/or a butyl group within the above range with an ordinary method by using an acetic anhydride, a propionic anhydride, and/or a butyric anhydride, for example. A synthetic method of these cellulose esters is not limited to a specific one. For example, these cellulose esters may be synthesized by referring a method disclosed by JPA HEI-10-45804 or HYOU-6-501040.

The cellulose ester used in the present invention preferably contains an alkaline earth metal in an amount of 1 to 50 ppm. If the content exceeds 50 ppm, a lip adhesion soil increases or a slitting part is apt to fracture during hot stretching or after hot stretching. If the content is less than 1 ppm, a breakage trouble may take place easily, however, the reasons for it is not known well. Further, in order to make it less than 1 ppm, since the burden of a washing process becomes too large, it is not desirable at this point. More preferably, the content is in a range of 1 to 30 ppm. Here, the alkaline earth metals means the total content of Ca and Mg, and it can be measured by the use of X ray photoelectron spectral-analysis equipment (XPS).

The amount of the residual sulfuric acid contained in the cellulose ester used in the present invention is 0.1 through 45 ppm in terms of the sulfur element. They are considered to be included as salts. When the amount of the residual sulfuric acid contained therein exceeds 45 ppm, the deposition on the die lip at the time of heat-melting will increase, and therefore, such an amount is not preferred. Further, at the time of thermal stretching or slitting subsequent to thermal stretching, the material will be easily damaged, and therefore, such an amount is not preferred. The amount of the residual sulfuric acid contained therein should be reduced as much as possible, but when it is to be reduced below 0.1, the load on the cellulose ester washing process will be excessive and the material tends to be damaged easily. This should be avoided. This may be because an increase in the frequency of washing affects the resin, but the details are not yet clarified. Further, the preferred amount is in the range of 1 through 30 ppm. The amount of the residual sulfuric acid can be measured according to the ASTM-D817-96 in the similar manner.

The free acid content in the cellulose ester used in the present invention is desirably in a range of 1 to 500 ppm. If the content exceeds 500 ppm, adhesion matters on a die-lips part may increase, and it may become easy to fracture. It may be difficult to make it less than 1 ppm by washing. The content is desirably in a range of 1 to 100 ppm, because it becomes difficult to fracture. Especially, the content is more desirably in a range of 1 to 70 ppm The range of 1-70 ppm is desirable. The free acid content can be measured by a method specified in ASTM-D817.

The amount of the residual acid can be kept within the aforementioned range if the synthesized cellulose ester is washed more carefully than in the case of the solution casting method. Then, when a film is manufactured by the melt casting, the amount of depositions on the lip portion will be reduced so that a film characterized by a high degree of flatness is produced. Such a film will be further characterized by excellent resistance to dimensional changes, mechanical strength, transparency, resistance to moisture permeation, Rt value (to be described later) and Ro value. Further, the cellulose ester can be washed using water as well as a poor solvent such as methanol or ethanol. It is also possible to use a mixture between a poor solvent and a good solvent if it is a poor solvent as a result. This will remove the inorganic substance other than residual acid, and low-molecular organic impurities. The cellulose ester is washed preferably in the presence of an antioxidant such as a hindered amine and phosphorous acid ester. This will improve the heat resistance and film formation stability of the cellulose ester.

To improve the heat resistance, mechanical property and optical property of the cellulose ester, the cellulose ester is settled again in the poor solvent, subsequent to dissolution of the good solvent of the cellulose ester. This will remove the low molecular weight component and other impurities of the cellulose ester. In this case, similarly to the aforementioned case of washing the cellulose ester, washing is preferably carried out in the presence of an antioxidant.

Furthermore, another polymer or a low molecular compound may be added after a reprecipitation process of cellulose ester.

In the present invention, in addition to the cellulose ester resin, a cellulose ether resin, a vinyl resin (including a polyvinyl acetate resin and a polyvinyl alcohol resin), a cyclic olefine resin, a polyester resin (an aromatic polyester, an aliphatic polyester, and a copolymer containing them), and an acrylic resin (including a copolymer), may be contained in a the present invention. The content of a resin other than the cellulose ester is preferably 0.1 to 30% by weight.

The cellulose ester used in the present invention is preferred to be such that there are few bright defects when formed into a film. The bright defect can be defined as follows: Two polarizing plates are arranged perpendicular to each other (crossed-Nicols), and a cellulose ester film is inserted between them. Light of the light source is applied from one of the surfaces, and the cellulose ester film is observed from the other surface. In this case, a spot formed by the leakage of light from the light source. This spot is referred to as a bright detect. The polarizing plate employed for evaluation in this case is preferably made of the protective film free of a bright defect. A glass plate used to protect the polarizer is preferably used for this purpose. The bright defect may be caused by non-acetified cellulose or cellulose with a low degree of acetification contained in the cellulose ester. It is necessary to use the cellulose ester containing few bright defects (use the cellulose ester with few distributions of substitution degree), or to filter the molten cellulose ester. Alternatively, the material in a state of solution is passed through a similar filtering step in either the later process of synthesizing the cellulose ester or in the process of obtaining the precipitate, whereby the bright defect can be removed. The molten resin has a high degree of viscosity, and therefore, the latter method can be used more efficiently.

The smaller the film thickness, the fewer the number of bright defects per unit area and the fewer the number of the cellulose esters contained in the film. The number of the bright defects having a bright spot diameter of 0.01 mm or more is preferably 200 pieces/cm² or less, more preferably 100 pieces/cm² or less, still more preferably 50 pieces/cm² or less, further more preferably 30 pieces/cm² or less, still further more preferably 10 pieces/cm² or less. The most desirable case is that there is no bright defect at all. The number of the bright defects having a bright spot diameter of 0.005 through 0.01 mm is preferably 200 pieces/cm² or less, more preferably 100 pieces/cm² or less, still more preferably 50 pieces/cm² or less, further more preferably 30 pieces/cm² or less, still further more preferably 10 pieces/cm² or less. The most desirable case is that there is no bright defect at all.

When the bright defect is to be removed by melt filtration, the bright defect is more effectively removed by filtering the cellulose ester composition mixed with a plasticizer, anti-deterioration agent and antioxidant, rather than filtering the cellulose ester melted independently. It goes without saying that, at the time of synthesizing the cellulose ester, the cellulose ester can be dissolved in a solvent, and the bright defect can be reduced by filtering. Alternatively, the cellulose ester mixed with an appropriate amount of ultraviolet absorber and other additive can be filtered. At the time of filtering, the viscosity of the melt including the cellulose ester is preferably 10000 P or less, more preferably 5000 P or less, still more preferably 1000 P or less, further more preferably 500 P or less. A conventionally known medium including a fluoride resin such as a glass fiber, cellulose fiber, filter paper and tetrafluoroethylene resin is preferably used as a filter medium. Particularly, ceramics and metal can be used in preference. The absolute filtration accuracy is preferably 50 μm or less, more preferably 30 μm or less, still more 10 μm or less, further more preferably 5 μm or less. They can be appropriately combined for use. Either a surface type or depth type filter medium can be used. The depth type is more preferably used since it has a greater resistance to clogging.

In another embodiment, it is also possible that the cellulose ester as a material is dissolved in a solvent at least once, and is dried and used. In this case, the cellulose ester is dissolved in the solvent together with one or more of the plasticizer, ultraviolet absorber, anti-deterioration agent, antioxidant and matting agent, and is dried and used. Such a good solvent as methylene chloride, methyl acetate or dioxolane that is used in the solution casting method can be used as the solvent. At the same time, the poor solvent such as methanol, ethanol or butanol can also be used. In the process of dissolution, it can be cooled down to −20° C. or less or heated up to 80° C. or more. Use of such a cellulose ester allows uniform additives to be formed in the molten state, and the uniform optical property is ensured in some cases.

(Additive)

The cellulose acylate film of the present invention preferably contains as additives at least one kind plasticizer of an ester type plasticizer having a structure in which an organic acid and an alcohol of 3 or more valence are condensed, an ester type plasticizer composed of a polyvalent alcohol and a monovalent carboxylic acid and an ester type plasticizer composed of a polyvalent carboxylic acid and a monovalent alcohol and at least one kind stabilizer of a phenol type antioxidant, a hindered amine light stabilizer, a phosphorus type stabilizer, and a sulfur type stabilizer. Further, in addition to the above, it may contains a peroxide decomposing agent, a radical capturing agent, a metal deactivator, an ultraviolet absorption agent, a mat agent, a die, a pigment and also a plasticizer other than the above and an antioxidant other than a hindered phenol antioxidant.

The additives are employed for preventing oxidation of the film constituting material, capturing an acid formed by decomposition of the material and inhibiting or preventing the decomposition reaction caused by the radical species so as to inhibiting the deterioration of the material such as the coloring, decreasing in the molecular weight including a not cleared decomposing reaction and occurrence of volatile component, and for giving a function such as moisture permeating ability and a slipping ability.

Besides, the decomposition reaction in the film constituting materials is considerably progressed when the material is molten by heating, and the decomposition reaction some times causes coloring or degradation in the strength of the film constituting material. Moreover, undesirable volatile component tends to occur by the decomposition reaction of the film constituting materials.

The film constituting material preferably contains the above additives on the occasion of melting by heat, such the material is superior in the inhibition of the lowering in the strength caused by the degradation and decomposition of the material and in the keeping of the peculiar strength of the material.

The presence of the additives is effective for inhibiting the formation of a colored substance in the visible light region and for inhibiting or preventing undesirable properties of the optical film such as low transparency and high haze value caused by mixing of the volatile component.

The haze value is preferably less than 1%, and more preferably less than 0.5% because a haze exceeding 1% influences on the displayed image when the optical film is employed in the liquid crystal display having the constitution according to the invention.

In a process of providing a retardation when producing a film, the additives are used to refrain the deterioration in the strength of the film constituting compositions and to maintain a material inherent strength. If the film constituting compositions become fragile due to excessive deteriorations, a rupture becomes apt to take place in a stretching process and it becomes difficult to control the retardation value.

A degradation reaction caused by oxygen in the air occurs some times in the storage or in the film forming process of the film constituting materials. In such the case, it is preferable to decrease the oxygen concentration in the air together with the stabilizing effect of the additive. The decreasing in the oxygen concentration can be performed by know methods, for example, the use of inactive gas such as nitrogen and argon, the air exhaustion operation for making reduced pressure to vacuum, and the processing in a closed environment. At least one of the above three methods can be applied together with the use of the foregoing additives. The degradation of the materials can be inhibited by reducing the probability of contacting the materials with oxygen in the air, such the process is preferable for in object of the invention.

The presence of the additives in the film constituting material is preferable for using cellulose acylate film as the polarizing plate protective film from the viewpoint of the improving of the storage durability of the polarizing plate or the polarizing element constituting the polarizing plate.

In the display employing the polarizing plate of the invention, the variation and degradation of the optical film can be inhibited by the presence of the additives so that the durability during the storage can be improved, and the function of the optical compensation design of the optical film is maintained for a long period.

(Plasticizer)

The cellulose acylate film of the present invention preferably contains 1-25 weight % of an ester compound, as a plasticizer, having a structure obtained by condensing the organic acid represented by Formula (2) and an alcohol having a valence of 3 or more. When its amount is less than 1 weight %, the effect of adding the plasticizer is not acknowledged, on the other hand, when its amount is more than 25 weight %, bleeding out tends to occur resulting in lowering the long term stability of the film, accordingly those amounts are not preferable. More preferable is a cellulose acylate film containing 3-20 weight % of the above plasticizers, and still more preferable is a cellulose acylate film containing 5-15 weight % of the plasticizers.

A plasticizer, as described herein, commonly refers to an additive which decreases brittleness and result in enhanced flexibility upon being incorporated in polymers. In the present invention, a plasticizer is added so that the melting temperature of a cellulose ester resin is lowered, and at the same temperature, the melt viscosity of the film forming materials including a plasticizer is lower than the melt viscosity of a cellulose ester resin containing no additive. Further, addition is performed to enhance hydrophilicity of cellulose ester so that the water vapor permeability of cellulose ester films is lowered. Therefore, the plasticizers of the present invention have a property of an anti-moisture-permeation agent.

The melting temperature of a film forming material, as described herein, refers to the temperature at which the above materials are heated to exhibit a state of fluidity. In order that cellulose ester results in melt fluidity, it is necessary to heat cellulose ester to a temperature which is at least higher than the glass transition temperature. At or above the glass transition temperature, the elastic modulus or viscosity decreases due to heat absorption, whereby fluidity is observed. However, at higher temperatures, cellulose ester melts and simultaneously undergoes thermal decomposition to result in a decrease in the molecular weight of the cellulose ester, whereby the dynamical characteristics of the resulting film may be adversely affected. Consequently, it is preferable to melt cellulose ester at a temperature as low as possible. Lowering the melting temperature of the film forming materials is achieved by the addition of a plasticizer having a melting point or a glass transition temperature which is equal to or lower than the glass transition temperature of the cellulose ester. The polyalcohol ester type plasticizer having a structure obtained by condensing the organic acid represented by Formula (1) and a polyalcohol is excellent in the following points: It makes a melting temperature of a cellulose ester lower and since it has less volatility in the process of melting and producing a film and after production, it has a good process adaptability. In addition, the obtained cellulose acylate film is excellent in terms of optical property, dimensional stability and flatness.

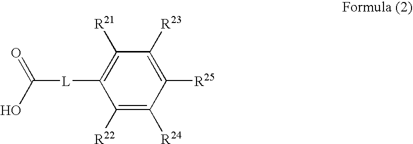

In Formula (2), R²¹-R²⁵ each independently represent a hydrogen atom, a cycloalkyl group, an aralkyl group, an alkoxy group, a cycloalkoxy group, an aryloxy group, an aralkyloxy group, an acyl group, a carbonyloxy group, an oxycarbonyl group, or an oxycarbonyloxy group, any of which may further be substituted. L represents a linkage group, which includes a substituted or unsubstituted alkylene group, an oxygen atom or a direct bond.

Preferred as the cycloalkyl group represented by R²¹-R²⁵ is a cycloalkyl group having 3-8 carbon atoms, and specific examples include cycloproyl, cyclopentyl and cyclohexyl groups. These groups may be substituted. Examples of preferred substituents include: halogen atoms such as a chlorine atom, a bromine atom and a fluolinr atom, a hydroxyl group, an alkyl group, an alkoxy group, an aralkyl group (the phenyl group may further be substituted with an alkyl group or a halogen atom), an alkenyl group such as a vinyl group or an allyl group, a phenyl group (the phenyl group may further be substituted with an alkyl group, or a halogen atom), a phenoxy group (the phenyl group may further be substituted with an alkyl group or a halogen atom), an acyl group having 2-8 carbon atoms such as an acetyl group or a propionyl group, and a non-substituted carbonyloxy group having 2-8 carbon atoms such as an acetyloxy group and a propionyloxy group.

The aralkyl group represented by R²¹-R²⁵ includes a benzyl group, a phenetyl group, and a γ-phenylpropyl group, which may be substituted. Listed as the preferred substituents may be those which may substitute the above cycloalkyl group.

The alkoxy group represented by R²¹-R²⁵ include an alkoxy group having 1-8 carbon atoms. The specific examples include an methoxy group, an ethoxy group, an n-propoxy group, an n-butoxy group, an n-octyloxy group, an isopropoxy group, an isobutoxy group, a 2-ethylhexyloxy group and a t-butoxy group. The above groups may further be substituted. Examples of preferred substituents include: halogen atoms such as a chlorine atom, a bromine atom and a fluorine atom; a hydroxyl group; an alkoxy group; a cycloalkoxy group; an aralkyl group (the phenyl group may be substituted with an alkyl group or a halogen atom); an alkenyl group; a phenyl group (the phenyl group may further be substituted with an alkyl group or a halogen atom); an aryloxy group (for example, a phenoxy group (the phenyl group may further be substituted with an alkyl group or a halogen atom)); an acyl group having 2-8 carbon atoms such as an acetyl group or a propionyl group; an acyloxy group such as a propionyloxy group; and an arylcarbonyloxy group such as a benzoyloxy group.

The cycloalkoxy groups represented by R²¹-R²⁵ include an cycloalkoxy group having 1-8 carbon atoms as an unsubstituted cycloalkoxy group. Specific examples include a cyclopropyloxy group, a cyclopentyloxy group and a cyclohexyloxy group. These groups may further be substituted. Listed as the preferred substituents may be those which may substitute the above cycloalkyl group.

The aryloxy groups represented by R²¹-R²⁵ include a phenoxy group, the phenyl group of which may further be substituted with the substituent listed as a substituent such as an alkyl group or a halogen atom which may substitute the above cycloalkyl group.

The aralkyloxy group represented by R²¹-R²⁵ includes a benzyloxy group and a phenethyloxy group, which may further be substituted. Listed as the preferred substituents may be those which may substitute the above cycloalkyl group.

The acyl group represented by R²¹-R²⁵ includes an unsubstituted acyl group having 1-8 carbon atoms such as an acetyl group and a propionyl group (an alkyl, alkenyl, or alkynyl group is included as a hydrocarbon group of the acyl group), which may further be substituted. Listed as the preferred substituents may be those which may substitute the above cycloalkyl group.

The carbonyloxy group represented by R²¹-R²⁵ includes an unsubstituted acyloxy group (an alkyl, alkenyl, or alkynyl group is included as a hydrocarbon group of the acyl group) having 2-8 carbon atoms such as an acetyloxy group or a propionyloxy group, and an arylcarbonyloxy group such as a benzoyloxy group, which may further be substituted with the group which may substitute the above cycloalkyl group.

The oxycarbonyl group represented by R²¹-R²⁵ includes an alkoxycarbonyl group such as a methoxycarbonyl group, an ethoxycarbonyl group or a propyloxycarbonyl group, and an aryloxycarbonyl group such as a phonoxycarbonyl group, which may further be substituted. Listed as the preferred substituents may be those which may substitute the above cycloalkyl group.

The oxycarbonyloxy group represented by R²¹-R²⁵ includes an alkoxycarbonyloxy group having 1-8 carbon atoms such as a methoxycarbonyloxy group, which may further be substituted. Listed as the preferred substituents may be those which may substitute the above cycloalkyl group.

Further, any of R²¹-R²⁵ may be combined with each other to form a ring structure.

Further, the linkage group represented by L includes a substituted or unsubstituted alkylene group, an oxygen atom, or a direct bond. The alkylene group includes a methylene group, an ethylene group, and a propylene group, which may further be substituted with the substituent which is listed as the substituent which may substitute the groups represented by above R²¹-R²⁵.

Of these, one which is particularly preferred as the linking group is the direct bond which forms an aromatic carboxylic acid.

In the present invention, the organic acids which substitute the hydroxyl groups of a polyalcohol having a valence of 3 or more may either be of a single kind or of a plurality of kinds.

In the present invention, the polyalcohol which reacts with the organic acid represented by above Formula (2) to form a polyalcohol ester is preferably an aliphatic polyalcohol having a valence of 3-20. In the present invention, preferred as a polyalcohol having a valence of 3 or more is represented by following Formula (3).
R′—(OH)m Formula (3)

In Formula (3), R′ represents an m-valence organic group, m is a positive integer of 3 or more and OH group represents an alcoholic hydroxyl group. Especially, a polyvalent alcohol of 3 or 4 valence as m is preferable.

Preferable examples of the polyvalent alcohol include adonitol, arabitol, 1 and 2,4-butane triol, 1 and 2,3-hexane triol, 1 and 2,6-hexane triol, glycerol, diglycerol, erythritol, pentaerythritol, dipenta erythritol, tri pentaerythritol, galactitol, inositol, mannitol, 3-methylpentane-1,3,5-triol, pinacol, sorbitol, trimethylolpropane, methyltrimethylolmethane, xylitol, etc. However, the present invention is not limited to these examples. In particular, glycerol, methyltrimethylolmethane, trimethylolpropane, and pentaerythritol may more desirable.

An ester of an organic acid represented by Formula (2) and a polyalcohol having a valence of 3-20 can be synthesized employing methods known in the art. Typical synthesis examples are shown in the examples. Examples of the synthetic method include: a method in which an organic acid represented by Formula (2) and a polyalcohol undergo etherification via condensation in the presence of, for example, an acid; a method in which an organic acid is converted to an acid chloride or an acid anhydride which is allowed to react with a polyalcohol; and a method in which a phenyl ester of an organic acid is allowed to react with a polyalcohol. Depending on the targeted ester compound, it is preferable to select an appropriate method which results in a high yield.

As an example of a plasticizer containing an ester of an organic acid represented by Formula (2) and a polyalcohol, the compound represented by Formula (4) is preferable.

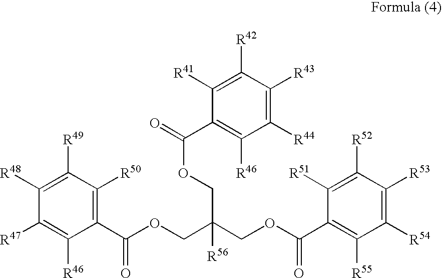

In Formula (4), R⁴¹ to R⁵⁵ each independently represent a hydrogen atom, a cycloalkyl group, an aralkyl group, an alkoxy group, a cycloalkoxy group, an aryloxy group, an aralkyloxy group, an acyl group, a carbonyloxyl group, an oxycarbonyl group or an oxycarbonyloxy group, provided that R⁴¹ to R⁵⁵ may further have a substituent. R⁵⁶ represents an alkyl group.

As examples of the above described cycloalkyl group, aralkyl group, alkoxy group, cycloalkoxy group, aryloxy group, aralkyloxy group, acyl group, carbonyloxyl group, oxycarbonyl group and oxycarbonyloxy group represented by R⁴¹ to R⁵⁵, the same groups as described for R²¹ to R²⁵ in Formula (1) can be cited.

The molecular weight of the polyalcohol esters prepared as above is not particularly limited, but is preferably 300-1,500, more preferably 400-1,000. A greater molecular d volatility, while a smaller molecular weight is preferred in view of reducing water vapor permeability and improving the compatibility with cellulose ester.

Specific compounds of polyalcohol esters according to the present invention will be exemplified below.

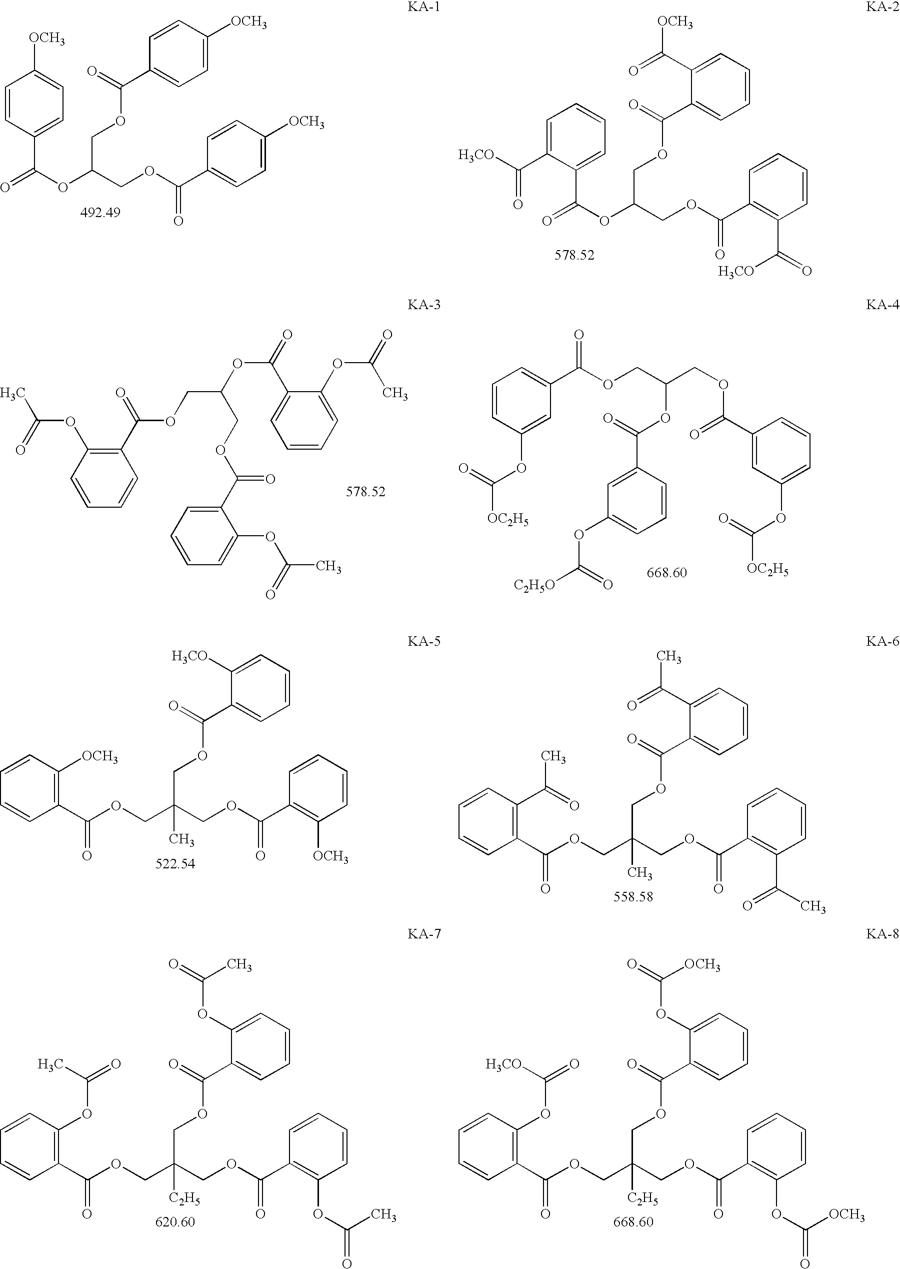

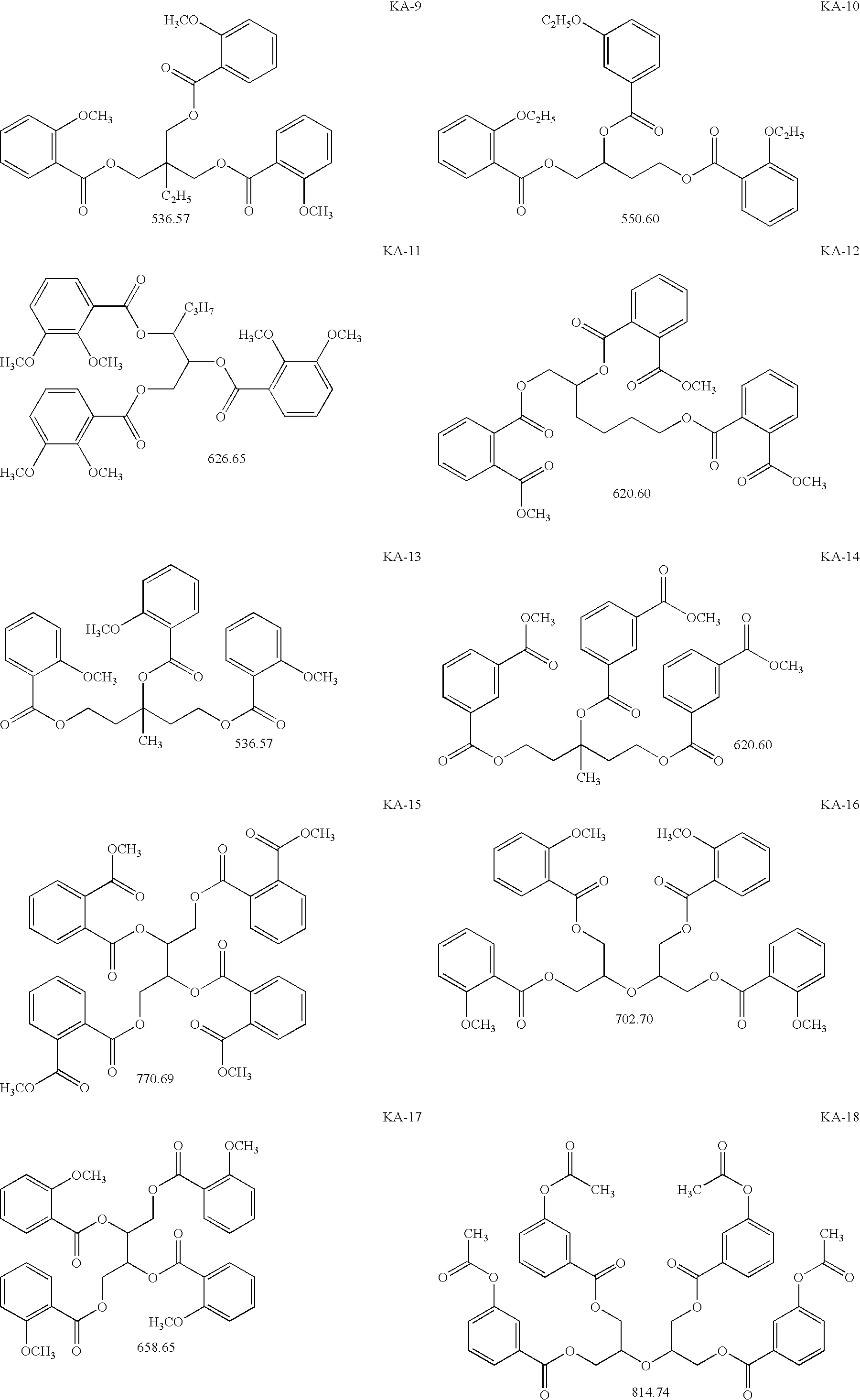

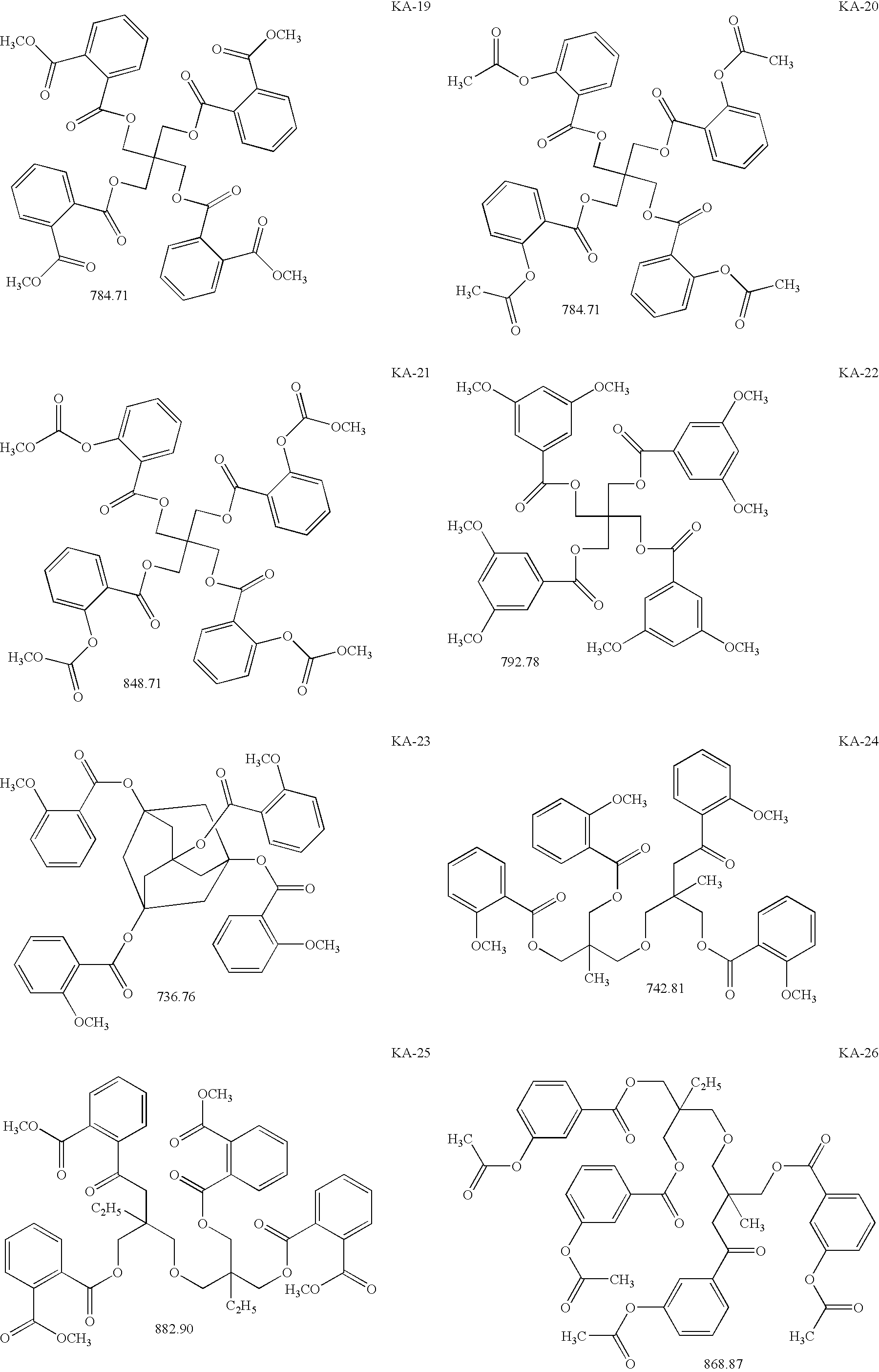

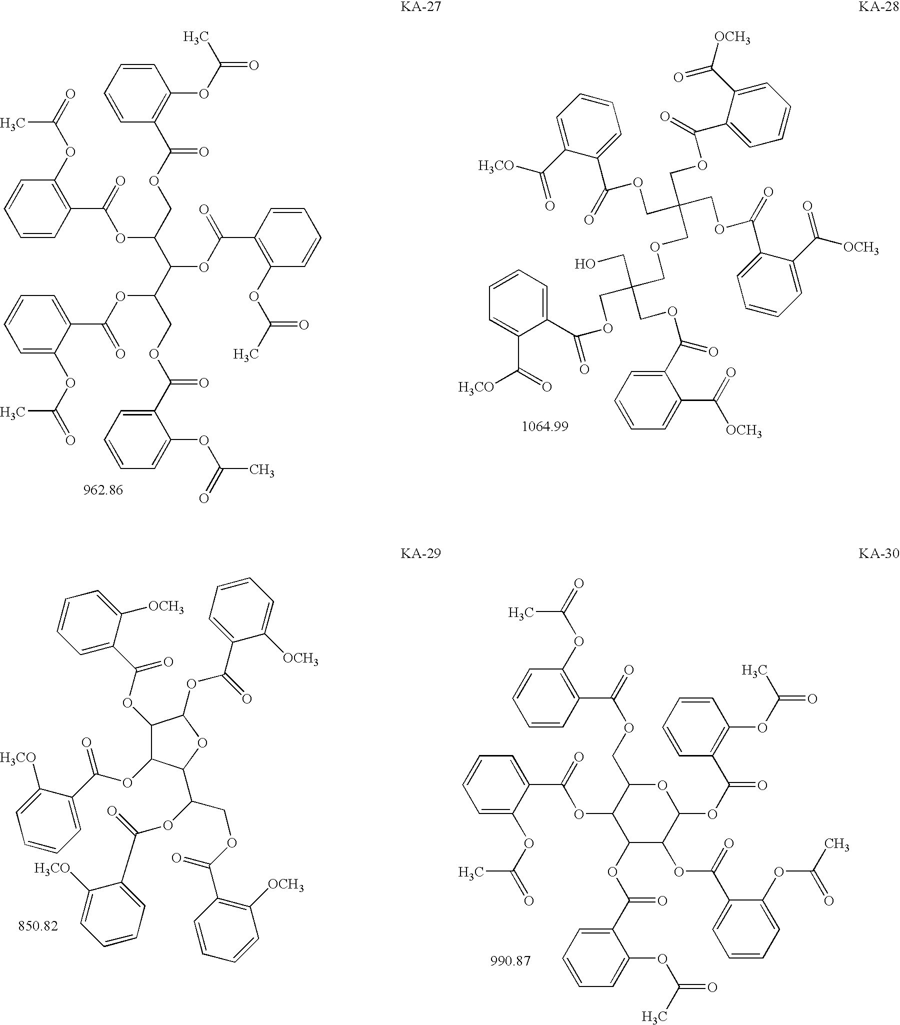

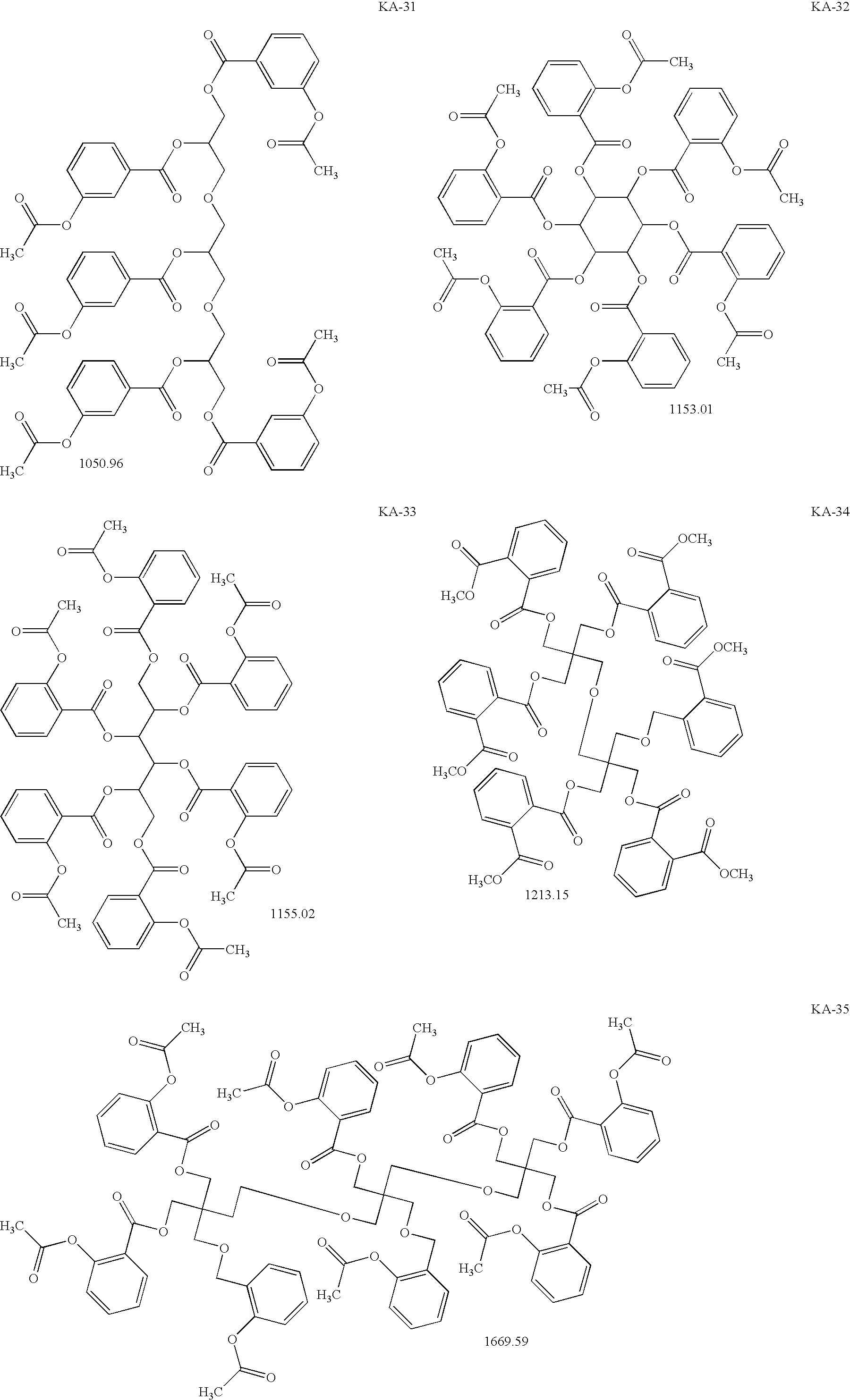

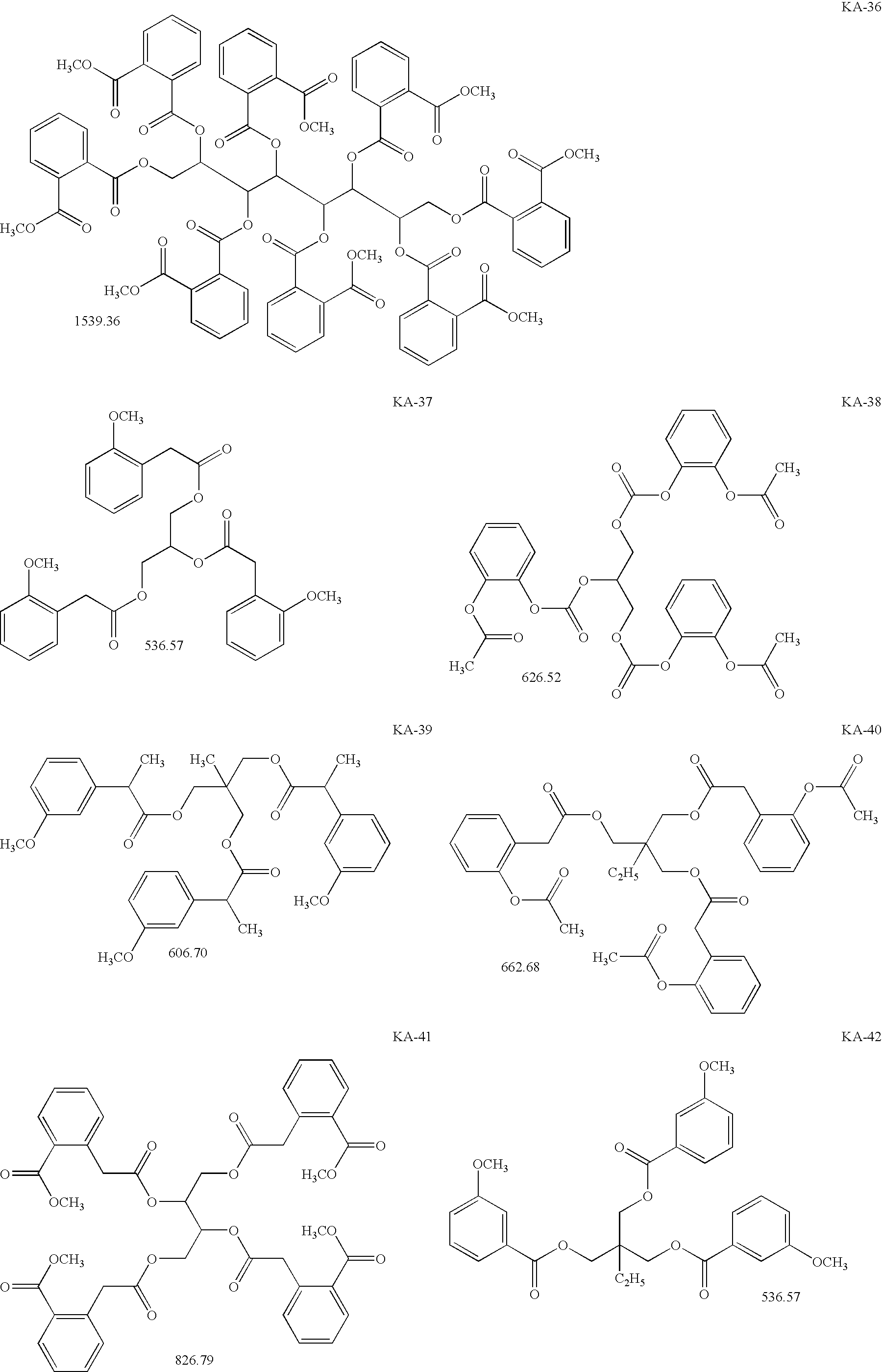

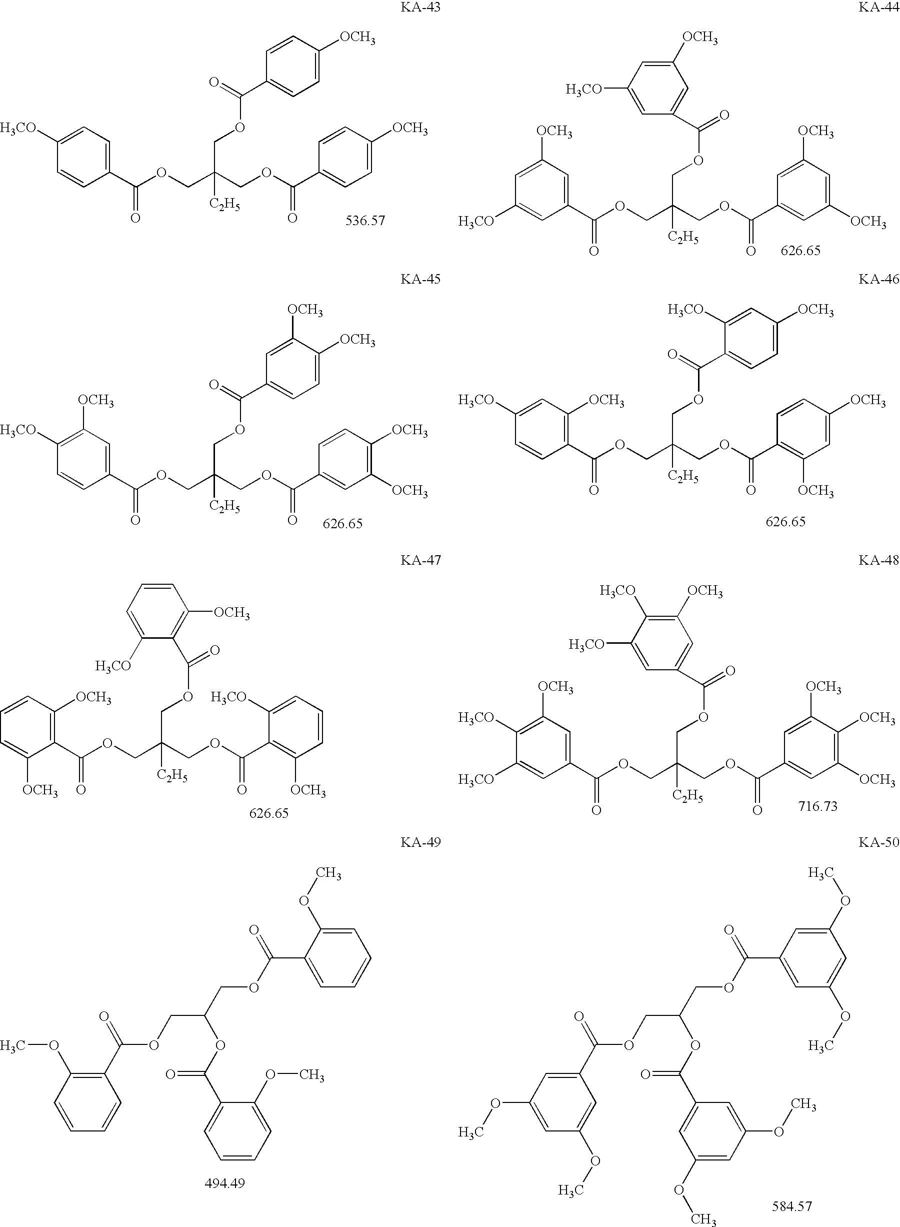

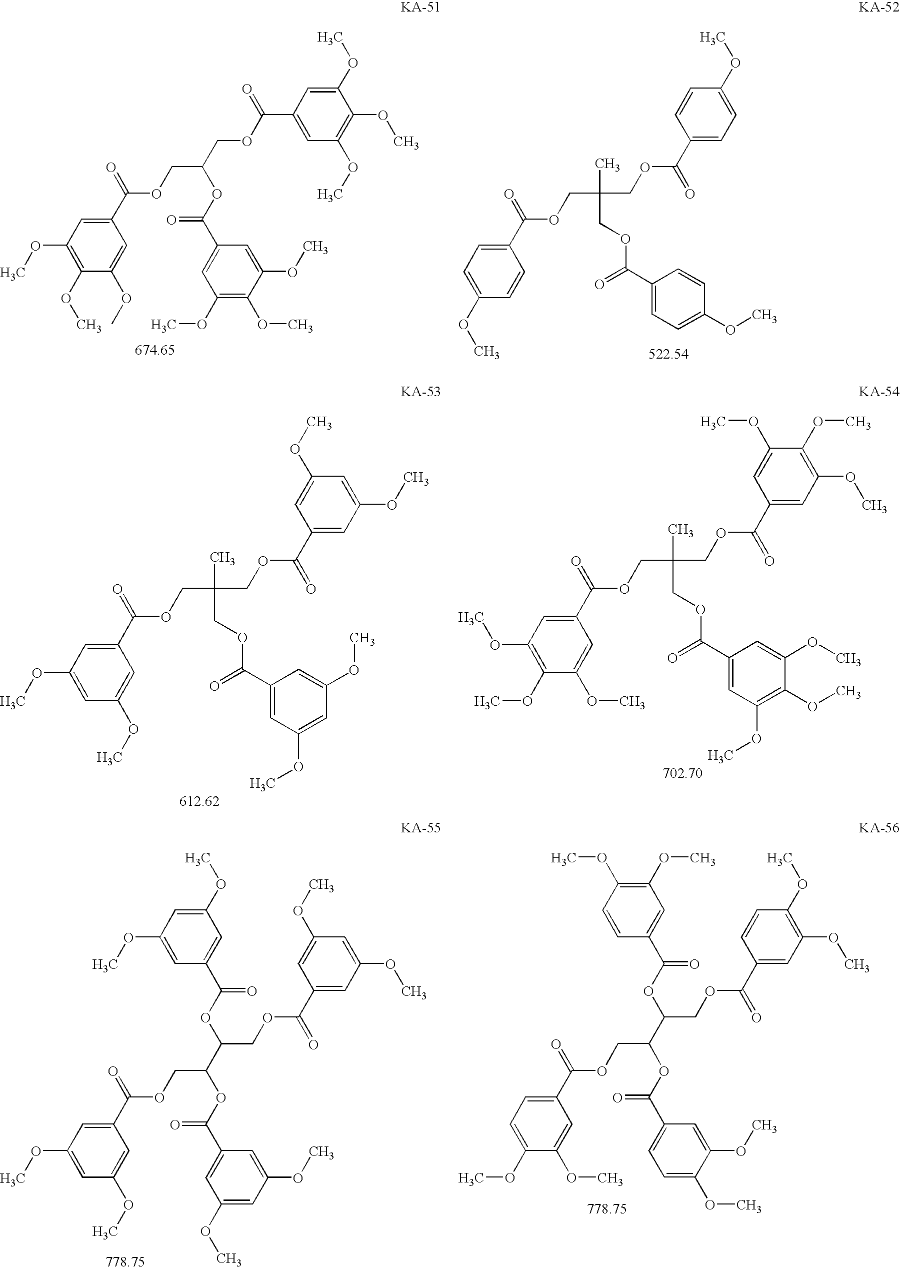

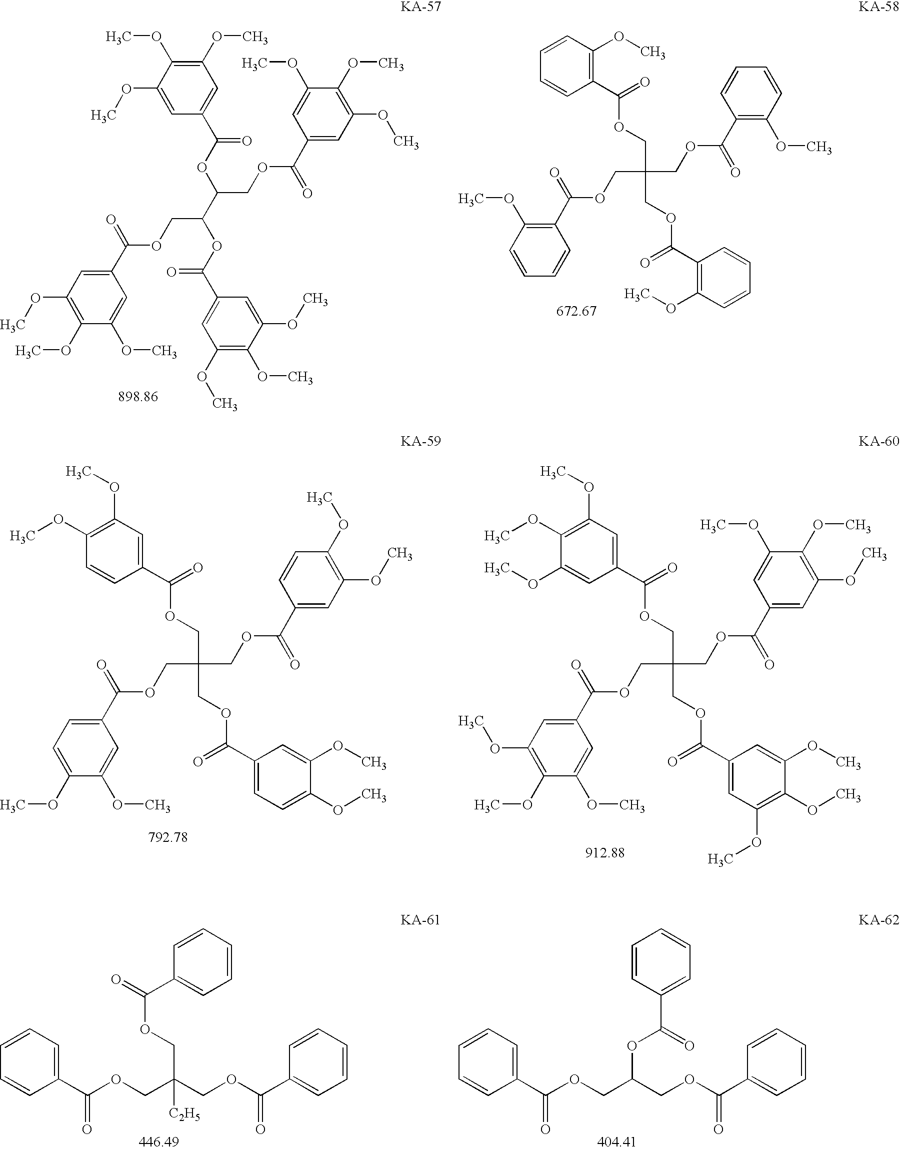

The cellulose acylate film of the present invention may use another plasticizer together with the above.

An ester compound derived from an organic acid represented by Formula (2) and a polyalcohol exhibits high compatibility with cellulose ester and can be incorporated in the cellulose ester at a high addition content. Consequently, bleeding-out tends not to occur even when another plasticizer or additive is used together, whereby other plasticizer or additive can be easily used together, if desired.

Further, when another plasticizer is simultaneously employed, the plasticizers represented by Formula (2) is preferably at least 50 percent by weight, more preferably at least 70 percent, but still more preferably at least 80 percent, based on the total weight of the plasticizers. When the plasticizer of the present invention is employed in the above range, it is possible to achieve a definite effect that the flatness of cellulose ester film produced by a melt-casting method is improved even under simultaneous use of other plasticizers.

Examples of other preferable plasticizers include the following plasticizers.

(Ester plasticizer made up of polyvalent alcohol and monovalent carboxylic acid, and ester plasticizer made up of polyvalent carboxylic acid and monovalent alcohol)

The ester plasticizer made up of polyvalent alcohol and monovalent carboxylic acid, and ester plasticizer made up of polyvalent carboxylic acid and monovalent alcohol) are preferably used because of excellent affinity with cellulose ester.

The ethylene glycol ester plasticizer as one of the polyvalent alcohol esters is exemplified by an ethylene glycol alkyl ester plasticizer such as ethylene glycol diacetate and ethylene glycol dibutylate; an ethylene glycol cycloalkyl ester plasticizer such as ethylene glycol dicyclopropyl carboxylate and ethyleneglycol dicyclohexyl carboxylate; and an ethylene glycol-aryl ester plasticizer such as ethylene glycol dibenzoate and ethylene glycol di-4-methyl benzoate. The aforementioned alkylate group, cycloalkylate group and arylate group can be either the same with each other or different from each other. Further, they can be replaced. A mixture of the alkylate group, cycloalkylate group and arylate group can also be used. The substituents thereof can be linked by a covalent bond. The ethylene glycol part can be substituted. The partial structure of the ethylene glycol ester can be pended to part of the polymer or regularly, or can be introduced into part of the molecular structure of an additive such as antioxidant, acid scavenger and ultraviolet absorber.

The glycerine ester plasticizer as one of the polyvalent alcohol esters is exemplified by a glycerine alkyl ester such as triacetin, tributyrin, glycerine diacetate caprylate and glycerineolate propionate; a glycerine cycloalkyl ester such as glycerine tricyclopropyl carboxylate, and glycerine tricyclohexyl carboxylate; a glycerine aryl ester such as glycerine tribenzoate, and glycerine 4-methyl benzoate; a diglycerine alkyl ester such as diglycerine tetraacetylate, diglycerine tetra propionate, diglycerine acetate tricaprylate, and diglycerine tetralaurate; a diglycerine cycloalkyl ester such as diglycerine tetra cyclobutyl carboxylate and diglycerine tetra cyclopentyl carboxylate; and a diglycerine aryl ester such as diglycerine tetrabenzoate and diglycerine 3-methyl benzoate. The alkylate group, cycloalkyl carboxylate group and arylate group can be the same with each other, different from each other, or can be substituted. Further, a mixture of alkylate group, cycloalkyl carboxylate group and arylate group can be used. The substituents thereof can be linked by covalent bond. Further, the glycerine and diglycerine part can be substituted. The partial structure of the glycerine ester and diglycerine ester can be pended to part of the polymer or regularly, or can be introduced into part of the molecular structure of an additive such as antioxidant, acid scavenger and ultraviolet absorber.

Other polyvalent alcohol ester plasticizers are exemplified by the polyvalent alcohol ester plasticizers described in paragraphs 30 through 33 of the Unexamined Japanese Patent Application Publication No. 2003-12823.

The aforementioned alkylate group, cycloalkyl carboxylate group and arylate group can be the same with each other, different from each other, or can be substituted. Further, a mixture of alkylate group, cycloalkyl carboxylate group and arylate group can be used. The substituents thereof can be linked by covalent bond. Further, the polyvalent alcohol part can be substituted. The partial structure of the polyvalent alcohol can be pended to part of the polymer or regularly, or can be introduced into part of the molecular structure of an additive such as antioxidant, acid scavenger and ultraviolet absorber.

Of the ester plasticizers made up of the aforementioned polyvalent alcohol and monovalent carboxylic acid, the alkyl polyvalent alcohol aryl ester is used preferably, and can be exemplified by the aforementioned ethylene glycol dibenzoate, glycerine tribenzoate, diglycerine tetrabenzoate, and compound 16 disclosed in the paragraph 32 of the Unexamined Japanese Patent Application Publication No. 2003-12823.

The dicarboxylic acid ester plasticizer as one of the polyvalent carboxylic acid esters is exemplified by:

an alkyldicarboxylate alkyl ester plasticizer such as didodesylmalonate (C1), dioctyladipate (C4) and dibutylsebacate (C8);

an alkyldicarboxylate cycloalkyl ester plasticizer such as dicyclopentyl succisinate and dicyclohexyl adipate;

an alkyldicarboxylate aryl ester plasticizer such as diphenylsuccisinate, di-4-methyl phenylglutarate;

a cycloalkyldicarboxylate alkyl ester plasticizer such as dihexyl-1,4-cyclohexane dicarboxylate and didesyl bicyclo [2.2.1]heptane-2,3-dicarboxylate;

a cycloalkyldicarboxylate cycloalkyl ester plasticizer such as dicyclohexyl-1,2-cyclobutane dicarboxylate, and dicyclopropyl-1,2-cyclohexyl dicarboxylate;

a cycloalkyldicarboxylate aryl ester plasticizer such as, diphenyl-1,1-cyclopropyl dicarboxylate and di-2-naphthyl-1,4-cyclohexane dicarboxylate;

an aryldicarboxylate alkyl ester plasticizer such as diethyl phthalate, dimethyl phthalate, dioctylphthalate, dibutylphthalate and di-2-ethyl hexyl phthalate;

an aryldicarboxylate cycloalkyl ester plasticizer such as dicyclopropyl phthalate and dicyclohexyl phthalate; and

an aryldicarboxylate aryl ester plasticizer such as diphenylphthalate and di-4-methyl phenylphthalate.

These alkoxy group and cycloalkoxy group can be the same with each other, different from each other, or can be mono-substituted. These substituents may be further substituted. Further, a mixture of alkylate group and cycloalkyl carboxylate group can be used. The substituents thereof can be linked by covalent bond. Further, the aromatic ring of the phthalic acid can be substituted. A polymer such as a dimer, trimer or tetramer may be used. The partial structure of the phthalic acid ester can be pended to part of the polymer or regularly, or can be introduced into part of the molecular structure of an additive such as antioxidant, acid scavenger and ultraviolet absorber.

Other polyvalent carboxylic acid ester plasticizers are exemplified by:

an alkyl polyvalent carboxylic acid alkyl ester plasticizer such as tridodesyltricarbalate and tributyl-meso-butane-1,2,3,4-tetracarboxylate;

an alkyl polyvalent carboxylic acid cycloalkyl ester plasticizer such as tricyclohexyl tricarbalate and tricyclopropyl-2-hydroxy-1,2,3-propane tricarboxylate;

an alkyl polyvalent carboxylic acid aryl ester plasticizer such as triphenyl 2-hydroxy-1,2,3-propane tricarboxylate and tetra 3-methyl phenyltetrahydrofuran-2,3,4,5-tetracarboxylate;

a cycloalkyl polyvalent carboxylic acid alkyl ester plasticizer such as tetrahexyl-1,2,3,4-cyclobutane tetracarboxylate and tetrabutyl-1,2,3,4-cyclopentane tetracarboxylate;

a cycloalkyl polyvalent carboxylic acid cycloalkyl ester plasticizer such as tetra cyclopropyl-1,2,3,4-cyclobutane tetracarboxylate and tricyclohexyl-1,3,5-cyclohexyl tricarboxylate;

a cycloalkyl polyvalent carboxylic acid aryl ester plasticizer such as triphenyl-1,3,5-cyclohexyl tricarboxylate, hexa-4-methyl phenyl-1,2,3,4,5,6-cyclohexyl hexacarboxylate;

an aryl polyvalent carboxylic acid alkyl ester plasticizer such as tridodesylbenzene-1,2,4-tricarboxylate, tetraoctyl benzene-1,2,4,5-tetracarboxylate;

an aryl polyvalent carboxylic acid cycloalkyl ester plasticizer such as tricyclopentyl benzene-1,3,5-tricarboxylate and tetra cyclohexyl benzene-1,2,3,5-tetracarboxylate; and

an aryl polyvalent carboxylic acid aryl ester plasticizer such as triphenylbenzene-1,3,5-tetracarboxylate, hexa 4-methyl phenylbenzene-1,2,3,4,5,6-hexacarboxylate. These alkoxy group and cycloalkoxy group can be the same with each other, different from each other, or can be mono-substituted. These substituents may be further substituted. Further, a mixture of alkyl group and cycloalkyl group can be used. The substituents thereof can be linked by covalent bond. Further, the aromatic ring of the phthalic acid can be substituted. A polymer such as a dimer, trimer or tetramer may be used. The partial structure of the phthalic acid ester can be pended to part of the polymer or regularly, or can be introduced into part of the molecular structure of an additive such as antioxidant, acid scavenger and ultraviolet absorber.

Of the ester plasticizers made up of the polyvalent carboxylic acid and monovalent alcohol, the dialkyl carboxylic acid alkyl ester is preferably used, and is exemplified by the aforementioned dioctyladipate and tridesyltricarbalate.

(Other Plasticizers)

Other plasticizers used in the present invention are exemplified by a phosphoric acid ester plasticizer, carbohydrate ester plasticizer and polymer plasticizer.

The phosphoric acid ester plasticizer is exemplified by:

a phosphate alkyl ester such as triacetyl phosphate and tributyl phosphate;

a phosphate cycloalkyl ester such as tricyclopentyl phosphate, cyclohexyl phosphate; and

a phosphate aryl ester such as triphenyl phosphate, tricresyl phosphate, cresyl phenyl phosphate, octyl diphenyl phosphate, diphenylbiphenyl phosphate, trioctyl phosphate, tributyl phosphate, trinaphthyl phosphate, trixylylphosphate and trisortho-biphenyl phosphate.

These substitutes can be the same with each other, different from each other, or can be further substituted. Further, a mixture of an alkyl group, cycloalkyl group and aryl group can be used. The substituents can be linked with each other by covalent bond.

It is also possible to mention:

an alkylene bis(dialkyl phosphate) such as ethylene bis(dimethyl phosphate) and butylene bis(diethyl phosphate);

an alkylene bis(diaryl phosphate) such as ethylene bis(diphenyl phosphate) and propylene bis(dinaphthyl phosphate);

an arylene bis(dialkyl phosphate) such as phenylene bis(dibutyl phosphate) and biphenylene bis(dioctyl phosphate); and

a phosphoric acid ester such as arylene bis(diaryl phosphate) including phenylene bis(diphenyl phosphate) and naphthylene bis(ditoluoyl phosphate).

These substitutes can be the same with each other, different from each other, or can be further substituted. Further, a mixture of an alkyl group, cycloalkyl group and aryl group can be used. The substituents can be linked with each other by covalent bond.

Further, the partial structure of the phosphoric acid ester can be pended to part of the polymer or regularly, or can be introduced into part of the molecular structure of an additive such as antioxidant, acid scavenger and ultraviolet absorber. Of the aforementioned compounds, phosphate aryl ester and arylene bis(diaryl phosphate) are preferably used, and is exemplified by triphenyl phosphate, phenylene bis(diphenyl phosphate).

The following describes the carbohydrate ester plasticizer: The carbohydrate can be defined as a monosaccharide, disaccharide or trisaccharide wherein the saccharides are present in the form of pyranose or furanose (six- or five-membered ring). The carbohydrate can be exemplified in an unrestricted sense by glucose, saccharose, lactose, cellobiose, mannose, xylose, ribose, galactose, arabinose, fructose, sorbose, cellotriose and raffinose. The carbohydrate ester refers to the ester compound formed by the hydroxyl group of carbohydrate and carboxylic acid by dehydration and condensation. To put it in greater details, it refers to the aliphatic carboxylic acid ester of the carbohydrate or aromatic carboxylic acid ester. The aliphatic carboxylic acid can be exemplified by acetic acid and propionic acid. The aromatic carboxylic acid is exemplified by benzoic acid, toluic acid and anisic acid. The carbohydrate has the number of hydroxyl groups in conformity to the type. The ester compound can be formed by reaction between part of the hydroxyl group and carboxylic acid, or by reaction between the entire hydroxyl group and carboxylic acid. In the present invention, the ester compound is preferably formed by reaction between the entire hydroxyl group and carboxylic acid.

The carbohydrate ester plasticizer can be preferably exemplified by glucose penta acetate, glucose penta propionate, glucose pentabutylate, saccharose octaacetate, and saccharose octabenzoate. Of these, saccharose octaacetate is preferably used.

The polymer plasticizer is exemplified by: an aliphatic hydrocarbon polymer; an alicyclic hydrocarbon polymer; an acryl polymer such as polyacrylic acid ethyl, polymethacrylic acid methyl, copolymer between methacrylic acid methyl and methacrylic acid-2-hydroxyethyl (e.g., copolymer of any ratio between 1:99 and 99:1); a vinyl based polymer, such as polyvinyl isobutylether and poly-N-vinyl pyrrolidone

a styrene polymer such as polystyrene and poly-4-hydroxystyrene; a polyester such as polybutylene succisinate, polyethylene terephthalate, polyethylene naphthalate; a polyether such as polyethylene oxide and polypropylene oxide; polyamide, polyurethane, and polyurea. The number average molecular weight is preferably about 1,000 through 500,000, and more preferably 5,000 through 200,000. If this value is less than 1,000, a volatilization problem will occur. If it is over 500,000, the plasticization performance will deteriorate to give an adverse effect to the mechanical properties of the cellulose ester film. The polymer plasticizer can be an independent polymer made up of one repeating unit or a copolymer containing a plurality of repeating structures. Further, two or more of the aforementioned polymers can be used in combination.

The cellulose acylate film of the present invention will give an adverse effect to the optical application if colored. To avoid this, the yellow index (YI) is preferably 3.0 or less, more preferably 1.0 or less. The yellow index can be measured according to the JIS-K 7103.

Similarly to the case of the aforementioned cellulose ester, the plasticizer is preferably cleared of impurities such as residual acids, inorganic salts and organic low molecules that were produced in the manufacturing phase or that have occurred during storage. The plasticizer is more preferably purified to a purity level of 99% or more. The amount of the residual acids and water is preferably 0.01 through 100 ppm. This will reduce the thermal deterioration and will enhance the film making stability, film optical property and film mechanical property when the cellulose resin is subjected to the process of melting film formation method.

(Antioxidant to be Used in Combination)

Decomposition of the cellulose ester is promoted not only by heat but also by oxygen under the conditions of high temperature wherein a film is formed by melting method. In the cellulose acylate film of the present invention, an antioxidant as a stabilizer is preferably used in combination as the compound essential to the present invention.

Any compound can be used as the useful antioxidant for the present invention if it is capable of reducing the deterioration of the melt molding material by oxygen. The particularly useful antioxidant can be exemplified by a phenol compound, hindered amine compound, phosphoric acid compound, sulfur compound, heat-resistant processed stabilizer, and oxygen scavenger. Of these, a phenol compound, hindered amine compound, phosphoric acid compound, and lactone compound are used with particular preference.

A 2,2,6,6-tetra alkyl piperidine compound, salt supplied with the acid thereof or the complex of these and metallic compound is preferably used as a hindered amine compound (HALS), as disclosed in the columns 5 through 11 of the Specification of the U.S. Pat. No. 4,619,956 and the columns 3 through S of the Specification of the U.S. Pat. No. 4,839,405. The commercially available product can be exemplified by LA52 (made by Asahi Denka Co., Ltd.)

As a lactone type composition, a composition disclosed in Japanese Unexamined Patent Application Publication Nos. HEI7-233160 and HEI7-247278 may be preferable, especially the lactone type composition represented by Formula (5) is preferable.

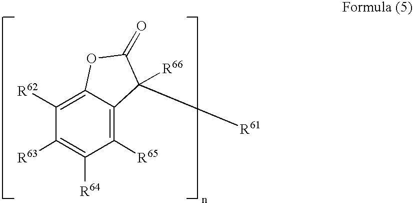

In Formula (5), R⁶² through R⁶⁶ each represents independently a halogen atom or substituents, and examples of the substituents represented by formula R⁶² through R⁶⁶ include an alkyl group (for example, a methyl group, an ethyl group, a propyl group, an isopropyl group, a t-butyl group, a pentyl group, a hexyl group, an octyl group, a dodecyl group, or a trifluoromethyl group), a cycloalkyl group (for example, a cyclopentyl group or a cyclohexyl group), an aryl group (for example, a phenyl group, or a naphthyl group), an acylamino group (for example, an acetylamino group, or a benzoylamino group), an alkylthio group (for example, a methylthio group, or an ethylthio group), an arylthio group (for example, a phenylthio group or a naphthylthio group), an alkenyl group (for example, a vinyl group, 2-propenyl group, a 3-butenyl group, a 1-methyl-3-propenyl group, a 3-pentenyl group, a 1-methyl-3-butenyl group, a hexenyl group or a cyclohexenyl group), a halogen atom (for example, fluorine, chlorine, bromine, iodine), an alkinyl group (for example, a propargyl group), a heterocyclic group (for example, pyridyl group, a thiazolyl group, an oxazolyl group or an imidazolyl group), an alkylsulfonyl group (for example, a methylsulfonyl group or an ethylsulfonyl group), an arylsulfonyl group (for example, a phenylsulfonyl group or a naphthylsulfonyl group), a sulfinyl group (for example, a methylsulfinyl group), an arylsulfonyl group (a phenylsulfinyl group), a phosphono group, an acyl group (for example, an acetyl group, a pivaloyl group or a benzoyl group), a carbamoyl group (for example, an aminocarbonyl group, a methylaminocarbonyl group, a dimethylaminocarbonyl group, a butylaminocarbonyl group, a cyclohexylaminocarbonyl group, a phenylaminocarbonyl group, or a 2-pyridylaminocarbonyl group), a sulfamoyl group (for example, an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group or a 2-pyridylaminosulfonyl group), a sulfonamide group (for example, a methanesulfonamide group or a benzene sulfonamide group), a cyano group, an alkoxy group (for example, a methoxy group, an ethoxy group, or a propoxy group), an aryloxy group (for example, a phenoxy group or a naphthyloxy group), a heterocycleoxy group, a silyloxy group, an acyloxy group (for example, an acetyloxy group, or a benzoyloxy group), a sulfonic acid group, a sulfonate group, an aminocarbonyloxy group, an amino group (for example, an amino group, an ethylamino group, a dimethylamino group, a butylaminocarbonyl group, a cyclopentylamino group, a 2-ethylhexylamino group, or a dodecylamino group), an anilino group (for example, a phenylamino group, a chlorophenylamino group, a toluidino group, an anisidino group, a naphthylamino group or a 2-pyridylamino group), an imino group, a ureido group (for example, a methylureido group, an ethylureido group, a pentylureido group, a cyclohexylureido group, an octylureido group, a dodecylureido group, a phenylureido group, a naphthylureido group, or a 2-pyridylureido group), an alkoxycarbonylamino group (for example, a methoxycarbonylamino group or a phenoxycarbonylamino group), an alkoxycarbonyl group (for example, a methoxycarbonyl group or an ethoxycarbonyl group), an aryloxycarbonyl group (for example, a phenoxycarbonyl group), a heterocyclicthio group, a thioureido group, a carboxyl group, a carboxylate group, a hydroxyl group, a mercapto group, and a nitro group. These substituents may be further substituted with the similar substituents.

In Formula (5), n is 1 or 2.

In Formula (5), when n is 1, R⁶¹ is a substituent, and when n is 2, R⁶¹ is a divalent linkage group. When R⁶¹ is a substituents, examples of the substituent include the same substituents denoted in R⁶² through R⁶⁶ above. When R⁶¹ is a divalent linkage group, examples of the divalent linkage group include a substituted or unsubstituted alkylene group, a substituted or unsubstituted arylene group, an oxygen atom, a nitrogen atom, a sulfur atom or a combination thereof. In Formula (5), n is preferably 1.

Examples of the compound represented by Formula 5 will be listed below, but the invention is not limited thereto.

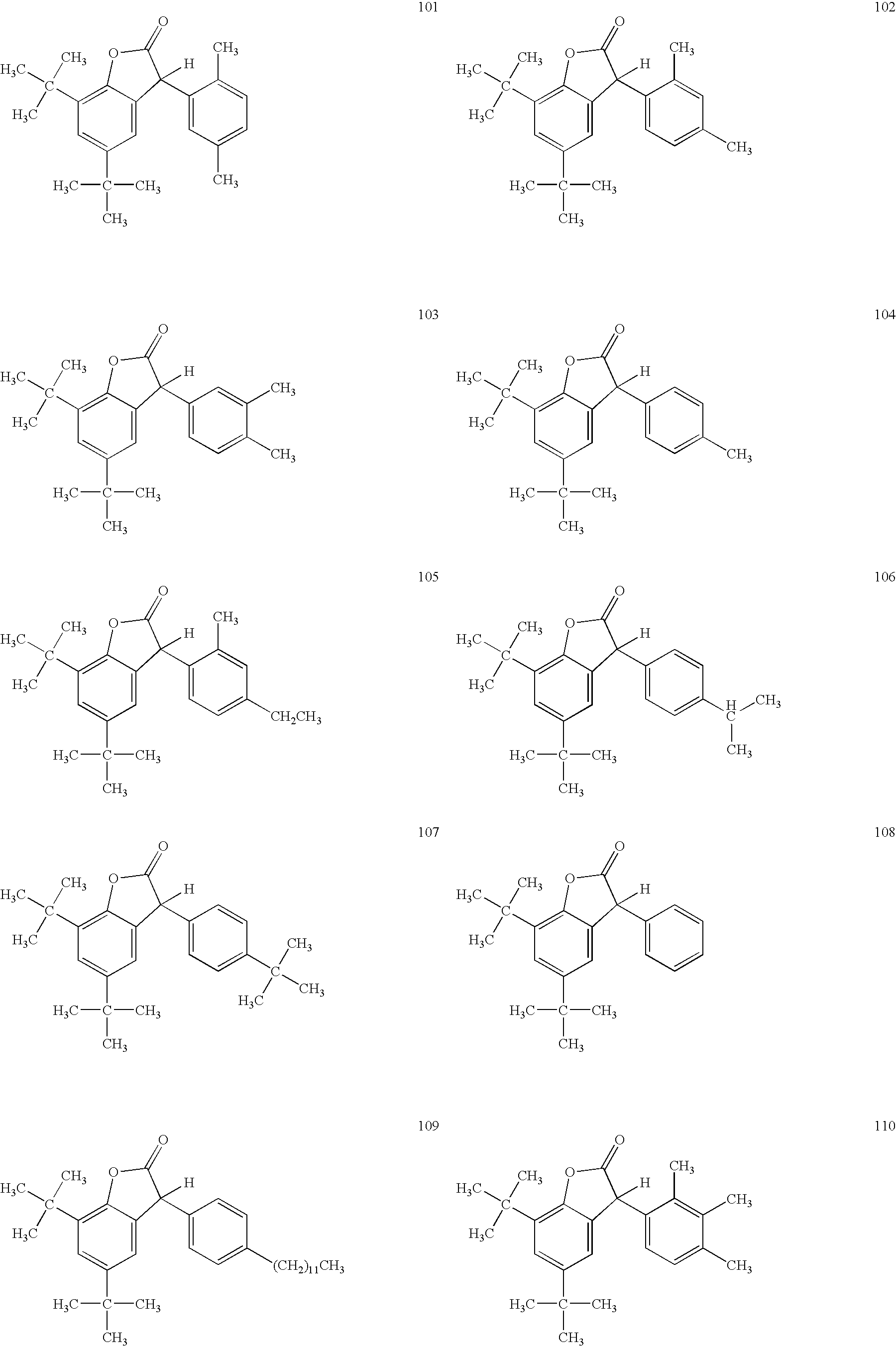

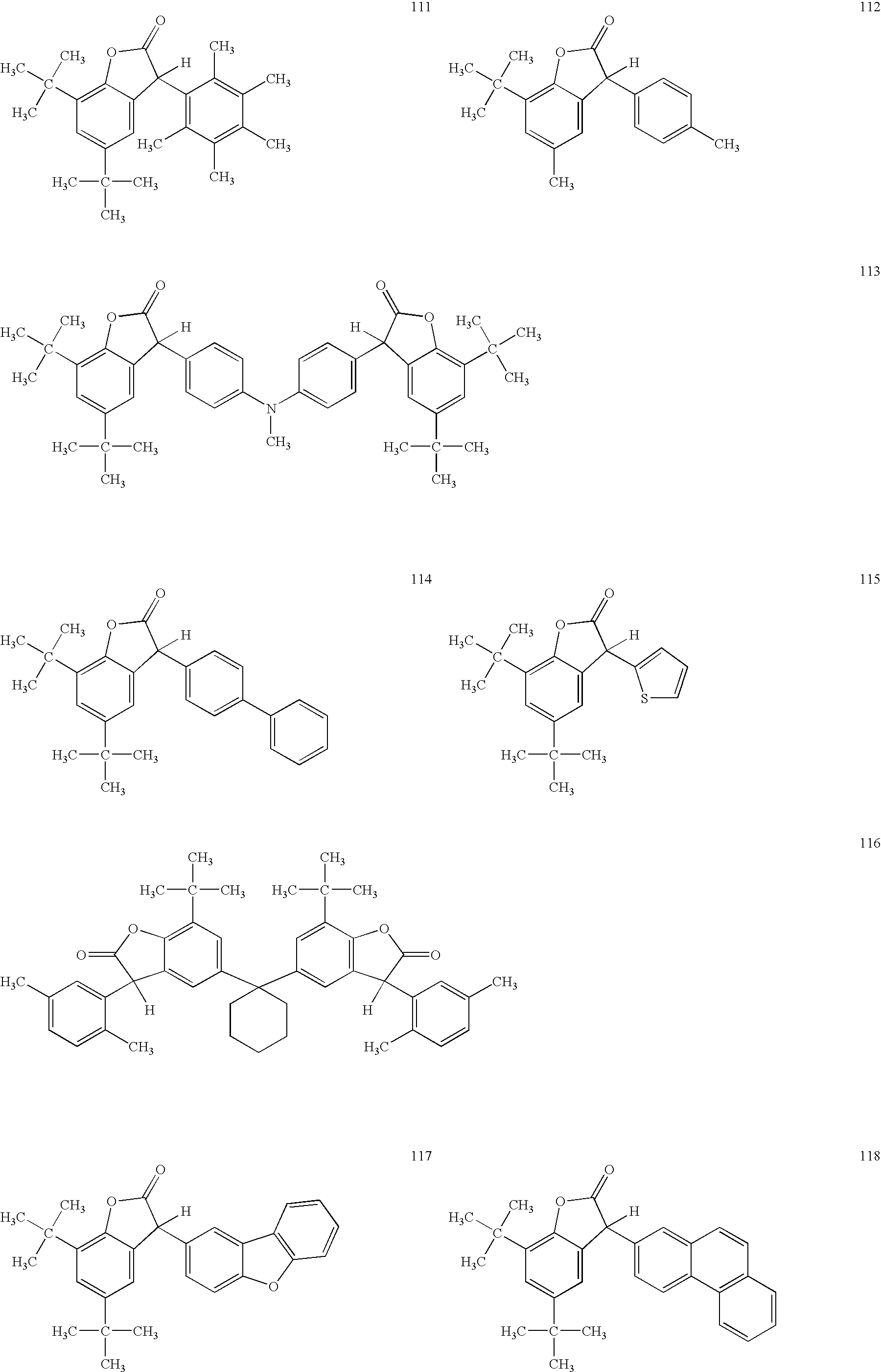

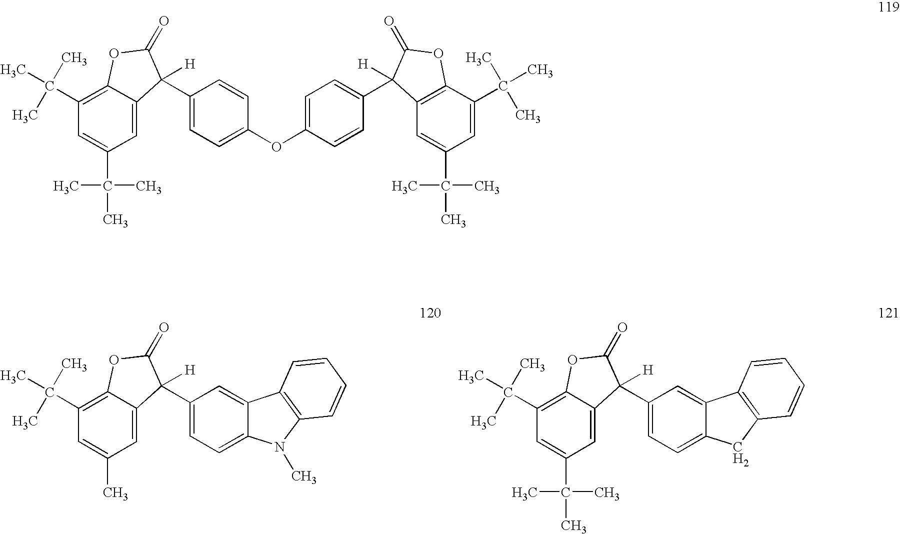

These stabilizers can be used singly or as an admixture of two or more kinds thereof. The added amount of the compound may appropriately selected from a range with which the object of the present invention is no spoiled, however, it is preferably from 0.001 to 10.0 parts by weight and more preferably from 0.01 to 5.0 parts by weight, and still more preferably from 0.1 to 3.0 parts by weight, base on 100 parts by weight of cellulose ester.

By the addition of these compounds, the formed material can be prevented from coloring or deteriorating in strength due to heat or thermal oxidation deterioration at the time of melting formation without degrading transparency and heat resistance.

The adding amount of an antioxidant is usually 0.01 to 10 parts by weight, preferably 0.05 to 5 parts by weight, and more preferably 0.1 to 3 parts by weight based on 100 parts by weight of cellulose ester.

(Acid Scavengers)

The acid scavenger is an agent that has the role of trapping the acid (proton acid) remaining in the cellulose ester that is brought in. Also when the cellulose ester is melted, the side chain hydrolysis is promoted due water in the polymer and the heat, and in the case of CAP, acetic acid or propionic acid is formed. It is sufficient that the acid scavenger is able to chemically bond with acid, and examples include but are not limited to compounds including epoxy, tertiary amines, and ether structures.

Examples thereof include epoxy compounds, which are acid trapping agents described in U.S. Pat. No. 4,137,201. The epoxy compounds which are trapping agents include those known in the technological field, and examples include polyglycols derived by condensation such as diglycidyl ethers of various polyglycols, especially those having approximately 8-40 moles of ethylene oxide per mole of polyglycol, diglycidyl ethers of glycerol and the like, metal epoxy compounds (such as those used in the past in vinyl chloride polymer compositions and those used together with vinyl chloride polymer compositions), epoxy ether condensation products, a diglycidyl ether of Bisphenol A (namely 2,2-bis(4-glycidyloxyphenyl)propane), epoxy unsaturated fatty acid esters (particularly alkyl esters having about 4-2 carbon atoms of fatty acids having 2-22 carbon atoms (such as butyl epoxy stearate) and the like, and various epoxy long-chain fatty acid triglycerides and the like (such as epoxy plant oils which are typically compositions of epoxy soy bean oil and the like and other unsaturated natural oils (these are sometimes called epoxidized natural glycerides or unsaturated fatty acids and these fatty acids generally have 12 to 22 carbon atoms)). Particularly preferable are commercially available epoxy resin compounds, which include an epoxy group such as EPON 815c, and other epoxidized ether oligomer condensates such as those represented by the general formula 6.

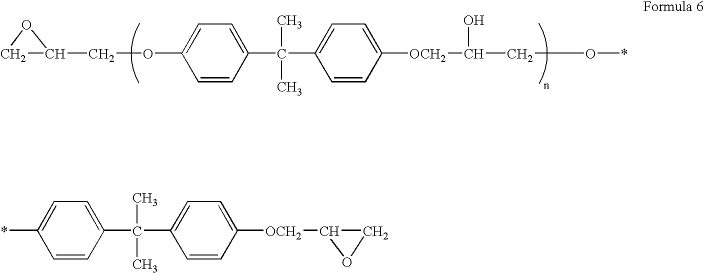

In Formula 6, n is an integer of 0-12. Other examples of acid trapping agents that can be used include those described in paragraphs 87-105 in JP-A 5-194788.

As same as the above mentioned cellulose resin, the acid trapping agent desirably removes impurities such as a residual acid, an inorganic salt and an organic low molecule which is be carried over from the time of manufacturing or generated during preservation, and more preferably to obtain a purity of 99% or more. The residual acid and water are preferably 0.01 to 100 ppm, whereby heat deterioration can be refrained in the process of forming a film by melting a cellulose resin, and the film formation stability, the optical property of a film and a mechanical physical property can be improved.

Incidentally, the acid trapping agents may be called an acid capturing agent, an acid scavenging agent, an acid catcher, etc., however, it may be used in the present invention without any difference regardless of these names.

(Ultraviolet Absorbent or Ultraviolet Absorbing Agent)

The ultraviolet absorbent preferably has excellent ultraviolet light absorbance for wavelengths not greater than 370 nm in view of preventing deterioration of the polarizer or the display device due to ultraviolet light, and from the viewpoint of the liquid crystal display it is preferable that there is little absorbance of visible light which has wavelength of not less than 400 nm.

Examples of the ultraviolet absorbent includes salicylic acid type ultraviolet absorbents (such as phenyl salicylate, p-tert-butyl salicylate), or benzophenone type ultraviolet absorbents (such as 2,4-dihydroxybenzophenone, 2,2′-dihydroxy-4,4′-dimethoxybenzophenone), benzotriazole type ultraviolet absorbents (such as 2-(2′-hydroxy-3′-tert-butyl-5′-methyl phenyl)-5-chloro benzotriazole, 2-(2′-hydroxy-3′,5′-di-tert-butylphenyl)-5-chloro benzotriazole, 2-(2′-hydroxy-3′,5′-di-tert-amylphenyl)benzotriazole, 2-(2′-hydroxy-3′-dodecyl-5′-methyl phenyl)benzotriazole, 2-(2′-hydroxy-3′-tert-butyl-5′-(2-octyl oxycarbonyl ethyl)-phenyl)-5-chlorobenzotriazol, 2-(2′-hydroxy-3′-(1-methyl-1-phenyl ethyl)-5′-(1,1,3,3,-tetramethyl butyl)-phenyl)benzotriazol, 2-(2′-hydroxy-3′,5′-di-(1-methyl-1-phenyl ethyl)-phenyl)benzotriazol), cyano acrylate type ultraviolet absorbents (such as 2′-ethylhexyl-2-cyano-3,3-diphenyl acrylate, ethyl-2-cyano-3-(3′,4-methylene dioxyphenyl)-acrylate), triazin type ultraviolet absorbents, compounds described in JP-A Nos. 58-185677, 59-149350, nickel complex compounds and inorganic powders.

As the ultraviolet absorbent concerning the present invention, the benzotriazole type ultraviolet absorbents and the triazin type ultraviolet absorbents which have high transparency and are excellent in effect to prevent the deterioration of a polarizing plate an a liquid crystal element, are preferable, and the benzotriazole type ultraviolet absorbents having a more suitable absorption spectrum is specifically preferable.

A conventionally well-known the benzotriazole type ultraviolet absorbents specifically preferably usable together with the ultraviolet absorbents according to the present invention may be made in bis, for example, 6,6′-methylene bis(2-(2H-benzo[d][1,2,3]triazol-2-yl))-4-(2,4,4,-trimethyl pentan-2-yl)phenol, 6,6′-methylene bis(2-(2H-benzo[d][1,2,3]triazol(e)-2-yl))-4-(2-hydroxyethyl)phenol may be employed.

In the invention, a conventional ultraviolet absorbing polymer can be used in combination. The conventional ultraviolet absorbing polymer is not specifically limited, but there is, for example, a homopolymer obtained by polymerization of LUVA-93 (produced by Otuka Kagaku Co., Ltd.) and a copolymer obtained by copolymerization of LUVA-93 and another monomer. Typical examples of the ultraviolet absorbing polymer include PUVA-30M obtained by copolymerization RUVA 93 and methyl methacrylate (3:7 by weight ratio), PUVA-50M obtained by copolymerization RUVA 93 and methyl methacrylate (5:5 by weight ratio), and ultraviolet absorbing polymers disclosed in Japanese Patent O.P.I. Publication No. 2003-113317.

Commercially available TINUVIN 109, TINUVIN 171, TINUVIN 900 and TINUVIN 928 (each being manufactured by Chiba Specialty Chemical Co., Ltd.), LA-31 (manufactured by Asahi Denka Co., Ltd.), and LUVA-100 (produced by Otuka Kagaku Co., Ltd.) may also be used.

Examples of the benzophenone based compound include 2,4-hydroxy benzophenone, 2,2′-dihydroxy-4-methoxy benzophenone, 2-hydroxy-4-methoxy-5-sulfobenzophenone, bis (2-methoxy-4-hydroxy-5-benzoyl phenyl methane) and the like, but are not limited thereto.

In the present invention, the ultraviolet absorbents may be preferably added in an amount of 0.1 to 20% by weight, more preferably 0.5 to 10% by weight, still more preferably 1 to 5% by weight. These may be used in a combination of two or more kinds.

<<Viscosity Lowering Agent>>

In the present invention, a hydrogen bondable solvent may be added in order to reduce a melt viscosity. The hydrogen bondable solvent means an organic solvent capable of causing “bonding” of a hydrogen atom mediation generated between electrically negative atoms (oxygen, nitrogen, fluorine, chlorine) and hydrogen covalent bonding with the electrically negative atoms, in other word, it means an organic solvent capable of arranging molecules approaching to each other with a large bonding moment and by containing a bond including hydrogen such as O—H ((oxygen hydrogen bond), N—H (nitrogen hydrogen bond) and F—H (fluorine hydrogen bond), as disclosed in the publication “inter-molecular force and surface force” written by J. N. Israelachibiri (translated by Yasushi Kondo and Hiroyuki Ohshima, published by McGraw-Hill, 1991). Since the hydrogen bondable solvent has an ability to form a hydrogen bond between celluloses stronger than that between molecules of cellulose ester, the melting temperature of a cellulose ester composition can be lowered by the addition of the hydrogen bondable solvent than the glass transition temperature of a cellulose ester alone in the melting casting method conducted in the present invention. Further, the melting viscosity of a cellulose ester composition containing the hydrogen bondable solvent can be lowered than that of a cellulose ester in the same melting temperature.

Examples of the hydrogen bondable solvents include alcohol such as methanol, ethanol, propanol, isopropanol, n-butanol, sec-butanol, t-butanol, 2-ethyl hexanol, heptanol, octanol, nonanol, dodecanol, ethylene glycol, propylene glycol, hexylene glycol, dipropylene glycol, polyethylene glycol, polypropylene glycol, methyl cellosolve, ethyl cellosolve, butyl cellosolve, hexyl cellosolve, and glycerol; ketone suc as acetone and methyl ethyl ketone; carboxylic acid such as formic acid, acetic acid, propionic acid, and butyric acid; ether such as diethyl ether, tetrahydrofuran, and dioxane; pyrolidone such as N-methylpyrolidone; and amines such as trimethylamine and pyridine. These hydrogen bondable solvents may be used alone or a mixture of two or more kinds. Among them, alcohol, ketone, and ether are desirable, and especially, methanol, ethanol, propanol, isopropanol, octanol, dodecanol, ethylene glycol, glycerol, acetone, and tetrahydrofuran are desirable. Further, water-soluble solvents such as methanol, ethanol, propanol, isopropanol, ethylene glycol, glycerol, acetone, and tetrahydrofuran are more preferable. Here, “water soluble” means that the solubility for 100 g of water is 10 g or more.

<<Retardation Adjusting Agent>>

In the cellulose acylate film of the present invention, a polarizing plate treatment to provide an optical compensation function may be conducted such that a liquid crystal layer is formed on the cellulose acylate film by forming an orientation layer so as to combine the retardation of the cellulose acylate film and that of the liquid crystal layer, or a polarizing plate protection film may be made to contain a compound for adjusting the retardation. As the composition to be added to adjust the retardation, an aromatic compound including two or more aromatic rings disclosed in the specification of the European patent No. 911,656 A2 may be used or two or more kinds of aromatic compound may be used. Examples of the aromatic rings of the aromatic compound include aromatic hetero rings in addition to aromatic hydrocarbon rings. The aromatic hetero rings may be more preferable, and the aromatic hetero rings are generally unsaturated hetero rings. Especially, compounds having 1,3,5-triazine ring are desirable.

(Matting Agents)

In order to provide a lubricant property, as well as optical and mechanical functions, a matting agent is incorporated into to the cellulose acylate film of the present invention. Listed as such matting agents are particles of inorganic or organic compounds. Preferably employed matting agents are spherical, rod-shaped, acicular, layered and tabular. Examples of a matting agent include: inorganic particles of metal oxides, metal phosphates, metal silicates and metal carbonates such as silicon dioxide, titanium dioxide, aluminum oxide, zirconium oxide, calcium carbonate, kaolin, talc, calcined calcium silicate, hydrated calcium silicate, aluminum silicate, magnesium silicate, or calcium phosphate; and crosslinking polymer particles. Of these, silicon dioxide is preferred due to a resulting decrease in film haze. It is preferable that these particles are subjected to a surface treatment, since it is possible to lower the film haze.

The above surface treatment is preferably carried out employing halosilane, alkoxysilane, silazane, or siloxane. As the average diameter of the particles increases, lubricant effect is enhanced, while, as the average diameter decreases, the transparency of the film increases. The average diameter of the secondary particles is 0.05-1.0 μm, preferably 5-50 nm, but is more preferably 7-14 nm. These particles are preferably employed to form unevenness of 0.01-1.0 μm on the surface of the cellulose acylate film. The content of the particles in cellulose ester is preferably 0.005 to 0.3% by weight for the cellulose ester.

Examples of silicon dioxide particles include AEROSIL 200, 200V, 300, R972, R972V, R974, R202, R812, OX50, TT600 and NAX50 (all of which are produced by Nihon Aerosil Co., Ltd); KE-P10, KE-P30, KE-P100, KE-P150 (Produced by NIPPON SHOKUBAI Co., Ltd.). Of these, preferred are AEROSIL 200V, R972, NAX50, KE-P30 and KE-P100. When two types of the particles are employed in combination, they may be mixed at an optional ratio to use. It is possible to use particles different in the average particle diameter or in materials, for example, AEROSIL 200V and R972V can be used at a weight ratio in the range of 0.1:99.9 to 99.9:0.1.

Existence of particulates used as the above-mentioned matting agent in a film may also be used to increase the strength of a film as another purposes. Moreover, the existence of the above-mentioned particulates in a film can also improve the orientation ability of cellulose ester constituting the cellulose acylate film of the present invention.

(Polymer Material)

The cellulose acylate film of the present invention may be mixed with polymer materials and oligomers suitably selected other than cellulose ester. The polymer materials and the oligomers may be preferably those which are excellent in compatibility with cellulose ester, has a transmittance of 80% or more, more preferably 90% or more, still more preferably 92% or more in a form of a film. The purposes of mixing at least one or more kinds of polymer materials or oligomers other than cellulose ester includes intentions to improve viscosity control film at the time of heating melting and physical properties after film processing. In this case, it may be contained as above-mentioned other additives.

<Melt Casting Method>

The film constituting material is required to generate very small amount of volatile matter or no volatile matter at all in the melting and film formation process. This is intended to ensure that the foaming occurs at the time of heating and melting to remove or avoid the defect inside the film and poor flatness on the film surface.

When the film constituting material is molten, the amount of the volatile matter contained is 1 by mass or less, preferably 0.5% by mass or less, more preferably 0.2% by mass or less, still more preferably 0.1% by mass or less. In the present invention, a differential thermogravimetric apparatus (differential weight calorimetry (TG/DTA 200 by Seiko Denshi Kogyo Co., Ltd.) is used to get a weight loss on heating from 30° C. through 250° C. The result is used as the amount of the volatile matter contained.

Before film formation or at the time of heating, the moisture and the volatile components represented the aforementioned solvent are preferably removed from the film constituting material to be used. They can be removed by the conventional known method. A heating method, depressurization method, or heating/depressurization method can be used to remove them in air or in nitrogen atmosphere as an inert gas atmosphere. When the known drying method is used, this procedure is carried out in the temperature range wherein the film constituting material is not decomposed. This is preferred to ensure good film quality.

Generation of the volatile components can be reduced by the drying step prior to film formation. It is possible to dry the resin independently, or dry the resin and film constituting materials by separating into a mixture or compatible substances made of at least one or more types other than the resin. The drying temperature is preferably 100° C. or more. If the material to be dried contains any substance having a glass-transition temperature, and is heated up to a drying temperature higher than that glass-transition temperature, the material will be fused and will become difficult to handle. To avoid this, the drying temperature is preferably kept at a level not exceeding the glass-transition temperature. If a plurality of substances has a glass-transition temperature, the glass-transition temperature of the substance having a lower glass-transition temperature should be used as a standard. This temperature is preferably 100° C. or more through (glass-transition temperature −5) ° C. or less, more preferably 110° C. or more through (glass-transition temperature −20) ° C. or less. The drying time is preferably 0.5 through 24 hours, more preferably 1 through 18 hours, still more preferably 1.5 through 12 hours. If the drying temperature is too low, the rate of removing the volatile components will be reduced and much time will be required for drying. The drying process can be divided into two or more steps. For example, the drying process may includes a pre-drying step for storing the material, and a preliminary drying step for the period one week before film formation through the period immediately before film formation.

The film forming method by melt casting can be divided into heating melting molding methods such as a melt-extrusion molding method, press molding method, inflation method, injection molding method, blow molding method, draw molding method, and others. Of these methods, melt-extrusion molding method is preferred to produce a polarizing plate protective film characterized by excellent mechanical strength and surface accuracy. The following describes the film manufacturing method of the present invention with reference to the melt extrusion method:

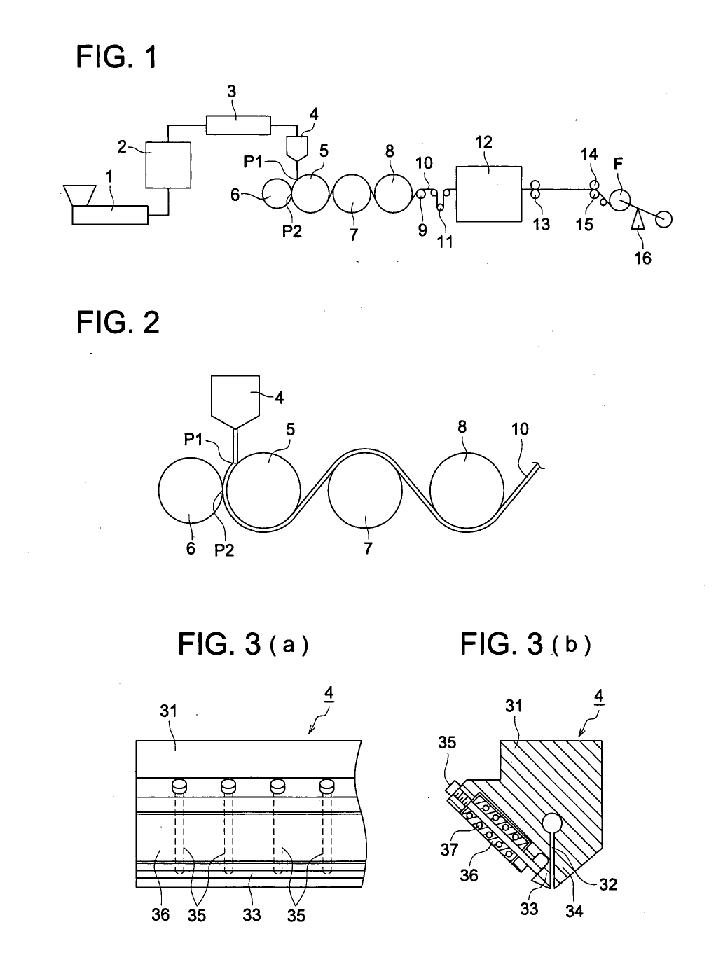

FIG. 1 is a schematic flow sheet showing the overall structure of the apparatus for manufacturing the cellulose acylate film preferably used in the present invention. FIG. 2 is an enlarged view of the cooling roll portion from the flow casting die.

In the cellulose acylate film manufacturing method shown in FIG. 1 and FIG. 2, the film material such as cellulose resin is mixed, then melt extrusion is conducted on a first cooling roll 5 from the flow casting die 4 using the extruder 1. The material is be circumscribed on a first cooling roll 5, second cooling roll 7 and third cooling roll 8—a total of three cooling rolls—sequentially. Thus, the material is cooled, solidified and formed into a film 10. With both ends gripped by a stretching apparatus 12, the film 10 separated by a separation roll 9 is stretched across the width and is wound by a winding apparatus 16. To correct flatness, a touch roll 6 is provided. This is used to press the film against the surface of the first cooling roll 5. This touch roll 6 has an elastic surface and forms a nip with the first cooling roll 5. The details of the touch roll 6 will be described later.

The conditions for the cellulose acylate film manufacturing method are the same as those for thermoplastic resins such as other polyesters. The material is preferably dried in advance. A vacuum or depressurized dryer, or dehumidified hot air dryer is used to dry the material until the moisture is reduced to 1000 ppm or less, preferably 200 ppm or less.

For example, the cellulose ester based resin having been dried under hot air, vacuum or depressurized atmosphere is extruded by the extruder 1 and is molten at a temperature of about 200 through 300° C. The leaf disk filter 2 is used to filter the material to remove foreign substances.

When the material is fed from the feed hopper (not illustrated) to the extruder 1, the material is preferably placed in the vacuum, depressurized or insert gas atmosphere to prevent oxidation and decomposition.

When additives such as plasticizer are not mixed in advance, they can be kneaded into the material during the process of extrusion. To ensure uniform mixing, a mixer such as a static mixer 3 is preferably utilized.

In the present invention, the cellulose resin and the additives such as a stabilizer to be added as required are preferably mixed before being molten. It is more preferred that the cellulose resin and stabilizer should be mixed first. A mixer may be used for mixing. Alternatively, mixing may be completed in the process of preparing the cellulose resin, as described above. It is possible to use a commonly used mixer such as a V-type mixer, conical screw type mixer, horizontal cylindrical type mixer, Henschel mixer and ribbon mixer.

As described above, subsequent to mixing of the film constituting material, the mixture can be directly molten by the extruder 1 to form a film. Alternatively, it is also possible to palletize the film constituting material, and the resultant pellets may be molten by the extruder 1, whereby a film is formed. The following arrangement can also be used: When the film constituting material contains a plurality of materials having different melting points, so-called patchy half-melts are produced at the temperature wherein only the material having a lower melting point is molten. The half-melts are put into the extruder 1, whereby a film is formed. Further, the following arrangement can also be used: If the film constituting material contains the material vulnerable thermal decomposition, a film is directly formed without producing pellets, thereby reducing the frequency of melting. Alternatively, a film is produced after patchy half-melts have been formed, as described above.

Various types of commercially available extruders can be used as the extruder 1. A melt-knead extruder is preferably utilized. Either a single-screw extruder or a twin-screw extruder can be used. When producing a film directly without pellets being formed from the film constituting material, an adequate degree of mixing is essential. In this sense, a twin-screw extruder is preferably used. A single-screw extruder can be used if the screw is changed into a kneading type screw such as a Madoc screw, Unimelt screw or Dulmage screw, because a proper degree of mixing can be obtained by this modification. When pellets or patchy half-melts are used as film constituting materials, both the single screw extruder and twin screw extruder can be used.

In the cooling process inside the extruder 1 and after extrusion, oxygen density is preferably reduced by an inert gas such as nitrogen gas or by depressurization.

The preferred conditions for the melting temperature of the film constituting material inside the extruder 1 vary according to the viscosity and discharge rate of the film constituting material as well as the thickness of the sheet to be produced. Generally, it is Tg or more through Tg+130° C. or less with respect to the glass-transition temperature Tg of the film, preferably Tg+10° C. or more through Tg+120° C. or less. The melt viscosity at the time of extrusion is 10 through 100000 poises, preferably 100 through 10000 poises. The retention time of the film constituting material inside the extruder 1 should be as short as possible. It is within five minutes, preferably within three minutes, more preferably within two minutes. The retention time varies according to the type of the extruder and the conditions for extrusion. It can be reduced by adjusting the amount of the material to be supplied, the L/D, the speed of screw and the depth of screw groove.

The shape and speed of the screw of the extruder 1 are adequately selected in response to the viscosity and discharge rate of the film constituting material. In the present invention, the shear rate of the extruder 1 is 1/sec. through 10000/sec., preferably 5/sec. through 1000/sec., more preferably 10/sec. through 100/sec.

The extruder 1 that can be used in the present invention can be obtained as a plastic molding machine generally available on the market.

The film constituting material extruded from the extruder 1 is fed to the flow casting die 4, and the slit of the flow casting die 4 is extruded as a film. There is no restriction to the flow casting die 4 if it can be used to manufacture a sheet or film. The material of the flow casting die 4 are exemplified by hard chromium, chromium carbonate, chromium nitride, titanium carbide, titanium carbonitride, titanium nitride, cemented carbide, ceramic (tungsten carbide, aluminum oxide, chromium oxide), which are sprayed or plated. Then they are subjected to surface processing, as exemplified by buffing and lapping by a grinder having a count of #1000 or later planar cutting (in the direction perpendicular to the resin flow) by a diamond wheel having a count of #1000 or more, electrolytic grinding, and electrolytic complex grinding. The preferred material of the lip of the flow casting die 4 is the same as that of the flow casting die 4. The surface accuracy of the lip is preferably 0.5 S or less, more preferably 0.2 S or less.

The slit of this flow casting die 4 is designed in such a way that the gap can be adjusted. This is shown in FIG. 3. Of a pair of lips forming the slit 32 of the flow casting die 4, one is the flexible lip 33 of lower rigidity easily to be deformed, and the other is a stationary lip 34. Many heat bolts 35 are arranged at a predetermined pitch across the flow casting die 4, namely, along the length of the slit 32. Each heat bolt 5 includes a block 36 containing a recessed type electric heater 37 and a cooling medium passage. Each heat bolt 35 penetrates the block 36 in the vertical direction. The base of the heat bolt 35 is fixed on the die (main body) 31, and the front end is held in engagement with the outer surface of the flexible lip 33. While the block 36 is constantly cooled, the input of the recessed type electric heater 37 is adjusted to increase or decrease the temperature of the block 36, this adjustment causes thermal extension and contraction of the heat bolt 35, and hence, displacement of the flexible lip 33, whereby the film thickness is adjusted. The following arrangement can also be used: A thickness gauge is provided at predetermined positions in the wake of the die. The web thickness information detected by this gauge is fed back to the control apparatus. This thickness information is compared with the preset thickness information of the control apparatus, whereby the power of the heat generating member of the heat bolt or the ON-rate thereof is controlled by the signal for correction control amount sent from this apparatus. The heat bolt preferably has a length of 20 through 40 cm, and a diameter of 7 through 14 mm. A plurality of heat bolts, for example, several tens of heat bolts are arranged preferably at a pitch of 20 through 40 mm. A gap adjusting member mainly made up of a bolt for adjusting the slit gap by manually movement in the axial direction can be provided, instead of a heat bolt. The slit gap adjusted by the gap adjusting member normally has a diameter of 200 through 1000 μm, preferably 300 through 800 μm, more preferably 400 through 600 μm.

The first through third cooling roll is made of a seamless steel pipe having a wall thickness of about 20 through 30 mm. The surface is mirror finished. It incorporates a tune for feeding a coolant. Heat is absorbed from the film on the roll by the coolant flowing through the tube. Of these first through third cooling rolls, the first cooling roll 5 corresponds to the rotary supporting member of the present invention.

In the meantime, the touch roll 6 held in engagement with the first cooling roll 5 has an elastic surface. It is deformed along the surface of the first cooling roll 5 by the pressure against the first cooling roll 5, and forms a nip between this roll and the first roll 5. To be more specific, the touch roll 6 corresponds to the pressure rotary member of the present invention.

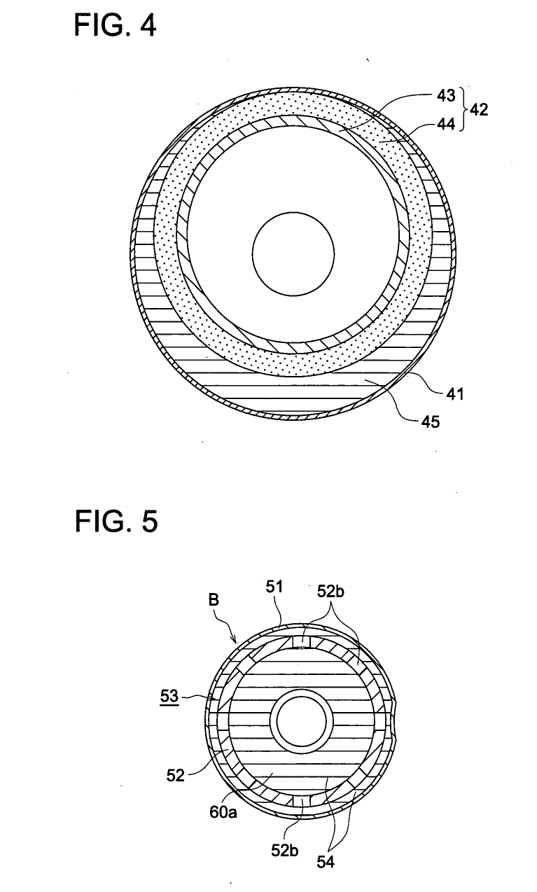

FIG. 4 is a schematic cross section of the touch roll 6 as an embodiment of the present invention (hereinafter referred to as “touch roll A”). As illustrated, the touch roll A is made up of an elastic roller 42 arranged inside the flexible metallic sleeve 41.

The metallic sleeve 41 is made of a stainless steel having a thickness of 0.3 mm, and is characterized by a high degree of flexibility. If the metallic sleeve 41 is too thin, strength will be insufficient. If it is too thick, elasticity will be insufficient. Thus, the thickness of the metallic sleeve 41 is preferably 0.1 through 1.5 mm. The elastic roller 42 is a roll formed by installing a rubber 44 on the surface of the metallic inner sleeve 43 freely rotatable through a bearing. When the touch roll A is pressed against the first cooling roll 5, the elastic roller 42 presses the metallic sleeve 41 against the first cooling roll 5, and the metallic sleeve 41 and elastic roller 42 is deformed, conforming to the shape of the first cooling roll 5, whereby a nip is formed between this roll and the first cooling roll. The cooling water 45 is fed into the space formed inside the metallic sleeve 41 with the elastic roller 42.

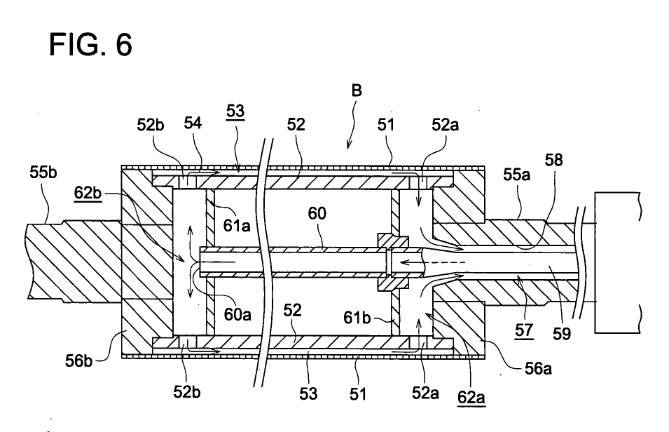

FIG. 5 and FIG. 6 show a touch roll B as another embodiment of the pressure rotary member. The touch roll B is formed of an outer sleeve 51 of flexible seamless stainless steel tube (having a thickness of 4 mm), and metallic inner sleeve 52 of high rigidity arranged coaxially inside this outer sleeve 51. Coolant 54 is led into the space 53 formed between the outer sleeve 51 and inner sleeve 52. To put it in greater details, the touch roll B is formed in such a way that the outer sleeve supporting flanges 56a and 56b are mounted on the rotary shafts 55a and 55b on both ends, and a thin-walled metallic outer sleeve 51 is mounted between the outer peripheral portions of these outer sleeve supporting flanges 56a and 56b. The fluid supply tube 59 is arranged coaxially inside the fluid outlet port 58 which is formed on the shaft center of the rotary shaft 55a and constitutes a fluid return passage 57. This fluid supply tube 59 is connected and fixed to the fluid shaft sleeve 60 arranged on the shaft center which is arranged inside the thin-walled metallic outer sleeve 51. Inner sleeve supporting flanges 61a and 61b are mounted on both ends of this fluid shaft sleeve 60, respectively. A metallic inner sleeve 52 having a wall thickness of about 15 through 20 mm is mounted in the range from the position between the outer peripheral portions of these inner sleeve supporting flanges 61a and 61b to the outer sleeve supporting flange 56b on the other end. For example, a coolant flow space 53 of about 10 mm is formed between this metallic inner sleeve 52 and thin-walled metallic outer sleeve 51. An outlet 52a and an inlet 52b communicating between the flow space 53 and intermediate passages 62a and 62b outside the inner sleeve supporting flanges 61a and 61b are formed on the metallic inner sleeves 52 close to both ends, respectively.

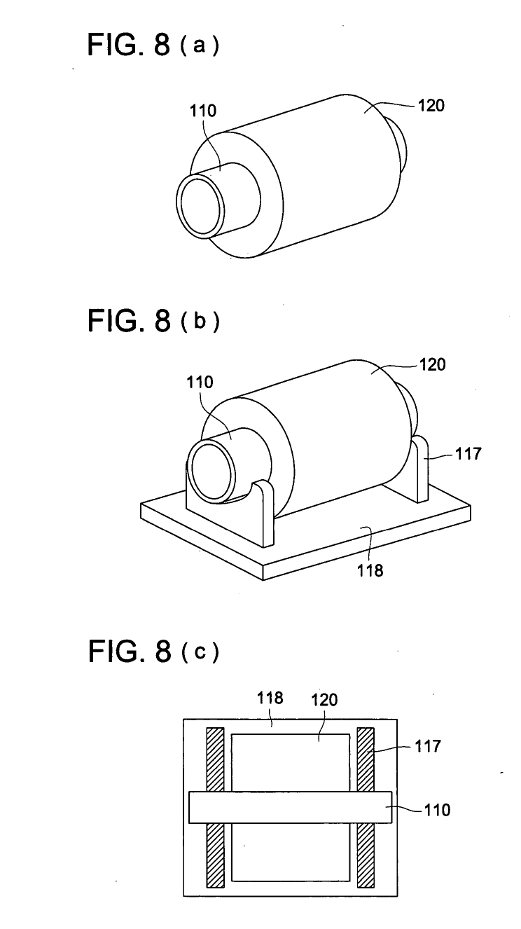

To provide pliability, flexibility and restoring force close to those of the rubber, the outer sleeve 51 is designed thin within the range permitted by the thin cylinder theory of elastic mechanics. The flexibility evaluated by the thin cylinder theory is expressed by wall thickness t/roll radium r. The smaller the t/r, the higher the flexibility. The flexibility of this touch roll B meets the optimum condition when t/r≦0.03. Normally, the commonly used touch roll has a roll diameter R=200 through 500 mm (roll radius r=R/2), a roll effective width L=500 through 1600 mm, and an oblong shape of r/L<1. As shown in FIG. 8, for example, when roll diameter R=300 mm and the roll effective width L=1200 mm, the suitable range of wall thickness t is 150×0.03=4.5 mm or less. When pressure is applied to the molten sheet width of 1300 mm at the average linear pressure of 98 N/cm, the wall thickness of the outer sleeve 51 is 3 mm. Then the corresponding spring constant becomes the same as that of the rubber roll of the same shape. The width k of the nip between the outer sleeve 51 and cooling roll in the direction of roll rotation is about 9 mm. This gives a value approximately close to the nip width of this rubber roll is about 12 mm, showing that pressure can be applied under the similar conditions. The amount of deflection in the nip width k is about 0.05 through 0.1 mm.

Here, t/r≦0.03 is assumed. In the case of the general roll diameter R=200 through 500 mm, sufficient flexibility is obtained if 2 mm≦t≦5 mm in particular. Thickness can be easily reduced by machining. Thus, this is very practical range. If the wall thickness is 2 mm or less, high-precision machining cannot be achieved due to elastic deformation during the step of processing.

The equivalent value of this 2 mm≦t≦5 mm can be expressed by 0.008≦t/r≦0.05 for the general roll diameter. In practice, under the conditions of t/r≈0.03, wall thickness is preferably increased in proportion to the roll diameter. For example, selection is made within the range of t=2 through 3 mm for the roll diameter: R=200; and t=4 through 5 mm for the roll diameter: R=500.

These touch rolls A and B are energized toward the first cooling roll by the energizing section (not illustrated). The F/W (linear pressure) obtained by dividing the energizing force F of the energizing section by the width W of the film in the nip along the rotary shaft of the first cooling roll 5 is set at 10N/cm through 10 N/cm. According to the present embodiment, a nip is formed between the touch rolls A and B, and the first cooling roll 5. Flatness should be corrected while the film passes through this nip. Thus, as compared to the cases where the touch roll is made of a rigid body, and no nip is formed between the touch roll and the first cooling roll, the film is sandwiched and pressed at a smaller linear pressure for a longer time. This arrangement ensures more reliable correction of flatness. To be more specific, if the linear pressure is smaller than 10 N/cm, the die line cannot be removed sufficiently. Conversely, if the linear pressure is greater than 150 N/cm, the film cannot easily pass through the nip. This will cause uneven thickness of the film. The surfaces of the touch rolls A and B are made of metal. This provides smooth surfaces of the touch rolls A and B, as compared to the case where touch rolls have rubber surfaces. The elastic body 44 of the elastic roller 42 can be made of ethylene propylene rubber, neoprene rubber, silicone rubber or the like.

To ensure that the die line is removed sufficiently by the touch roll 6, it is important that the film viscosity should lie within the appropriate range when the film is sandwiched and pressed by the touch roll 6. Further, cellulose ester is known to be affected by temperature to a comparatively high degree. Thus, to set the viscosity within an appropriate range when the cellulose ester film is sandwiched and pressed by the touch roll 6, it is important to set the film temperature within an appropriate range when the cellulose ester film is sandwiched and pressed by the touch roll 6. When the glass-transition temperature of the cellulose acylate film is assumed as Tg, the temperature T of the film immediately before the film is sandwiched and pressed by the touch roll 6 is preferably set in such a way that Tg<T<Tg+110° C. can be met. If the film temperature T is lower than T, the viscosity of the film will be too high to correct the die line. Conversely, if the film temperature T is higher than Tg+110° C., uniform adhesion between the film surface and roll cannot be achieved, and the die line cannot be corrected. This temperature is preferably Tg+10° C.<T<Tg+90° C., more preferably Tg+20° C.<T<Tg+70° C. To set the film temperature within the appropriate range when the cellulose acylate film is sandwiched and pressed by the touch roll 6, one has only to adjust the length L of the nip between the first cooling roll 5 and touch roll 6 along the rotating direction of the first cooling roll 5, from the position P1 wherein the melt pressed out of the flow casting die 4 comes in contact with the first cooling roll 5.

In the present invention, the material preferably used for the first roll 5 and second roll 6 is exemplified by carbon steel, stainless steel and resin. The surface accuracy is preferably set at a higher level. In terms of surface roughness, it is preferably set to 0.3 S or less, more preferably 0.01 S or less.

In the present invention, the portion from the opening (lip) of the flow casting die 4 to the first roll 5 is reduced to 70 kPa or less. This procedure has been found out to correct the die line effectively. Pressure reduction is preferably 50 through 70 kPa. There is no restriction to the method of ensuring that the pressure in the portion from the opening (lip) of the flow casting die 4 to the first roll 5 is kept at 70 kPa or less. One of the methods is to reduce the pressure by using a pressure-resistant member to cover the portion from the flow casting die 4 to the periphery of the roll. In this case, the vacuum suction machine is preferably heated by a heater or the like to ensure that a sublimate will be deposited on the vacuum suction machine. In the present invention, if the suction pressure is too small, the sublimate cannot be sucked effectively. To prevent this, adequate suction pressure must be utilized.

In the present invention, the film-like cellulose ester based resin in the molten state from the T-die 4 is conveyed in contact with the first roll (the first cooling roll) 5, second cooling roll 7, and third cooling roll 8 sequentially, and is cooled and solidified, whereby an unoriented cellulose ester based resin film 10 is produced.

In the embodiment of the present invention shown in FIG. 1, the unoriented film 10 cooled, solidified and separated from the third cooling roll 8 by the separation roll 9 is passed through a dancer roll (film tension adjusting roll) 11, and is led to the stretching machine 12, wherein the film 10 is stretched in the lateral direction (across the width). This stretching operation orients the molecules in the film.

A known tender or the like can be preferably used to draw the film across the width. Especially when the film is stretched across the width, the lamination with the polarized film can be preferably realized in the form of a roll. The stretching across the width ensures that the low axis of the cellulose acylate film made up of a cellulose ester based resin film is found across the width.

In the meantime, the transmission axis of the polarized film also lies across the width normally. If the polarizing plate wherein the transmission axis of the polarized film and the low axis of the optical film will be parallel to each other is incorporated in the liquid crystal display apparatus, the display contrast of the liquid crystal display apparatus can be increased and an excellent angle of view field is obtained.

The glass transition temperature Tg of the film constituting material can be controlled when the types of the materials constituting the film and the proportion of the constituent materials are made different. When the retardation film is manufactured as a cellulose film, Tg is 120° C. or more, preferably 135° C. or more. In the liquid crystal display apparatus, the film temperature environment is changed in the image display mode by the temperature rise of the apparatus per se, for example, by the temperature rise caused by a light source. In this case, if the Tg of the film is lower than the film working environment temperature, a big change will occur to the retardation value and film geometry resulting from the orientation status of the molecules fixed in the film by stretching. If the Tg of the film is too high, temperature is raised when the film constituting material is formed into a film. This will increase the amount of energy consumed for heating. Further, the material may be decomposed at the time of forming a film, and this may cause coloring. Thus, Tg is preferably kept at 250° C. or less.

The process of cooling and relaxation under a known thermal setting conditions can be applied in the stretching process. Appropriate adjustment should be made to obtain the characteristics required for the intended optical film.

The aforementioned stretching process and thermal setting process are applied as appropriate on an selective basis to provide the retardation film function for the purpose of improving the physical properties of the retardation film and to increase the angle of field in the liquid crystal display apparatus. When such a stretching process and thermal setting process are included, the heating and pressing process should be performed prior to the stretching process and thermal setting process.

When a retardation film is produced as an optical film, and the functions of the polarizing plate protective film are combined, control of the refractive index is essential. The refractive index control can be provided by the process of stretching. The process of stretching is preferred. The following describes the method for stretching:

In the retardation film stretching process, required retardations Ro and Rt can be controlled by a stretching at a magnification of 1.0 through 2.0 times in one direction of the cellulose resin, and at a magnification of 1.01 through 2.5 times in the direction perpendicular to the inner surface of the film. Here Ro denotes an in-plane retardation. It is obtained by multiplying the thickness by the difference between the refractive index in the longitudinal direction MD in the same plane and that across the width TD. Rt denotes the retardation along the thickness, and is obtained by multiplying the thickness by the difference between the refractive index (an average of the values in the longitudinal direction MD and across the width TD) in the same plane and that along the thickness.

Stretching can be performed sequentially or simultaneously, for example, in the longitudinal direction of the film and in the direction perpendicular thereto in the same plane of the film, namely, across the width. In this case, if the stretching magnification at least in one direction is insufficient, sufficient retardation cannot be obtained. If it is excessive, stretching difficulties may occur and the film may break.

Stretching in the biaxial directions perpendicular to each other is an effectively way for keeping the film refractive indexes nx, ny and nz within a predetermined range. Here nx denotes a refractive index in the longitudinal direction MD, ny indicates that across the width TD, and nz represents that along the thickness.

When the material is stretched in the melt-casting direction, the nz value will be excessive if there is excessive shrinkage across the width. This can be improved by controlling the shrinkage of the film across the width or by stretching across the width. In the case of stretching across the width, distribution may occur to the refractive index across the width. This distribution may appear when a tenter method is utilized. Stretching of the film across the width causes shrinkage force to appear at the center of the film because the ends are fixed in position. This is considered to be what is called “bowing”. In this case, bowing can be controlled by stretching in the casting direction, and the distribution of the retardation across the width can be reduced.

Stretching in the biaxial directions perpendicular to each other reduces the fluctuation in the thickness of the obtained film. Excessive fluctuation in the thickness of the retardation film will cause irregularity in retardation. When used for liquid crystal display, irregularity in coloring or the like will occur.

The fluctuation in the thickness of the cellulose resin film is preferably kept within the range of ±3%, preferably ±1%. To achieve the aforementioned object, it is effective to use the method of stretching in the biaxial directions perpendicular to each other. The magnification rate of stretching in the biaxial directions perpendicular to each other is preferably 1.0 through 2.0 times in the casting direction, and 1.01 through 2.5 times across the width. Stretching in the range of 1.01 through 1.5 times in the casting direction and in the range of 1.05 through 2.0 times across the width will be more preferred to get a retardation value.

When the absorption axis of the polarizer is present in the longitudinal direction, matching of the transmission axis of the polarizer is found across the width. To get a longer polarizing plate, the retardation film is preferably stretched so as to get a low axis across the width.

When using the cellulose ester to get positive double refraction with respect to stress, stretching across the width will provide the low axis of the retardation film across the width because of the aforementioned arrangement. In this case, to improve display quality, the low axis of the retardation film is preferably located across the width. To get the target retardation value, it is necessary to meet the following condition:
(Stretching magnification across the width)>(stretching magnification in casting direction)

After stretching, the end of the film is trimmed off by a slitter 13 to a width predetermined for the product. Then both ends of the film are knurled (embossed) by a knurling apparatus made up of an emboss ring 14 and back roll 15, and the film is wound by a winder 16. This arrangement prevents sticking in the cellulose acylate film F (master winding) or scratch. Knurling can be provided by heating and pressing a metallic ring having a pattern of projections and depressions on the lateral surface. The gripping portions of the clips on both ends of the film are normally deformed and cannot be used as a film product. They are therefore cut out and are recycled as a material.

When the phase difference film is used as a polarizing plate protective film, the thickness of this protective film is preferably 10 through 500 μm. The lower limit is 20 μm or more, preferably 35 μm or more. The upper limit is 150 μm or less, preferably 120 μm or less. The particularly preferred range is 25 μm or more without exceeding 90 μm. If the phase difference film is too thick, the polarizing plate subsequent to processing of the polarizing plate will be too thick. This is not suited for the low-profile, light weight configuration required in the liquid crystal display used in a notebook PC or mobile electronic equipment. In the meantime, if the phase difference film is too thin, difficulties will be involved in the retardation as a phase difference film will be difficult. This will further result in higher film moisture permeability, and lower capacity in protecting the polarizer against humidity.

Assuming that the low axis or high axis of the phase difference film is present in the plane of the film, and the angle formed with respect to film making direction is θ1, then θ1 is −1 degrees or more without exceeding +1 degrees, preferably −0.5 degrees or more without exceeding +0.5 degrees.

The θ1 can be defined as an orientation angle, and θ1 can be measured with a double refractometer KOBRA-21ADH (made by Oji Scientific Instruments).

When the θ1 meets the aforementioned relation, luminance is increased on the display image and leakage of light is reduced or prevented, whereby faithful color reproduction in a color liquid crystal display apparatus is ensured.

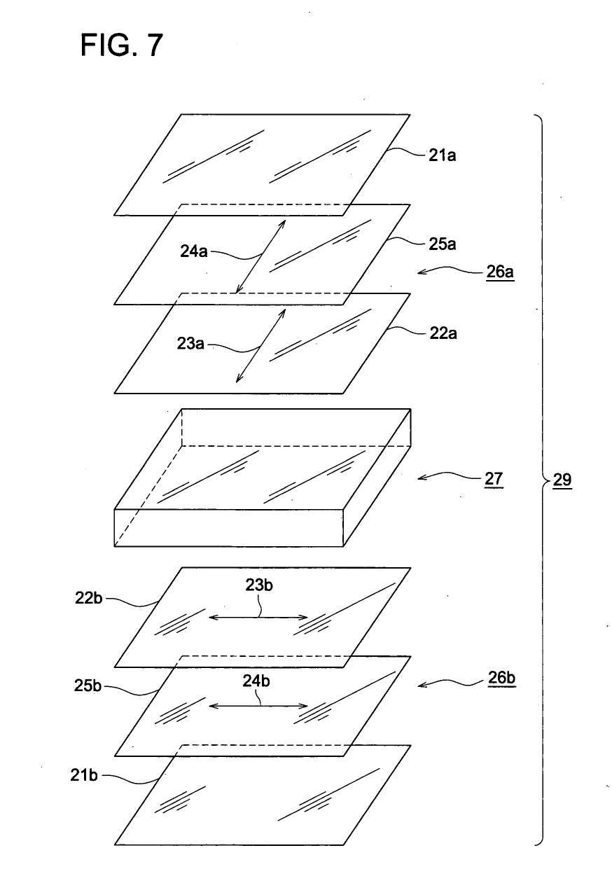

When the phase difference film in the present invention is used in the VA mode subjected to the configuration of multi-domain, the phase difference film is arranged in the aforementioned area with the high axis of phase difference film being θ1. This arrangement improves the display quality, and permits the structure of FIG. 7 to be implemented, when placed in the MVA mode as a polarizing plate and liquid crystal display apparatus.

In FIG. 7, the reference numerals 21a and 21b indicate protective films, the 22a and 22b shows phase difference films, the 25a and 25b represent the polarizers, the 23a and 23b show the low axis direction of the film, the 24a and 24b denote the direction of the transmission axis of polarizer, the 26a and 26b indicate polarizing plates, the 27 denotes a liquid crystal cell, and the 29 indicates a liquid crystal display apparatus.

The retardation Ro distribution in the in-plane direction of the optical film is adjusted to preferably 5% or less, more preferably 2% or less, still more preferably 1.5% or less. Further, the retardation Rt distribution across the thickness of the film is adjusted to preferably 10% or less, more preferably 2% or less, still more preferably 1.5% or less.

In the phase difference film, the distribution in the fluctuation of retardation value is preferably smaller. When a polarizing plate containing a phase difference film is used in an liquid crystal display apparatus, it is preferred that the distribution in the fluctuation of retardation should be small for the purpose of avoiding color irregularity.

In order to adjust the phase difference film so as to set the retardation value suited for improvement of the display quality of the liquid crystal cell in the VA or TN mode, and especially to ensure that the VA mode is divided into the aforementioned multi-domains so as to be preferably used in the MVA mode, it is required to make adjustment so that the in-plane retardation Ro should be greater than 30 nm without exceeding 95 nm, and the retardation Rt across the thickness should be greater than 70 nm without exceeding 400 nm.

When in the state of crossed-Nicols as observed in the direction normal to the display surface when two polarizing plates are positioned in a crossed-Nicols arrangement and a liquid crystal cell is placed between the polarizing plates, for example, as shown in FIG. 7, the crossed-Nicols state of the polarizing plate is deviated when observed in the direction normal to the display surface, and the leakage of light caused thereby is mainly corrected by the aforementioned in-plane retardation Ro. The retardation across the thickness mainly corrects the double refraction of the liquid crystal cell observed as viewed obliquely in the same manner when the liquid crystal cell is in the black display mode in the aforementioned TN and VA modes, especially in the MVA mode.

When two polarizing plates are placed above and below the liquid crystal cell in the liquid crystal display apparatus as shown in FIG. 7, the 22a and 22b in the drawing are capable of selecting the distribution of the retardation Rt across the thickness. It is preferred that the requirements of the aforementioned range should be satisfied, and that the total of both retardations Rt across the thickness should be preferably greater than 140 nm without exceeding 500 nm. Here, the in-plane retardation Ro of the 22a and 22b and retardations Rt across the thickness are the same are preferred to be the same in both cases for the purpose of improving the industrial productivity of the polarizing plate. It is particularly preferred that the in-plane retardation Ro should be greater than 35 nm without exceeding 65 nm and the retardation Rt across the thickness should be greater than 90 nm without exceeding 180 nm, wherein they should be applicable to the liquid crystal cell in the MVA mode in FIG. 7.

In the liquid crystal display apparatus, when a TAC film having a thickness of 35 through 85 μm with the in-plane retardation Ro=0 through 4 nm and retardation Rt across the thickness=20 through 50 nm, for example, as a commercially available polarizing plate protective film is used, for example, at the position 22b shown in FIG. 7 on one of the polarizing plates, the polarized film arranged on the other polarizing plate, for example, the phase difference film arranged at 22a in FIG. 7 to be used is preferred to have an in-plane retardation Ro greater than 39 nm without exceeding 95 nm and a retardation Rt across the thickness greater than 140 nm without exceeding 400 nm. This is advantageous for the improvement of display quality and film production.

<Liquid Crystal Display Apparatus>

The polarizing plate including the phase difference film of the present invention provides higher display quality than a normal polarizing plate, and is suited for application particularly to the multi-domain liquid crystal display apparatus, more preferably to the multi-domain liquid crystal display apparatus due to the double refraction mode.

The polarizing plate of the present invention can be used in the MVA (Multi-domain Vertical Alignment) PVA (Patterned Vertical Alignment) mode, CPA (Continuous Pinwheel Alignment) mode and OCB (Optical Compensated Bend) mode, without the present invention being restricted to a particular liquid crystal mode or particular arrangement of the polarizing plate.

The liquid crystal display apparatus is coming into use as an apparatus for the display of colored and moving images. The display quality, contrast and resistance of the polarizing plate enhanced by the present invention provides a faithful display of moving images without imposing loads on user's eyes.

In a liquid crystal display apparatus equipped with a polarizing plate including the phase difference film of the present invention, one polarizing plate including the phase difference film of the present invention is arranged for the liquid crystal cell or two polarizing plates are arranged on both sides of the liquid crystal cell. The display quality can be improved if used in such a way that the side of the phase difference film of the present invention contained in the polarizing plate faces the liquid crystal cell of the liquid crystal display apparatus. In FIG. 7, the films 22a and 22b face the liquid crystal cell of the liquid crystal display apparatus.

In this structure, the phase difference film of the present invention optically corrects the liquid crystal cell. When the polarizing plate of the present invention is used in a liquid crystal display apparatus, at least one of the polarizing plates used in the liquid crystal display apparatus is the polarizing plate of the present invention. This structure provides a liquid crystal display apparatus characterized by improved display quality and viewing angle properties.

In the polarizing plate of the present invention, the polarizing plate protective film as the cellulose derivative is used on the side opposite the phase difference film as viewed from the polarizer. A general-purpose TAC film and others can be used. To improve the quantity of the display apparatus, the polarizing plate protective film located far away from the liquid crystal cell can also be provided with other functional layers.

For example, to protect against reflection, glare, damage and deposition of dust and to enhance luminance, a conventionally known functional layer for a display can be laminated on the film as a component or the polarizing plate layer of the present invention, without the present invention being restricted thereto.

Generally, in the phase difference film, the fluctuation of the Ro or Rth as the aforementioned retardation value is required to be smaller for the purpose of ensuring stable optical characteristics. The aforementioned fluctuation may cause image irregularity especially in the liquid crystal display apparatus of the double refraction mode.

The longer phase difference film formed by the melt-casting film formation technique according to the present invention is mainly made up of a cellulose resin, and therefore, saponification inherent to the cellulose resin can be utilized in the process of alkaline treatment. When the resin constituting the polarizer is polyvinyl alcohol, a solution of fully saponified polyvinyl alcohol can be used for lamination with the phase difference film of the present invention, similarly to the case of the conventional polarizing plate protective film. Thus, the present invention is superior in that the conventional polarizing plate processing method can be used and a longer roll polarizing plate in particular can be manufactured.

The manufacturing advantages provided by the present invention are noteworthy especially in a long product measuring 100 meters or more. The advantages in manufacturing the polarizing plate increase with the length of the product, as the length increases, for example, to 1500 m, 2500 m, 5000 m and so on.

In the production of a phase difference film, for example, the roll length is 10 m or more without exceeding 5000 m, more preferably 50 m or more without exceeding 4500 m when consideration is given to productivity and transportability. The film with in this case can be selected to suit the polarizer width and production line requirements. It is possible to make such arrangements that a fill is manufactured with a width of 0.5 m or more without exceeding 4.0 m, preferably 0.6 m or more without exceeding 3.0 m, and is wound in a roll to be processed into a polarizing plate. Alternatively, it is also possible to manufacture a film having a width more than twice the intended width which is wound in a roll, whereby a roll having the intended width is obtained. This roll is then processed into a polarizing plate.

At the time of manufacturing the phase difference film of the present invention, such a functional layer as an antistatic layer, hard coated layer, lubricating layer, adhesive layer, antiglare layer or barrier layer can be coated before and/or after drawing. In this case, various forms of surface treatment such as corona discharging, plasma treatment and medical fluid treatment can be provided wherever required.

In the film manufacturing process, the clip holding section on both ends of the film having been cut is pulverized or is used for granulating wherever required. After that, it can be reused as the material of the same type of film or as the material of a different type of film.

The compositions including the cellulose resin with additives having different concentration such as the aforementioned plasticizer, ultraviolet absorber, and matting agent can be extruded together to manufacture the optical film of lamination structure. For example, it is possible to manufacture an optical film having a structure of a scanning layer core layer/scanning layer. For example, a large amount of matting agent can be put into the scanning layer, or the matting agent can be put into the scanning layer alone. A greater amount of plasticizer and ultraviolet absorber can be put into the core layer than into the scanning layer. Alternatively, they can be put into the core layer alone. Further, different types of the plasticizer and ultraviolet absorber can be put into the core layer and scanning layer. For example, the scanning layer can be impregnated with a plasticizer and/or ultraviolet absorber of low volatility, and the core layer can be impregnated with the plasticizer of excellent plasticity, or with an ultraviolet absorber of superb ultraviolet absorbency. The glass transition temperature of the scanning layer can be different from that of the core layer. The glass transition temperature of the core layer is preferably lower than that of the scanning layer. In this case, the glass transition temperatures of the scanning and core layers are measured and the average value calculated from these volume fractions can be defined as the aforementioned glass transition temperature Tg, whereby the same procedure is used for handling. Further, the viscosity of the melt including the cellulose ester at the time of melt casting can be different between the scanning layer and core layer. The viscosity of the scanning layer can be greater than that of the core layer, or the viscosity of the core layer can be equal to or greater than that of the scanning layer.

The dimensional stability of the cellulose acylate film of the present invention is such that, when the dimensions of the film having been left to stand at a temperature of 23° C. with a relative humidity of 55% RH for 24 hours are used as standard, the fluctuation of the dimensions at a temperature of 80° C. with a relative humidity of 90% RH is within ±2.0%, preferably less than 1.0%, more preferably less than 0.5%.

When the cellulose acylate film of the present invention is a phase difference film, and is used as a protective film of the polarizing plate, a deviation will occur between the absolute value of the retardation as a polarizing plate and the initial setting of the orientation angle if the phase difference film exhibits a fluctuation exceeding the aforementioned range. This may impede the improvement in display quality or may cause deterioration of the display quality.

The phase difference film of the present invention can be used as a polarizing plate protective film. When used as a polarizing plate protective film, there is no particular restriction to the method of manufacturing the polarizing plate. It can be manufactured by common practice. For example, the phase difference film having been obtained is subjected to alkaline treatment, and the polyvinyl alcohol film is immersed in an iodine solution, wherein it is drawn. A polarizing plate protective film is laminated on both sides of the polarizer manufactured in this procedure, using the solution of fully saponifiable polyvinyl alcohol. On at least one side, the phase difference film as a polarizing plate protective film of the present invention directly bonded onto the polarizer.

The polarizing plate can be manufactured by adhesion promoting treatment disclosed in the Unexamined Japanese Patent Application Publication No. H6-94915 and Unexamined Japanese Patent Application Publication No. H6-118232, instead of the aforementioned alkaline treatment.

The polarizing plate is made up of the protective film for protecting both surfaces of the polarizer. A protective film can be bonded onto one surface of this polarizing plate and a separate film can be bonded onto the opposite side. The protective film and separate film are used to protect the polarizing plate at the time of inspection before the polarizing plate is shipped. In this case, the protective film is laminated to protect the surface of the polarizing plate, and is used on the side opposite the surface wherein the polarizing plate is bonded to the liquid crystal plate. Further, the separate film is used to cover the adhesive layer bonded to the liquid crystal plate. It is used on the surface wherein the polarizing plate is bonded onto the liquid crystal cell.

(Formation of Functional Layers)

During the production of the optical film of the present invention, prior to/after stretching, coated may be functional layers such as a transparent conductive layer, a hard coat layer, an antireflection layer, a lubricating layer, an adhesion aiding layer, a glare shielding layer, a barrier layer, or an optical compensating layer. Specifically, it is preferable to arrange at least one layer selected from the group consisting of a transparent conductive layer, an antireflection layer, an adhesion aiding layer, a glare shielding layer, and an optical compensating layer. In such a case, if desired, it is possible to conduct various surface treatments such as a corona discharge treatment, a plasma treatment, and a chemical treatment.

<Transparent Conductive Layer>

In the film of the present invention, it is preferable to provide a transparent conductive layer, employing surface active agents or minute conductive particles. The film itself may be made to be conductive or a transparent conductive layer may be provided. In order to provide antistatic properties, it is preferable to provide a transparent conductive layer. It is possible to provide the transparent conductive layer employing methods such as a coating method, an atmospheric pressure plasma treatment, vacuum deposition, sputtering, or an ion plating method. Alternatively, by employing a co-extrusion method, a transparent conductive layer is prepared by incorporating minute conductive particles into the surface layer or only into the interior layer. The transparent conductive layer may be provided on one side of the film or on both sides. Minute conductive particles may be employed together with matting agents resulting in lubrication or may be employed as a matting agent.

Preferred as examples of metal oxides are ZnO, TiO₂, SnO₂, Al₂O₃, In₂O₃, SiO₂, MgO, BaO, MoO₂, and V₂O₅ or composite oxides thereof. Of these, Zn, TiO₂, and SnO₂ are particularly preferred. As an example of incorporating a different type of atom, it is effective that Al and In are added to ZnO, Nb and Ta are added to TiO₂, or Sb, Nb and halogen elements are added to SnO₂. The addition amount of these different types of atoms is preferably in the range of 0.01-25 mol percent, but is most preferably in the range of 0.1-15 mol percent.

Further, the volume resistivity of these conductive metal oxide powders is preferably at most 1×10⁷ Ωcm, but most preferably at most 1×10⁵ Ωcm. It is preferable that powders exhibiting the specified structure at a primary particle diameter of 100 Å-0.2 μm, and a major diameter of higher order structure of 300 Å-6 μm is incorporated in the conductive layer at a volume ratio of 0.01-20 percent.

In the present invention, the transparent conductive layer may be formed in such a manner that minute conductive particles are dispersed into binders and provided on a substrate, or a substrate is subjected to a subbing treatment onto which minute conductive particles are applied.

Further, it is possible to incorporate the ionen conductive polymers represented by Formulas (I)-(V), described in paragraph 0038-0055 of JP-A No. 9-203810, and quaternary ammonium cationic polymers represented by Formula (1) or (2), described in paragraphs 0056-0145 of the above patent.

Further, to result in a matted surface and to improve layer quality, heat resistant agents, weather resistant agents, inorganic particles, water-soluble resins, and emulsions may be incorporated into the transparent conducive layer composed of metal oxides within the amount range which does not adversely affect the effects of the present invention.

Binders employed in the transparent conductive layer are not particularly limited as long as they exhibit film forming capability. Listed as binders may, for example, be proteins such as gelatin or casein; cellulose compounds such as carboxymethyl cellulose, hydroxyethyl cellulose, acetyl cellulose, diacetyl cellulose, or triacetyl cellulose; saccharides such as dextran, agar, sodium alginates, or starch derivatives; and synthetic polymers such as polyvinyl alcohol, polyvinyl acetate, polyacrylates, polymethacrylates, polystyrene, polyacrylamides, poly-N-vinylpyrrolidone, polyester, polyvinyl chloride, or polyacrylic acid.

Particularly preferred are gelatin (such as alkali process gelatin, acid process gelatin, oxygen decomposition gelatin, phthalated gelatin, or acetylated gelatin), acetyl cellulose, diacetyl cellulose, triacetyl cellulose, polyvinyl acetate, polyvinyl alcohol, butyl polyacrylate, polyacrylamide, and dextran.

<Antireflection Film>

It may be also preferable to make the cellulose ester optical film of the present invention an antireflection film by providing a hard coat layer and an antireflection layer on its surface.

As the hard coat layer, an actinic ray curable resin layer or a heat curable resin may be preferably employed. The hard coat layer may be coated directly on a support, or on another layer such as an antistatic layer and an undercoat layer.

In the case that the actinic ray curable resin layer is provided as the hard coat layer, the actinic ray curable resin layer preferably contains an actinic ray curable resin capable of being cured by the irradiation with light such as ultraviolet rays.

The hard coat layer preferably has a refractive index of 1.45 to 1.65 from a view point of an optical design. Further, from view points of durability and shock resistance to be provided to an antireflection film, also from view points of a proper flexibility and an economical efficiency at the time of production, the hard coat layer preferably has a thickness of from 1 μm to 20 μm, more preferably from 1 μm to 10 μm.

An actinic ray curable resin layer refers to a layer mainly comprising a resin which can be cured through a cross-linking reaction caused by irradiating with actinic rays such as UV rays or electron beams (in the present invention, “actinic rays” means that all of various electromagnetic waves such as electron beams, neutron beams, X-rays, alpha rays, ultraviolet rays, visible rays and infrared rays are defied as light). As the actinic ray curable resin, an ultraviolet ray (UV) curable resin and an electron beam curable resin are typically listed, however, a resin curable by the irradiation with light other than ultraviolet rays and electron beams. The UV curable resin includes, for example: a UV-curable acryl urethane type resin, a UV-curable polyester acrylate type resin, a UV-curable epoxy acrylate type resin, a UV-curable polyol acrylate type resin and a UV-curable epoxy type resin.

A UV-curable acryl urethane type resin, a UV-curable polyester acrylate type resin, a UV-curable epoxy acrylate type resin, a UV-curable polyol acrylate type resin and a UV-curable epoxy type resin may be listed.

Moreover, a photoreaction initiator and a photosensitizer may be contained. Concretely, for example: acetophenone, benzophenone, hydroxy benzophenone, Michler's ketone, α-amyloxim ester, thioxanthone, and their derivatives may be employed. Further, when a photoreaction agent is used for synthesizing an epoxy acrylate type resin, sensitizers such as n-butyl amine, triethyl amine and tri-n-butyl phosphine can be utilized. The photoreaction initiator and the photosensitizer may be contained in an amount of 2.5 W to 6% by weight in the UV curable resin composition except solvent components which volatilize after coating and drying.

Resin monomers include, for example, as a monomer having one unsaturated double bond, common monomers such as methyl acrylate, ethyl acrylate, butyl acrylate, vinyl acetate, benzyl acrylate, cyclohexyl acrylate, or styrene. Further, listed as monomers having at least two unsaturated double bonds may be ethylene glycol diacrylate, propylene glycol diacrylate, divinylbenzene, 1,4-cyclohexane diacrylate, and 1,4-cyclohexyldimethyl acrylate, as well as trimethylolpropane triacrylate and pentaerythritolpropane acrylate, described above.

Moreover, an ultraviolet absorber may be contained in an ultraviolet curable resin composition to such an extent that actinic-ray curing of the ultraviolet curable resin composition is not disturbed. As the ultraviolet absorber, one similar to an ultraviolet absorber which may be usable for the above substrate may be employed.

In order to enhance the heat resistance of a cured layer, an antioxidant selected as a type which does not refrain an actinic-ray curing reaction may be employed. For example, a hindered phenol derivative, a thio propionic acid derivative, a phosphite derivative, etc. may be listed. Concretely, 4,4′-thiobis (6-t-3-methyl phenol), 4,4′-butylidenebis(6-t-butyl-3-methyl phenol), 1,3,5-tris(3,5-di-t-butyl-4-hydroxybenzyl) isocyanurate, 2,4,6-tris(3,5-di-t-butyl-4-hydroxybenzyl) mesitylene and di-octadecyl-4-hydroxy-3,5-di-t-butyl benzyl phosphate etc. may be listed.

The UV curable resins available on the market utilized in the present invention include Adekaoptomer KR, BY Series such as KR-400, KR-410, KR-550, KR-566, KR-567 and BY-320B (manufactured by Asahi Denka Co., Ltd.); Koeihard A-101-KK, A-101-WS, C-302, C-401-N, C-501, M-101, M-102, T-102, D-102, NS-101, FT-102Q8, MAG-1-P20, AG-106 and M-101-C (manufactured by Koei Kagaku Co., Ltd.); Seikabeam PHC2210(S), PHC X-9(K-3), PHC2213, DP-10, DP-20, DP=30, P1000, P1100, P1200, P1300, P1400, P1500, P1600, SCR900 (manufactured by Dainichiseika Kogyo Co., Ltd.); KRM7033, KRM7039, KRM7131, UVECRYL29201 and UVECRYL29202 (manufactured by Daicel U. C. B. Co., Ltd.); RC-5015, RC-5016, RC-5020, RC-5031, RC-5100, RC-5102, RC-5120, RC-5122, RC-5152, RC-5171, RC-5180 and RC-5181 (manufactured by Dainippon Ink & Chemicals, Inc.); Olex No. 340 Clear (manufactured by Chyugoku Toryo Co., Ltd.); Sunrad H-601, RC-750, RC-700, RC-600, RC-500, RC-611 and RC-612 (manufactured by Sanyo Kaseikogyo Co., Ltd.); SP-1509 and SP-1507 (manufactured by Syowa Kobunshi Co., Ltd.); RCC-15C (manufactured by Grace Japan Co., Ltd.) and Aronix M-6100, M-8030 and M-8060 (manufactured by Toagosei Co., Ltd.).

The coating composition of the actinic ray layer preferably has a solid component concentration of from 10% to 95% by weight, and a proper concentration may be selected in accordance with a coating method.

A light source to cure layers of the actinic ray curable resin layer by a photo-curing reaction is not specifically limited, and any light source may be used as far as UV ray is generated. Concretely, a light source to emit light described above item with regard to light. An irradiating condition may change depending on a lamp. However, the preferable irradiation quantity of light is preferably from 20 mJ/cm² to 10000 mJ/cm², and more preferably from 50 to 2000 mJ/cm². In a range from a near ultraviolet ray range to a visible ray region, it may be preferable to use a sensitizer having an absorption maximum for the range.

An organic solvent at a time of coating the actinic ray curable resin layer can be selected properly from organic solvents, for example: hydrocarbon series (toluene, xylene), alcohol series (methanol, ethanol, isopropanol, butanol and cyclohexanol), ketone series (acetone, methyl ethyl ketone and isobutyl ketone), ester series (methyl acetate, ethyl acetate and methyl lactate), glycol ether series and other organic solvents, or these organic solvents may be also used in combinations as the organic solvent. The above mentioned organic preferably contains propyleneglycol monoalkylether (with an alkyl group having 1 to 4 carbon atoms) or propyleneglycol monoalkylether acetate ester (with an alkyl group having 1 to 4 carbon atoms) with a content of 5 percent by weight or more, and more preferably from 5 to 80 percent by weight.

As a coating method of the coating liquid of the actinic ray curable resin composition, well-known methods such as a gravure coater, a spinner coater, a wire bar coater, a roll coater, a reverse coater, an extrusion coater and an air doctor coater. A coating amount is preferably 0.1 μm to 30 μm as a wet layer thickness, more preferably 0.5 μm to 15 μm. A coating speed is preferably in a range of 10 m/minute to 60 m/minute.

After the actinic ray curable resin composition is coated and dried, it is irradiated with ultraviolet rays. At this time, the irradiation time is preferably 0.5 seconds to 5 minutes. From view points of curing efficiency of an ultraviolet ray curable resin and working efficiency, it is preferably 3 seconds to 2 minutes.

Thus, it is possible to obtain a cured coating layer. In order to provide glare shielding properties with the panel surface of liquid crystal display devices, to minimize adhesion to other substances, and to enhance abrasion resistance, it is possible to incorporate minute inorganic or organic particles into the curable layer coating composition.

For example, listed as minute inorganic particles may be those composed of silicon oxide, zirconium oxide, titanium oxide, aluminum oxide, tin oxide, zinc oxide, calcium carbonate, barium sulfate, talc, kaolin, and calcium sulfate.

Further listed as minute organic particles may be polymethacrylic acid methyl acrylate resin powder, acryl styrene based resinous powder, polymethyl methacrylate resinous powder, silicone based resinous powder, polystyrene based resinous powder, polycarbonate resinous powder, benzoguanamine based resinous powder, melamine based resinous powder, polyolefin based resinous powder, polyester based resinous powder, polyamide based resinous powder, polyimide based resinous powder, or fluorinated ethylene based resinous powder. It is possible to incorporate these into ultraviolet radiation curable resinous compositions and then to employ them. The average particle diameter of these minute particle powders is commonly 0.01-10 μm. The used amount is preferably 0.1-20 parts by weight with respect to 100 parts by weight of the ultraviolet radiation curable resin composition. In order to provide glare shielding properties, it is preferable that minute practices of an average particle diameter of 0.1-1 μm are employed in an amount of 1-15 parts by weight with respect to 100 pars by weight of the ultraviolet radiation curable resin composition.

By incorporating such minute particles into ultraviolet radiation curable resins, it is possible to form a glare shielding layer exhibiting the preferred unevenness of center line mean surface roughness Ra of 0.05-0.5 μm. Further, when the above minute particles are not incorporated into ultraviolet radiation curable resin compositions, it is possible to form a hard cost layer exhibiting the desired smooth surface of a center line means roughness Ra of less than 0.05 μm, but preferably 0.002-0.04 μm.

Other than these, as a material to result in a blocking prevention function, it is possible to employ microscopic particles of a volume average particle diameter of 0.005-0.1 mm which are the same components as above in an amount of 0.1-5 parts by weight with respect to 100 parts by weight of the resin composition.

An antireflection layer is provided on the above hard coating layer. The providing methods are not particularly limited, and a common coating method, a sputtering method, a deposition method, CVD (chemical vapor deposition) method and an atmospheric pressure plasma method may be employed individually or in combination. In the present invention, it is particularly preferable to provide the antireflection layer employing a common coating method.

Listed as methods to form the antireflection layer via coating are a method in which metal oxide powder is dispersed into binder resins dissolved in solvents and the resulting dispersion is coated and subsequently dried, a method in which a polymer having a cross-linking structure is used as binder resin, and a method in which ethylenic unsaturated monomers and photopolymerization initiators are incorporated and a layer is formed via exposure to actinic radiation.

In the present invention, it is possible to provide an antireflection layer on the cellulose ester film provided with an ultraviolet radiation curable resinous layer. In order to decrease reflectance, it is preferable to form a low refractive index layer on the uppermost layer of optical film and then to provide between them a metal oxide layer which is a high refractive index layer, and further to provide a medium refractive index layer (being a metal oxide layer of which refractive index has been controlled by varying the metal oxide content, the ratio to the resinous binders, or the kind of metal). The refractive index of the high refractive index layer is preferably 1.55-2.30, but is more preferably 1.57-2.20. The refractive index of the medium refractive index layer is controlled to the intermediate value between the refractive index (approximately 1.5) of cellulose ester film as a substrate and the refractive index of the high refractive index layer. The refractive index of the medium refractive index layer is preferably 1.55-1.80. The thickness of each layer is preferably 5 nm-0.5 μm, is more preferably 10 nm-0.3 μm, but is most preferably 30 nm-0.2 μm. The haze of the metal oxide layer is preferably at most 5 percent, is more preferably at most 3 percent, but is most preferably at most 1 percent. The strength of the metal oxide layer is preferably at least 3H in terms of pencil strength of 1 kg load, but is most preferably at least 4H. In cases in which the metal oxide layer is formed employing a coating method, it is preferable that minute inorganic particles and binder polymers are incorporated.

It is preferable that the medium and high refractive index layers in the present invention are formed in such a manner that a liquid coating composition incorporating monomers or oligomers of organic titanium compounds represented by Formula (T) below, or hydrolyzed products thereof are coated and subsequently dried, and the resulting refractive index is 1.55-2.5.
Ti(OR¹)₄ Formula (T)
wherein R¹ is an aliphatic hydrocarbon group having 1-8 carbon atoms, but is preferably an aliphatic hydrocarbon group having 1-4 carbon atoms. Further, in monomers or oligomers of organic titanium compounds or hydrolyzed products thereof, the alkoxide group undergoes hydrolysis to form a crosslinking structure via reaction such as —Ti—O—Ti, whereby a cured layer is formed.

Listed as preferred examples of monomers and oligomers of organic titanium compounds employed in the present invention are dimers—decamers of Ti(OCH₃)₄, Ti(OC₂H₅)₄, Ti(O-n-C₃H₇)₄, Ti(O-i-C₃H₇)₄, Ti(O-n-C₄H₉)₄, and Ti(O-n-C₃H₇)₄, and dimers—decamers of Ti(O-n-C₄H₉)₄. These may be employed individually or in combinations of at least two types. Of these, particularly preferred are dimers—decamers of Ti(O-n-C₃H₇)₄, Ti(O-i-C₃H₇)₄, Ti(O-n-C₄H₉)₄, and Ti(O-n-C₃H₇)₄.

In the course of preparation of the medium and high refractive index layer liquid coating compositions in the present invention, it is preferable that the above organic titanium compounds are added to the solution into which water and organic solvents, described below, have been successively added. In cases in which water is added later, hydrolysis/polymerization is not uniformly performed, whereby cloudiness is generated or the layer strength is lowered. It is preferable that after adding water and organic solvents, the resulting mixture is vigorously stirred to enhance mixing and dissolution has been completed.

Further, an alternative method is employed. A preferred embodiment is that organic titanium compounds and organic solvents are blended, and the resulting mixed solution is added to the above solution which is prepared by stirring the mixture of water and organic solvents.

Further, the amount of water is preferably in the range of 0.25-3 mol per mol of the organic titanium compounds. When the amount of water is less than 0.25 mol, hydrolysis and polymerization are not sufficiently performed, whereby layer strength is lowered, while when it exceeds 3 mol, hydrolysis and polymerization are excessively performed, and coarse TiO₂ particles are formed to result in cloudiness. Accordingly, it is necessary to control the amount of water within the above range.

Further, the content of water is preferably less than 10 percent by weight with respect to the total liquid coating composition. When the content of water exceeds 10 percent by weight with respect to the total liquid coating composition, stability during standing of the liquid coating composition is degraded to result in cloudiness. Therefore, it is not preferable.

Organic solvents employed in the present invention are preferably water-compatible. Preferred as water-compatible solvents are, for example, alcohols (for example, methanol, ethanol, propanol, isopropanol, butanol, isobutanol, secondary butanol, tertiary butanol, pentanol, hexanol, cyclohexanol, and benzyl alcohol; polyhydric alcohols (for example, ethylene glycol, diethylene glycol, triethylene glycol, polyethylene glycol, propylene glycol, dipropylene glycol, polypropylene glycol, butylenes glycol, hexanediol, pentanediol, glycerin, hexanetriol, and thioglycol); polyhydric alcohol ethers (for example, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monomethyl ether, propylene glycol monobutyl ether, ethylene glycol monomethyl ether acetate, triethylene glycol monomethyl ether, triethylene glycol monoethyl ether, ethylene glycol monophenyl ether, and propylene glycol monophenyl ether); amines (for example, ethanolamine, diethanolamine, triethanolamine, N-methyldiethanolamine, N-ethyldiethanolamine, morpholine, N-ethylmorpholine, ethylenediamine, diethylenediamine, triethylenetetramine, tetraethylenepentamine, polyethyleneimine, pentamthyldiethylenetriamine, and tetramethylpropylenediamine); amides (for example, formamide, N,N-dimethylfromamide, and N,N-dimethylacetamide); heterocycles (for example, 2-pyrrolidone, N-methyl-2-pyrrolidone, cyclohexylpyrrolidone, 2-oxazolidone, 1,3-dimethyl-2-imidazolidinone); and sulfoxides (for example, dimethylsulfoxide); sulfones (for example, sulfolane); as well as urea, acetonitrile, and acetone. Of these, particularly preferred are alcohols, polyhydric alcohols, and polyhydric alcohol ethers. As noted above, the used amount of these organic solvents may be controlled so that the content of water is less than 10 percent by weight with respect to the total liquid coating composition by controlling the total used amount of water and the organic solvents.

The content of monomers and oligomers of organic titanium compounds employed in the present invention, as well as hydrolyzed products thereof is preferably 50.0-98.0 percent by weight with respect to solids incorporated in the liquid coating composition. The solid ratio is more preferably 50-90 percent by weight, but is still more preferably 55-90 percent by weight. Other than these, it is preferable to incorporate polymers of organic titanium compounds (which are subjected to hydrolysis followed by crosslinking) in a liquid coating composition, or to incorporate minute titanium oxide particles.

The high refractive index and medium refractive index layers in the present invention may incorporate metal oxide particles as minute particles and further may incorporate binder polymers.

In the above method of preparing liquid coating compositions, when hydrolyzed/polymerized organic titanium compounds and metal oxide particles are combined, both strongly adhere to each other, whereby it is possible to obtain a strong coating layer provided with hardness and uniform layer flexibility.

The refractive index of metal oxide particles employed in the high and medium refractive index layers is preferably 1.80-2.80, but is more preferably 1.90-2.80. The weight average diameter of the primary particle of metal oxide particles is preferably 1-150 nm, is more preferably 1-100 nm, but is most preferably 1-80 nm. The weight average diameter of metal oxide particles in the layer is preferably 1-200 nm, is more preferably 5-150 nm, is still more preferably 10-100 nm, but is most preferably 10-80 nm. Metal oxide particles at an average particle diameter of at least 20-30 nm are determined employing a light scattering method, while the particles at a diameter of at most 20-30 nm are determined employing electron microscope images. The specific surface area of metal oxide particles is preferably 10-400 m²/g as a value determined employing the BET method, is more preferably 20-200 m²/g, but is most preferably 30-150 m²/g.

Examples of metal oxide particles are metal oxides incorporating at least one element selected from the group consisting of Ti, Zr, Sn, Sb, Cu, Fe, Mn, Pb, Cd, As, Cr, Hg, Zn, Al, Mg, Si, P, and S. Specifically listed are titanium dioxide, (for example, rutile, rutile/anatase mixed crystals, anatase, and amorphous structures), tin oxide, indium oxide, zinc oxide, and zirconium oxide. Of these, titanium oxide, tin oxide, and indium oxide are particularly preferred. Metal oxide particles are composed of these metals as a main component of oxides and are capable of incorporating other metals. Main component, as described herein, refers to the component of which content (in percent by weight) is the maximum in the particle composing components. Listed as examples of other elements are Ti, Zr, Sn, Sb, Cu, Fe, Mn, Pb, Cd, As, Cr, Hg, Zn, Al, Mg, Si, P and S.

It is preferable that metal oxide particles are subjected to a surface treatment. It is possible to perform the surface treatment employing inorganic or organic compounds. Listed as examples of inorganic compounds used for the surface treatment are alumina, silica, zirconium oxide, and iron oxide. Of these, alumina and silica are preferred. Listed as examples of organic compounds used for the surface treatment are polyol, alkanolamine, stearic acid, silane coupling agents, and titanate coupling agents. Of these, silane coupling agents are most preferred.

Specific examples of silane coupling agents include methyltrimethoxysilane, methyltriethoxysilane, methyltrimethoxyethoxysilane, methyltriacetoxysilane, methyltributoxysilane, ethyltrimethoxysilane, ethyltriethoxysilane, vinyltrimethoxysilane, vinyltriethoxysilane, vinyltriacetoxysilane, vinyltrimethoxyethoxysilane, phenyltrimethoxysilane, phenyltriethoxysilane, phenyltriacetoxysilane, γ-chloropropyltrimethoxysilane, γ-chloropropyltriethoxysilane, γ-chloropropyltriacetoxysilane, 3,3,3-trifluoropropyltrimethoxysilane, γ-glycidyloxypropyltrimethoxysilane, γ-glycidyloxypropyltriethoxysilane, γ-(β-glycidyloxyethoxy)propyltrimethoxysilane, β-(3,4-epoxycyclohexyl)ethyltrimethoxysilane, β-(3,4-epoxycyclohexyl)ethyltriethoxysilane, γ-acryloyloxypropyltrimethoxysilane, γ-methacryloyloxypropyltrimethoxysilane, γ-aminopropyltrimethoxysilane, γ-aminopropyltriethoxysilane, γ-mercaptopropyltriethoxysilane, N-β-(aminoethyl)-γ-aminopropyltrimethoxysilane, and β-cyanoethyltriethoxysilane.

Further, examples of silane coupling agents having an alkyl group of 2-substitution for silicon include dimethyldimethoxysilane, phenylmethyldimethoxysilane, dimethyldiethoxysilane, phenylmethyldiethoxysilane, γ-glycidyloxypropylmethyldiethoxysilane, γ-glycidyloxypropylmethyldimethoxysilane, γ-glycidyloxypropylphenyldiethoxysilane, γ-chloropropylmethyldiethoxysilane, dimethyldiacetoxysilane, γ-acryloyloxypropylmethyldimethoxysilane, γ-acryloyloxypropylmethyldiethoxysilane, γ-methacryloyloxypropylmethyldimethoxysilane, γ-methacryloyloxypropylmethyldiethoxysilane, γ-mercaptopropylmethyldimethoxysilane, γ-mercaptopropylmethyldiethoxysilane, γ-aminopropylmethyldimethoxysilane, γ-aminopropyldiethoxysilane, methylvinyldimethoxysilane, and methylvinyldiethoxysilnae.

Of these, preferred are vinyltrimethoxysilane, vinyltriethoxysilane, vinylacetoxysilane, vinyltrimethoxethoxyysilane, γ-acryloyloxypropylmethoxysilane, and γ-methacryloyloxypropylmethoxysilane which have a double bond in the molecule, as well as γ-acryloyloxypropylmethyldimethoxysilane, γ-acryloyloxypropyldiethoxysilane, γ-methacryloyloxypropylmethyldimethoxysilane, γ-methacryloyloxypropylmethyldiethjoxysilane, methylvinyldimethoxysilane, and methylvinyldiethaoxysilane which have an alkyl group having 2-substitution to silicon. Of these, particularly preferred are γ-acryloyloxypropyltrimethoxysilane, γ-methacryloyloxypropyltrimethoxysilane, γ-acryloyloxypropylmethyldimethoxysilane, γ-acryloyloxypropylmethyldiethoxysilane, γ-methacryloyloxypropylmethyldimethoxysilane, and γ-methacryloyloxypropylmethyldiethoxysilane.

At least two types of coupling agents may simultaneously be employed. In addition to the above silane coupling agents, other silane coupling agents may be employed. Listed as other silane coupling agents are alkyl esters of ortho-silicic acid (for example, methyl orthosilicate, ethyl orthosilicate, n-propyl orthosilicate, i-propyl orthosilicate, n-butyl orthosilicate, sec-butyl orthosilicate, and t-butyl orthosilicate) and hydrolyzed products thereof.

It is possible to practice a surface treatment employing coupling agents in such a manner that coupling agents are added to a minute particle dispersion and the resulting dispersion is allowed to stand at room temperature −60° C. for several hours-10 days. In order to promote the surface treatment reaction, added to the above dispersion may be inorganic acids (for example, sulfuric acid, hydrochloric acid, nitric acid, chromic acid, hypochlorous acid, boric acid, orthosilicic acid, phosphoric acid, and carbonic acid), and organic acids (for example, acetic acid, polyacrylic acid, benzenesulfonic acid, phenol, and polyglutamic acid), or salts thereof (for example, metal salts and ammonium salts).

It is preferable that these coupling agents have been hydrolyzed employing water in a necessary amount. When the silane coupling agent is hydrolyzed, the resulting coupling agent easily react with the above organic titanium compounds and the surface of metal oxide particles, whereby a stronger layer is formed. Further, it is preferable to previously incorporate hydrolyzed silane coupling agents into a liquid coating composition. It is possible to use the water employed for hydrolysis to perform hydrolysis/polymerization of organic titanium compounds.

In the present invention, a treatment may be performed by combining at least two types of surface treatments. It is preferable that the shape of metal oxide particles is rice grain-shaped, spherical, cubic, spindle-shaped, or irregular. At least two types of metal oxide-particles may be employed in the high refractive index layer and the medium refractive index layer.

The content of metal oxide particles in the high refractive index and medium refractive index layers is preferably 5-90 percent by weight, is more preferably 10-85 percent by weight, but is still more preferably 20-80 percent by weight. In cases in which minute particles are incorporated, the ratio of monomers or oligomers of the above organic titanium compounds or hydrolyzed products thereof is commonly 1-50 percent by weight with solids incorporated in the liquid coating composition, is preferably 1-40 percent by weight, but is more preferably 1-30 percent by weight.

The above metal oxide particles are dispersed into a medium and fed to liquid coasting compositions to form a high refractive index layer and a medium refractive index layer. Preferably employed as dispersion medium of metal oxide particles is a liquid at a boiling point of 60-170° C. Specific examples of dispersion media include water, alcohols (for example, methanol, ethanol, isopropanol, butanol, and benzyl alcohol), ketones (for example, acetone, methyl ethyl ketone, methyl isobutyl ketone, and cyclohexanone), esters (for example, methyl acetate, ethyl acetate, propyl acetate, butyl acetate, methyl formate, ethyl formate, propyl formate and butyl formate), aliphatic hydrocarbons (for example, hexane and cyclohexanone), halogenated hydrocarbons (for example, methylene chloride, chloroform, and carbon tetrachloride), aromatic hydrocarbons (for example, benzene, toluene, and xylene), amides (for example, dimethylformamide, diethylacetamide, and n-methylpyrrolidone), ethers (for example, diethyl ether, dioxane, and tetrahydrofuran), and ether alcohols (for example, 1-methoxy-2-propanol). Of these, particularly preferred are toluene, xylene, methyl ethyl ketone, methyl isobutyl ketone, cyclohexane and butanol.

Further, it is possible to disperse metal oxide particles into a medium employing a homogenizer. Listed as examples of homogenizers are a sand grinder mill (for example, a bead mill with pins), a high speed impeller mill, a pebble mill, a roller mill, an attritor, and a colloid mill. Of these, particularly preferred are the sand grinder and the high speed impeller mill. Preliminary dispersion may be performed. Listed as examples which are used for the preliminary dispersion are a ball mill, a three-roller mill, a kneader, and an extruder.

It is preferable to employ polymers having a crosslinking structure (hereinafter referred to as a crosslinking polymer) as a binder polymer in the high refractive index and medium refractive index layers. Listed as examples of the crosslinking polymers are crosslinking products (hereinafter referred to as polyolefin) such as polymers having a saturated hydrocarbon chain such as polyolefin, polyether, polyurea, polyurethane, polyester, polyamine, polyamide, or melamine resins. Of these, crosslinking products of polyolefin, polyether, and polyurethane are preferred, crosslinking products of polyolefin and polyether are more preferred, and crosslinking products of polyolefin are most preferred. Further, it is more preferable that crosslinking polymers have an anionic group. The anionic group exhibits a function to maintain the dispersion state of minute inorganic particles and the crosslinking structure exhibits a function to strengthen layers by providing a polymer with layer forming capability. The above anionic group may directly bond to a polymer chain or may bond to a polymer chain via a linking group. However, it is preferable that the anionic group bonds to the main chain via a linking group as a side chain.

Listed as examples of the anionic group are a carboxylic acid group (carboxyl), a sulfonic acid group (sulfo), and phosphoric acid group (phosphono). Of these, preferred are the sulfonic acid group and the phosphoric acid group. Herein, the anionic group may be in the form of its salts. Cations which form salts with the anionic group are preferably alkali metal ions. Further, protons of the anionic group may be dissociated. The linking group which bond the anionic group with a polymer chain is preferably a bivalent group selected from the group consisting of —CO—, —O—, an alkylene group, and an arylene group, and combinations thereof. Crosslinking polymers which are binder polymers are preferably copolymers having repeating units having an anionic group and repeating units having a crosslinking structure. In this case, the ratio of the repeating units having an anionic group in copolymers is preferably 2-96 percent by weight, is more preferably 4-94 percent by weight, but is most preferably 6-92 percent by weight. The repeating unit may have at least two anionic groups.

In crosslinking polymers having an anionic group, other repeating units (an anionic group is also a repeating unit having no crosslinking structure) may be incorporated. Preferred as other repeating units are repeating units having an amino group or a quaternary ammonium group and repeating units having a benzene ring. The amino group or quaternary ammonium group exhibits a function to maintain a dispersion state of minute inorganic particles. The benzene ring exhibits a function to increase the refractive index of the high refractive index layer. Incidentally, even though the amino group, quaternary ammonium group and benzene ring are incorporated in the repeating units having an anionic group and the repeating units having a crosslinking structure, identical effects are achieved.

In crosslinking polymers incorporating as a constituting unit the above repeating units having an amino group or a quaternary ammonium group, the amino group or quaternary ammonium group may directly bond to a polymer chain or may bond to a polymer chain via a side chain. But the latter is preferred. The amino group or quaternary ammonium group is preferably a secondary amino group, a tertiary amino group or a quaternary ammonium group, but is more preferably a tertiary amino group or a quaternary ammonium group. A group bonded to the nitrogen atom of a secondary amino group, a tertiary amino group or a quaternary ammonium group is preferably an alkyl group, is more preferably an alkyl group having 1-12 carbon atoms, but is still more preferably an alkyl group having 1-6 carbon atoms. The counter ion of the quaternary ammonium group is preferably a halide ion. The linking group which links an amino group or a quaternary ammonium group with a polymer chain is preferably a bivalent group selected from the group consisting of —CO—, —NH—, —O—, an alkylene group and an arylene group, or combinations thereof. In cases in which the crosslinking polymers incorporate repeating units having an amino group or an quaternary ammonium group, the ratio is preferably 0.06-32 percent by weight, is more preferably 0.08-30 percent by weight, but is most preferably 0.1-28 percent t by weight.

It is preferable that high and medium refractive index layer liquid coating compositions composed of monomers to form crosslinking polymers are prepared and crosslinking polymers are formed via polymerization reaction during or after coating of the above liquid coating compositions. Each layer is formed along with the formation of crosslinking polymers. Monomers having an anionic group function as a dispersing agent of minute inorganic particles in the liquid coating compositions. The used amount of monomers having an anionic group is preferably 1-50 percent by weight with respect to the minute inorganic particles, is more preferably 5-40 percent by weight, but is still more preferably 10-30 percent by weight. Further, monomers having an amino group or a quaternary ammonium group function as a dispersing aid in the liquid coating compositions. The used amount of monomers having an amino group or a quaternary ammonium group is preferably 3-33 percent by weight with respect to the monomers having an anionic group. By employing a method in which crosslinking polymers are formed during or after coating of a liquid coating composition, it is possible to allow these monomers to effectively function prior to coating of the liquid coating compositions.

Most preferred as monomers employed in the present invention are those having at least two ethylenic unsaturated groups. Listed as those examples are esters of polyhydric alcohols and (meth)acrylic acid (for example, ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol (meth)acrylate, pentaerythritol hexa(meth)acrylate, 1,2,3-cyclohexane tetramethacrylate, polyurethane polyacrylate, and polyester polyacrylate); vinylbenzne and derivatives thereof (for example, 1,4-divinylbenzene, 4-vinyl-benzoic acid-2-acryloylethyl ester, and 1,4-divinylcyclohexane); vinylsulfones (for example, divinylsulfone); acrylamides (for example, methylenebisacrylamide); and methacrylamides. Commercially available monomers having an anionic group and monomers having an amino group or a quaternary ammonium group may be employed. Listed as commercially available monomers having an anionic group which are preferably employed are KAYAMAR PM-21 and PM-2 (both produced by Nihon Kayaku Co., Ltd.); ANTOX MS-60, MS-2N, and MS-NH4 (all produced by Nippon Nyukazai Co., Ltd.), ARONIX M-5000, M-6000, and M-8000 SERIES (all produced by Toagosei Chemical Industry Co., Ltd.); BISCOAT #2000 SERIES (produced by Osaka Organic Chemical Industry Ltd.); NEW FRONTIER GX-8289 (produced by Dai-ichi Kogyo Seiyaku Co., Ltd.); NK ESTER CB-1 and A-SA (produced by Shin-Nakamura Chemical Co., Ltd.); and AR-100, MR-100, and MR-200 (produced by Diahachi Chemical Industry Co., Ltd.). Listed as commercially available monomers having an amino group or a quaternary ammonium group which are preferably employed are DMAA (produced by Osaka Organic Chemical Industry Ltd.); DMAEA and DMAPAA (produced by Kojin Co., Ltd.); BLENMER QA (produced by NOF Corp.), and NEW FRONTIER C-1615 (produced by Dia-ichi Kogyo Seiyaku Co., Ltd.).

It is possible to perform polymer polymerization reaction employing a photopolymerization reaction or a thermal polymerization reaction. The photopolymerization reaction is particularly preferred. It is preferable to employ polymerization initiators to perform the polymerization reaction. For example, listed are thermal polymerization initiators and photopolymerization imitators described below which are employed to form binder polymers of the hard coating layer.

Employed as the polymerization initiators may be commercially available ones. In addition to the polymerization initiators, employed may be polymerization promoters. The added amount of polymerization initiators and polymerization promoters is preferably in the range of 0.2-10 percent by weight of the total monomers. Polymerization of monomers (or oligomers) may be promoted by heating a liquid coating composition (being an inorganic particle dispersion incorporating monomers). Further, after the photopolymerization reaction after coating, the resulting coating is heated whereby the formed polymer may undergo additional heat curing reaction.

It is preferable to use relatively high refractive index polymers in the medium and high refractive index layers. Listed as examples of polymers exhibiting a high refractive index are polystyrene, styrene copolymers, polycarbonates, melamine resins, phenol resins, epoxy resins, and urethanes which are obtained by allowing cyclic (alicyclic or aromatic) isocyanates to react with polyols. It is also possible to use polymers having another cyclic (aromatic, heterocyclic, and alicyclic) group and polymers having a halogen atom other than fluorine as a substituent due to their high refractive index.

Low refractive index layers usable in the present invention include a low refractive index layer which is formed by crosslinking of fluorine containing resins (hereinafter referred to as “fluorine containing resins prior to crosslinking) which undergo crosslinking by heat or ionizing radiation, a low refractive index layer prepared employing a sol-gel method, and a low refractive index layer composed of minute particles and binder polymers in which voids exist among minute particles or in the interior of the minute particle. In the present invention, preferred is the low refractive index layer mainly employing minute particles and binder polymers. The low refractive index layer having voids in the interior of the particle (also called the minute hollow particle) is preferred since it is possible to lower the refractive index. However, a decrease in the refractive index of the low refractive index layer is preferred due to an improvement of antireflection performance, while it becomes difficult to provide desired strength. In view of the above compatibility, the refractive index of the low refractive index layer is preferably at most 1.45, is more preferably 1.30-1.50, is still more preferably 1.35-1.49, but is most preferably 1.35-1.45.

Further, the above preparation methods of the low refractive index layer may be suitably combined.

Preferably listed as fluorine containing resins prior to coating are fluorine containing copolymers which are formed employing fluorine containing vinyl monomers and crosslinking group providing monomers. Listed as specific examples of the above fluorine containing vinyl monomer units are fluoroolefins (for example, fluoroethylene, vinylidene fluoride, tetrafluoroethylene, hexafluoroethylene, hexafluoropropylene, perfluoro-2,2-dimethyl-1,3-dioxol), partially or completely fluorinated alkyl ester derivatives of (meth)acrylic acid (for example, BISCOAT 6FM (produced by Osaka Organic Chemical Industry Ltd.) and M-2020 (produced by Daikin Industries, Ltd.), and completely or partially fluorinated vinyl ethers. Listed as monomers to provide a crosslinking group are vinyl monomers previously having a crosslinking functional group in the molecule, such as glycidyl methacrylate, vinyltrimethoxysilane, γ-methacryloyloxypropyltrimethoxysilane, or vinyl glycidyl ether, as well as vinyl monomers having a carboxyl group, a hydroxyl group, an amino group, or a sulfone group (for example, (meth)acrylic acid, methylol (meth)acrylate, hydroxyalkyl (meth)acrylate, allyl acrylate, hydroxyalkyl vinyl ether, and hydroxyalkyl allyl ether). JP-A Nos. 10-25388 and 10-147739 describe that a crosslinking structure is introduced into the latter by adding compounds having a group which reacts with the functional group in the polymer and at least one reacting group. Listed as examples of the crosslinking group are a acryloyl, methacryloyl, isocyanate, epoxy, aziridine, oxazoline, aldehyde, carbonyl, hydrazine, carboxyl, methylol or active methylene group. When fluorine containing polymers undergo thermal crosslinking due to the presence of a thermally reacting crosslinking group or the combinations of an ethylenic unsaturated group with thermal radical generating agents or an epoxy group with a heat generating agent, the above polymers are of a heat curable type. On the other hand, in cases in which crosslinking undergoes by exposure to radiation (preferably ultraviolet radiation and electron beams) employing combinations of an ethylenic unsaturated group with photo-radical generating agents or an epoxy group with photolytically acid generating agents, the polymers are of an ionizing radiation curable type.

Further, employed as a fluorine containing resins prior to coating may be fluorine containing copolymers which are prepared by employing the above monomers with fluorine containing vinyl monomers, and monomers other than monomers to provide a crosslinking group in addition to the above monomers. Monomers capable being simultaneously employed are not particularly limited. Those examples include olefins (ethylene, propylene, isoprene, vinyl chloride, and vinylidene chloride); acrylates (methyl acrylate, ethyl acrylate, and 2-ethylhexyl acrylate); methacrylates (methyl methacrylate, ethyl methacrylate, butyl methacrylate, and ethylene glycol dimethacrylate); styrene derivatives (styrene, divinylbenzene, vinyltoluene, and α-methylstyrene); vinyl ethers (methyl vinyl ether); vinyl esters (vinyl acetate, vinyl propionate, and vinyl cinnamate); acrylamides (N-tert-butylacrylamide and N-cyclohexylacrylamide); methacrylamides; and acrylonitrile derivatives. Further, in order to provide desired lubricating properties and antistaining properties, it is also preferable to introduce a polyorganosiloxane skeleton or a perfluoropolyether skeleton into fluorine containing copolymers. The above introduction is performed, for example, by polymerization of the above monomers with polyorganosiloxane and perfluoroether having, at the end, an acryl group, a methacryl group, a vinyl ether group, or a styryl group and reaction of polyorganosiloxane and perfluoropolyether having a functional group.

The used ratio of each monomer to form the fluorine containing copolymers prior to coating is as follows. The ratio of fluorine containing vinyl monomers is preferably 20-70 mol percent, but is more preferably 40-70 mol percent; the ratio of monomers to provide a crosslinking group is preferably 1-20 mol percent, but is more preferably 5-20 mol percent, and the ratio of the other monomers simultaneously employed is preferably 10-70 mol percent, but is more preferably 10-50 mol percent.

It is possible to obtain the fluorine containing copolymers by polymerizing these monomers employing methods such as a solution polymerization method, a block polymerization method, an emulsion polymerization method or a suspension polymerization method.

The fluorine containing resins prior to coating are commercially available and it is possible to employ commercially available products. Listed as examples of the fluorine containing resins prior to coating are SAITOP (produced by Asahi Glass Co., Ltd.), TEFLON (a registered trade name) AD (produced by Du Pont), vinylidene polyfluoride, RUMIFRON (produced by Asahi Glass Co., Ltd.), and OPSTAR (produced by JSR).

The dynamic friction coefficient and contact angle to water of the low refractive index layer composed of crosslinked fluorine containing resins are in the range of 0.03-0.15 and in the range of 90-120 degrees, respectively.

In view of controlling the refractive index, it is preferable that the low refractive index layer composed of crosslinked fluorine containing resins incorporates minute inorganic particles described below. Further, it is preferable that minute inorganic particles are subjected to a surface treatment. Surface treatment methods include physical surface treatments such as a plasma discharge treatment and a corona discharge treatment, and a chemical surface treatment employing coupling agents. It is preferable to use the coupling agents. Preferably employed as coupling agents are organoalkoxy metal compounds (for example, a titanium coupling argent and a silane coupling agent). In cases in which minute inorganic particles are composed of silica, the treatment employing the silane coupling agent is are particularly effective.

Further, preferably employed as components for the low refractive index layer may be various types of sol-gel components. Preferably employed as such sol-gel components may be metal alcolates (being alcolates of silane, titanium, aluminum, or zirconium, and organoalkoxy metal compounds and hydrolysis products thereof. Particularly preferred are alkoxysilane, and hydrolysis products thereof. It is also preferable to use tetraalkoxysilane (tetramethoxysilane and tetraethoxysilane), alkyltrialkoxysilane (methyltrimethoxysilane, and ethyltrimethoxysilane), aryltrialkoxysilane (phenyltrimethoxysilane, dialkyldialkoxysilane, diaryldialkoxysilane. Further, it is also preferable to use organoalkoxysilanes having various type of functional group (vinyltrialkoxysilane, methylvinyldialkoxysilane, γ-glycidyloxypropyltrialkoxysilane, γ-glycidyloxyoropylmethyldialkoxysilane, β-(3,4)epoxycyclohexyl)ethyltrialkoxysilane, γ-merthacryloyloxypropyltrialkoxysilane, γ-aminopropyltrialkoxysilane, γ-mercaptopropyltrialkoxysilane, and γ-chloropropyltrialkoxysilane), perfluoroalkyl group containing silane compounds (for example, (heptadecafluoro1,1,2,2-tetradecyl)triethoxysilane, 3,3,3-trifluoropropyltrimethoxy silane). In view of decreasing the refractive index of the layer and providing water repellency and oil repellency, it is preferable to particularly use fluorine containing silane compounds.

As a low refractive index layer, it is preferable to employ a layer which is prepared in such a manner that minute inorganic or organic particles are employed and micro-voids are formed among minute particles or in the minute particle. The average diameter of the minute particles is preferably 0.5-200 nm, is more preferably 1-100 nm, but is most preferably 5-40 nm. Further, it is preferable that the particle diameter is as uniform (monodispersion) as possible.

Minute inorganic particles are preferably non-crystalline. The minute inorganic particles are preferably composed of metal oxides, nitrides, sulfides or halides, are more preferably composed of metal oxides or metal halides, but are most preferably composed of metal oxides or metal fluorides. Preferred as metal atoms are Na, K, Mg, Ca, Ba, Al, Zn, Fe, Cu, Ti, Sn, In, W, Y, Sb, Mn, Ga, V, Nb, Ta, Ag, Si, Br Bi, Mo, Ce, Cd, Be, Ob and Ni. Of these, more preferred are Mg, Ca, B and Si. Inorganic compounds incorporating two types of metal may be employed. Specific examples of preferred inorganic compounds include SuO₂ or MgF₂, and SiO₂ is particularly preferred.

It is possible to form particles having micro-voids in the interior of an inorganic particle, for example, by crosslinking silica molecules. When silica molecules undergo crosslinking, the resulting volume decreases whereby a particle becomes porous. It is possible to directly synthesize micro-void containing (porous) inorganic particles as a dispersion, employing the sol-gel method (described in JP-A Nos. 53-112732 and 57-9051) and the deposition method (described in Applied optics, Volume 27, page 3356 (1988)). Alternatively, it is also possible to obtain a dispersion in such a manner that powder prepared by a drying and precipitation method is mechanically pulverized. Commercially available minute porous inorganic particles (for example, SiO₂ sol) may be employed.

In order to form a low refractive index layer, it is preferable that these minute inorganic particles are employed in the state dispersed in a suitable medium. Preferred as media are water, alcohol (for example, methanol, ethanol, and isopropyl alcohol), and ketone (for example, methyl ethyl ketone and methyl isobutyl ketone).

It is also preferable that minute organic particles are non-crystalline and are minute polymer particles which are synthesized by the polymerization reaction (for example, an emulsion polymerization method) of monomers. It is preferable that the polymers of minute organic particles incorporate fluorine atoms. The ratio of fluorine atoms in polymers is preferably 35-80 percent by weight, but is more preferably 45-75 percent by weight. Further, it is preferable that micro-voids are formed in the minute organic particle in such a manner that particle forming polymers undergo crosslinking so that a decrease in the volume forms micro-voids. In order that particle forming polymers undergo crosslinking, it is preferable that at least 20 mol percent of monomers to synthesize a polymer are multifunctional monomers. The ratio of the multifunctional monomers is more preferably 30-80 mol percent, but is most preferably 35-50 mol percent. Listed as examples of fluorine containing monomers employed to synthesize the above fluorine containing polymers are fluorolefins (for example, fluoroethylene, vinylidene fluoride, tetrafluoroethylene, hexafluoropropylene, and perfluoro-2,2-dimethyl-1,3-dioxol), as well as fluorinated alkyl esters of acrylic acid or methacrylic acid and fluorinated vinyl ethers. Copolymers of monomers with and without fluorine atoms may be employed. Listed as examples of monomers without fluorine atoms are olefins (for example, ethylene, propylene, isoprene, vinyl chloride, and vinylidene chloride), acrylates (for example, methyl acrylate, ethyl acrylate, and 2-ethylhexyl acrylate), methacrylates (for example, ethyl methacrylate and butyl methacrylate), styrenes (for example, styrene, vinyltoluene, and α-methylstyrene), vinyl ethers (for example, methyl vinyl ether), vinyl esters (for example, vinyl acetate and vinyl propionate), acrylamides (for example, N-tert-butylacrylamide and N-cyclohexylacrylamide), methacrylamides, and acrylonitriles. Listed as examples of multifunctional monomers are dienes (for example, butadiene and pentadiene), esters of polyhydric alcohol with acrylic acid (for example, ethylene glycol diacrylate, 1,4-cyclohexane diacrylate, and dipentaerythritol hexaacrylate), esters of polyhydric alcohol with methacrylic acid (for example, ethylene glycol dimethacrylate, 1,2,4-cyclohexane tetramethacrylate, and pentaerythritol tetramethacrylate), divinyl compounds (for example, divinylcyclohexane and 1,4-divinylbenzene), divinylsulfone, and bisacrylamides (for example, methylenebisacrylamide) and bismethacrylamides.

It is possible to form micro-voids among particles by piling at least two minute particles. Incidentally, when minute spherical particles (completely monodispersed) of an equal diameter are subjected to closest packing, micro-voids at a 26 percent void ratio by volume are formed among minute particles. When spherical particles of an equal diameter are subjected to simple cubic packing, micro-voids at 48 percent void ratio by volume are formed among minute particles. In a practical low refractive index layer, the void ratio significantly shifts from the theoretical value due to the distribution of diameter of the minute particles and the presence of voids in the particle. As the void ratio increases the refractive index of the low refractive index layer decreases. When micro-voids are formed by piling minute particles, it is possible to easily control the size of micro-voids among particles to an appropriate value (being a value minimizing scattering light and resulting in no problems of the strength of the low refractive index layer) by adjusting the diameter of minute particles. Further, by making the diameter of minute particles uniform, it is possible to obtain an optically uniform low refractive index layer of the uniform size of micro-voids among particles. By doing so, though the resulting low refractive index layer is microscopically a micro-void containing porous layer, optically or macroscopically, it is possible to make it a uniform layer. It is preferable that micro-voids among particles are confined in the low refractive index layer employing minute particles and polymers. Confined voids exhibits an advantage such that light scattering on the surface of a low refractive index layer is decreased compared to the voids which are not confined.

By forming micro-voids, the macroscopic refractive index of the low refractive index layer becomes lower than the total refractive index of the components constituting the low refractive index layer. The refractive index of a layer is the sum of the refractive indexes per volume of layer constituting components. The refractive index value of the constituting components such as minute particles or polymers of the low refractive index lay is larger than 1, while the refractive index of air is 1.00. Due to that, by forming micro-voids, it is possible to obtain a low refractive index layer exhibiting significantly lower refractive index.

Further, in the present invention, an embodiment is also preferred in which minute hollow SiO₂ particles are employed.

Minute hollow particles, as described in the present invention, refer to particles which have a particle wall, the interior of which is hollow. An example of such particles includes particles which are formed in such a manner that the above SiO₂ particles having voids in the interior of particles are further subjected to surface coating employing organic silicon compounds (being alkoxysilanes such as tetraethoxysilane) to close the pores. Alternatively, voids in the interior of the wall of the above particles may be filled with solvents or gases. For example, in the case of air, it is possible to significantly lower the refractive index (at 1.44-1.34) of minute hollow particles compared to common silica at a refractive index of 1.46). By adding such minute hollow SiO₂ particles, it is possible to further lower the refractive index of the low refractive index layer.

Making particles having micro-voids in the above minute inorganic particle hollow may be achieved based on the methods described in JP-A Nos. 2001-167637 and 2001-233611. Further, it is possible to use commercially available minute hollow SiO₂ particles. Listed as a specific example of commercially available particles is P-4 produced by Shokubai Kasei Kogyo Co.

It is preferable that the low refractive index layer incorporates polymers in an amount of 5-50 percent by weight. The above polymers exhibit functions such that minute particles are subjected to adhesion and the structure of the above low refractive index layer is maintained. The used amount of the polymers is controlled so that without filing voids, it is possible to maintain the strength of the low refractive index layer. The amount of the polymers is preferably 10-30 percent by weight of the total weight of the low refractive index layer. In order to achieve adhesion of minute particles employing polymers, it is preferable that (1) polymers are combined with surface processing agents of minute particles, (2) a polymer shell is formed around a minute particle used as a core, or (3) polymers are employed as a binder among minute particles. The polymers which are combined with the surface processing agents in (1) are preferably the shell polymers of (2) or binder polymers of (3). It is preferable that the polymers of (2) are formed around the minute particles employing a polymerization reaction prior to preparation of the low refractive index layer liquid coating composition. It is preferable that the polymers of (3) are formed employing a polymerization reaction during or after coating of the low refractive index layer while adding their monomers to the above low refractive index layer coating composition. It is preferable that at least two of (1), (2), and (3) or all are combined and employed. Of these, it is particularly preferable to practice the combination of (1) and (3) or the combination of (1), (2), and (3). (1) surface treatment, (2) shell, and (3) binder will now successively be described in that order.

(1) Surface Treatments

It is preferable that minute particles (especially, minute inorganic particles) are subjected to a surface treatment to improve affinity with polymers. These surface treatments are classified into a physical surface treatment such as a plasma discharge treatment or a corona discharge treatment and a chemical surface treatment employing coupling agents. It is preferable that the chemical surface treatment is only performed or the physical surface treatment and the chemical surface treatment are performed in combination. Preferably employed as coupling agents are organoalkoxymetal compounds (for example, titanium coupling agents and silane coupling agents). In cases in which minute particles are composed of SiO₂, it is possible to particularly effectively affect a surface treatment employing the silane coupling agents. As specific examples of the silane coupling agents, preferably employed are those listed above.

The surface treatment employing the coupling agents is achieved in such a manner that coupling agents are added to a minute particle dispersion and the resulting mixture is allowed to stand at room temperature −60° C. for several hours—10 days. In order to accelerate a surface treatment reaction, added to a dispersion may be inorganic acids (for example, sulfuric acid, hydrochloric acid, nitric acid, chromic acid, hypochloric acid, boric acid, orthosilicic acid, phosphoric acid, and carbonic acid), or salts thereof (for example, metal salts and ammonium salts).

(2) Shell

Shell forming polymers are preferably polymers having a saturated hydrocarbon as a main chain. Polymers incorporating fluorine atoms in the main chain or the side chain are preferred, while polymers incorporating fluorine atoms in the side chain are more preferred. Acrylates or methacrylates are preferred and esters of fluorine-substituted alcohol with polyacrylic acid or methacrylic acid are most preferred. The refractive index of shell polymers decreases as the content of fluorine atoms in the polymer increases. In order to lower the refractive index of a low refractive index layer, the shell polymers incorporate fluorine atoms in an amount of preferably 35-80 percent by weight, but more preferably 45-75 percent by weight. It is preferable that fluorine containing polymers are synthesized via the polymerization reaction of fluorine atom containing ethylenic unsaturated monomers. Listed as examples of fluorine atom containing ethylenic unsaturated monomers are fluorolefins (for example, fluoroethylene, vinylidene fluoride, tetrafluoroethylene, hexafluoropropylene, perfluoro-2,-dimethyl-1,3-dixol), fluorinated vinyl ethers and esters of fluorine substituted alcohol with acrylic acid or methacrylic acid.

Polymers to form the shell may be copolymers having repeating units with and without fluorine atoms. It is preferable that the units without fluorine atoms are prepared employing the polymerization reaction of ethylenic unsaturated monomers without fluorine atoms. Listed as examples of ethylenic unsaturated monomers without fluorine atoms are olefins (for example, ethylene, propylene, isoprene, vinyl chloride, and vinylidene chloride), acrylates (for example, methyl acrylate, ethyl acrylate, and 2-ethylhexyl acrylate), methacrylates (for example, methyl methacrylate, ethyl methacrylate, butyl methacrylate, and ethylene glycol dimethacrylate), styrenes and derivatives thereof (for example, styrene, divinylbenzene, vinyltoluene, and α-methylstyrene), vinyl ethers (for example, methyl vinyl ether), vinyl esters (for example, vinyl acetate, vinyl propionate, and vinyl cinnamate), acrylamides (for example, N-tetrabutylacrylamide and N-cyclohexylacrylamide), as well as methacrylamide and acrylonitrile.

In the case of (3) in which binder polymers described below are simultaneously used, a crosslinking functional group may be introduced into shell polymers and the shell polymers and binder polymers are chemically bonded via crosslinking. Shell polymers may be crystalline. When the glass transition temperature (Tg) of the shell polymer is higher than the temperate during the formation of a low refractive index layer, micro-voids in the low refractive index layer are easily maintained. However, when Tg is higher than the temperature during formation of the low refractive index layer, minute particles are not fused and occasionally, the resulting low refractive index layer is not formed as a continuous layer (resulting in a decrease in strength). In such a case, it is desirous that the low refractive index layer is formed as a continuous layer simultaneously employing the binder polymers of (3). A polymer shell is formed around the minute particle, whereby a minute core/shell particle is obtained. A core composed of a minute inorganic particle is incorporated preferably 5-90 percent by volume in the minute core/shell particle, but more preferably 15-80 percent by volume. At least two types of minute core/shell particle may be simultaneously employed. Further, inorganic particles without a shell and core/shell particles may be simultaneously employed.

(3) Binders

Binder polymers are preferably polymers having saturated hydrocarbon or polyether as a main chain, but is more preferably polymers having saturated hydrocarbon as a main chain. The above binder polymers are subjected to crosslinking. It is preferable that the polymers having saturated hydrocarbon as a main chain is prepared employing a polymerization reaction of ethylenic unsaturated monomers. In order to prepare crosslinked binder polymers, it is preferable to employ monomers having at least two ethylenic unsaturated groups. Listed as examples of monomers having at least two ethylenic unsaturated groups are esters of polyhydric alcohol with (meth)acrylic acid (for example, ethylene glycol di(meth)acrylate, 1,4-dicyclohexane diacrylate, pentaerythritol tetra(meth)acrylate, pentaerythritol (meth)acrylate, trimethylolpropane tri(meth)acrylate, trimethylolethane tri(meth)acrylate, dipentaerythritol tetra(meth)acrylate, dipentaerythritol penta(meth)acrylate, pentaerythritol hexa(meth)acrylate, 1,2,3-cyclohexane tetramethacrylate, polyurethane polyacrylate, and polyester polyacrylate); vinylbenzene and derivatives thereof (for example, 1,4-divinylbenzene and 4-vinylbenzoic acid-2-acryloylethyl ester, and 1,4-divinylcyclohexane); vinylsulfones (for example, divinylsulfone); acrylamides (for example, methylenebisacrylamide); and methacrylamides. It is preferable that polymers having polyether as a main chain are synthesized employing a ring opening polymerization reaction. A crosslinking structure may be introduced into binder polymers employing a reaction of crosslinking group instead of or in addition to monomers having at least two ethylenic unsaturated groups. Listed as examples of the crosslinking functional groups are an isocyanate group, an epoxy group, an aziridine group, an oxazoline group, an aldehyde group, a carbonyl group, a hydrazine group, a carboxyl group, a methylol group, and an active methylene group. It is possible to use, as a monomer to introduce a crosslinking structure, vinylsulfonic acid, acid anhydrides, cyanoacrylate derivatives, melamine, ether modified methylol, esters and urethane. Functional groups such as a block isocyanate group, which exhibit crosslinking properties as a result of the decomposition reaction, may be employed. The crosslinking groups are not limited to the above compounds and include those which become reactive as a result of decomposition of the above functional group. Employed as polymerization initiators used for the polymerization reaction and crosslinking reaction of binder polymers are heat polymerization initiators and photopolymerization initiators, but the photopolymerization initiators are more preferred. Examples of photopolymerization initiators include acetophenones, benzoins, benzophenones, phosphine oxides, ketals, antharaquinones, thioxanthones, azo compounds, peroxides, 2,3-dialkyldiones, disulfide compounds, fluoroamine compounds, and aromatic sulfoniums. Examples of acetophenones include 2,2-diethoxyacetophenone, p-dimethylacetophenone, 1-hydroxydimethyl phenyl ketone, 1-dihydroxycyclohexyl phenyl ketone, 2-methyl-4-methylthio-2-morpholinopropiophene, and 2-benzyl-2-dimethylamino-1-(4-morpholinophenyl)-butanone. Examples of benzoins include benzoin ethyl ether and benzoin isopropyl ether. Examples of benzophenones include benzophenone, 2,4-dichlorobenzophenone, 4,4-dichlorobenzophenone, and p-chlorobenzophenone. An example of phosphine oxides includes 2,4,6-trimethylbenzoyldiphenylphosphine oxide.

It is preferable that binder polymers are formed in such a manner that monomers are added to a low refractive index layer liquid coating composition and the binder polymers are formed during or after coating of the low refractive index layer utilizing a polymerization reaction (if desired, further crosslinking reaction). A small amount of polymers (for example, polyvinyl alcohol, polyoxyethylene, polymethyl methacrylate, polymethyl acrylate, diacetyl cellulose, triacetyl cellulose, nitrocellulose, polyester, and alkyd resins) may be added to the low refractive index layer liquid coating composition.

Further, it is preferable to add slipping agents to the low refractive index layer or other refractive index layers. By providing desired slipping properties, it is possible to improve abrasion resistance. Preferably employed as slipping agents are silicone oil and wax materials. For example, preferred are the compounds represented by the formula below.
R₁COR₂ Formula

In the above formula, R₁ represents a saturated or unsaturated aliphatic hydrocarbon group hang at least 12 carbon atoms, while R₁ is preferably an alkyl group or an alkenyl group but is more preferably an alkyl group or an alkenyl group having at least 16 carbon atoms. R₂ represents —OM₁ group (M₁ represents an alkaline metal such as Na or K), —OH group, —NH₂ group, or —OR₃ group (R₃ represents a saturated or unsaturated aliphatic hydrocarbon group having at least 12 carbon atoms and is preferably an alkyl group or an alkenyl group). R₂ is preferably —OH group, —NH₂ group or —OR₃ group. In practice, preferably employed may be higher fatty acids or derivatives thereof such as behenic acid, stearic acid amide, or pentacosanoic acid or derivatives thereof and natural products such as carnauba wax, beeswax, or montan wax, which incorporate a large amount of such components. Further listed may be polyorganosiloxane disclosed in Japanese Patent Publication No. 53-292, higher fatty acid amides discloses in U.S. Pat. No. 4,275,146, higher fatty acid esters (esters of a fatty acid having 10-24 carbon atoms and alcohol having 10-24 carbon atoms) disclosed in Japanese Patent Publication No. 58-35341, British Patent No. 927,446, or JP-A Nos. 55-126238 and 58-9o633, higher fatty acid metal salts disclosed in U.S. Pat. No. 3,933,516, polyester compounds composed of dicarboxylic acid having at least 10 carbon atoms and aliphatic or alicyclic diol disclosed in JP-A No. 51-37217, and oligopolyesters composed of dicarboxylic acid and diol disclosed in JP-A No. 7-13292.

For example, the added amount of slipping agents employed in the low refractive index layer is preferably 0.01-10 mg/m₂.

Added to each of the antireflection layers or the liquid coating compositions thereof may be polymerization inhibitors, leveling agents, thickeners, anti-coloring agents, UV absorbents, silane coupling agents, antistatic agents, and adhesion providing agents, other than metal oxide particles, polymers, dispersion media, polymerization initiators, and polymerization accelerators.

It is possible to form each layer of the antireflection films employing coating methods such as a dip coating method, an air-knife coating method, a curtain coating method, a roller coating method, a wire bar coating method, a gravure coating method, or an extrusion coating method (U.S. Pat. No. 2,681,294). At least two layers may be simultaneously coated. Simultaneous coating methods are described in U.S. Pat. Nos. 2,761,791, 2,941,898, 3,508,947, and 3,526,528, as well as Yuji Harazaki, Coating Kogaku (Coating Engineering), page 253, Asakura Shoten (1973).

In the present invention, in the production of an antireflection film, after applying the above liquid coating composition onto a support, drying is performed preferably at 60° C. or higher, but more preferably at 80° C. or higher. Further, drying is performed preferably at a dew point of 20° C. or lower, but is more preferably at a dew point of 15° C. or lower. It is preferable that drying is initiated within 10 seconds after coating onto a support. Combining the above conditions results in the preferred production method to achieve the effects of the present invention.

As noted above, the optical film of the present invention is preferably employed as an antireflection film, a hard coating film, a glare shielding film, a phase different film, an antistatic film, and a luminance enhancing film.

### EXAMPLE

The following specifically describes the present invention with reference to Examples, without the present invention being restricted thereto.

### Example 1

### Cellulose Acylate

### Example of Synthesis 1

30 g of acetic acid was added to 30 g of cellulose (dissolving pulp by Nippon Paper Industries Co., Ltd.), and was stirred for 30 minutes at 54° C. After the mixture was cooled, 150 g of acetic anhydride and 1.2 g of sulfuric acid having been cooled in an ice bath was added thereto so that esterification was carried out. In the process of esterification, the mixture was stirred for 150 minutes by making adjustment so that the temperature would not exceed 40° C. After termination of reaction, a mixture of 30 g of acetic acid 30 g and 10 g of water was dropped for 20 minutes so that excessive anhydride was hydrolyzed. While the reaction solution was kept at 40° C., 90 g of acetic acid 90 g and 30 g of water were added and were stirred for one hour. The mixture was put into an aqueous solution containing 2 g of magnesium acetate 2 g and was stirred for some time. After that, the mixture was filtered and dried to get cellulose acylate C-1. It had an acetyl replacement ratio of 2.80 and a mass average molecular weight of 220000.

### Examples of Synthesis 2 through 8

The acetic acid, acetic anhydride, propionic acid, propionic acid, butyric acid anhydride, butyric acid anhydride shown in Table 1 were used to carry out esterification, similarly to the case of the example of synthesis 1, whereby cellulose acylate C-2 through C-8 was obtained.

TABLE 1

| | | | Fatty | | Acyl group | | | Total number of | |
|---|---|---|---|---|---|---|---|---|---|
| | Fatty | | acid | | replacement | | | carbon atoms | |
| Cellulose | acid | | anhydride | | ratio | | | contained in acyl | |
| acylate | I | II | I | II | Ac | Pr | Bu | group | Mw |
| C-1 | 30 | 0 | 150 | 0 | 2.80 | 0.00 | — | 5.60 | 220000 |
| C-2 | 87 | 20 | 51 | 50 | 2.45 | 0.43 | — | 6.19 | 211000 |
| C-3 | 10 | 100 | 10 | 100 | 0.65 | 1.73 | — | 6.49 | 201000 |
| C-4 | 87 | 20 | 43 | 62 | 2.20 | — | 0.63 | 6.92 | 198000 |
| C-5 | 90 | 20 | 8 | 125 | 1.65 | 1.27 | — | 7.11 | 238000 |
| C-6 | 70 | 40 | 8 | 125 | 1.45 | 1.43 | — | 7.19 | 241000 |
| C-7 | 20 | 90 | 9 | 124 | 0.35 | 2.20 | — | 7.30 | 223000 |
| C-8 | 0 | 90 | 4 | 125 | 0.15 | 2.73 | — | 8.49 | 248000 |

In Table 1, the symbols denote the following groups:
Acyl group replacement ratio
Ac: acetyl group,
Pr: propionyl group,
Bu: butyryl group
Fatty acid
I: acetic acid,
II: propionic acid or butyric acid
Fatty acid anhydride
I: acetic anhydride,
II: propionic acid anhydride or n-butyric acid anhydride
Mw: mass average molecular weight, (which was measured by GPC HLC-8220 of Toso Co., Ltd.)

The replacement ratio of acyl group was obtained according to the method specified in the ASTM-D817. The total number of carbon atoms in the acyl group was calculated as follows:

Cellulose Acetate Propionate:
Total number of carbon atoms in acyl group=2×acetyl group replacement ratio+3×propionyl group replacement ratio
Cellulose Acetate Butylate:
Total number of carbon atoms in the acyl group=2×acetyl group replacement ratio+4×butyryl group replacement ratio

### Example of Synthesis 9 Through 41

Similarly to the case of the example of synthesis 1, the corresponding fatty acid and fatty acid anhydride was used to get cellulose acylates C-9 through C-41 shown in Table 2.

TABLE 2

| | | |
|---|---|---|
| | | Total number |
| | | of carbon |
| | Acyl group | atoms |
| Cellulose | replacement ratio | contained in |

| acylate | AC | Pr | Bu | Pe | acyl group |
|---|---|---|---|---|---|
| C-9 | 2.58 | — | — | — | 5.16 |
| C-10 | 0.35 | 1.62 | — | — | 5.56 |
| C-11 | 0.85 | 1.42 | — | — | 5.96 |
| C-12 | 1.35 | 1.08 | — | — | 5.94 |
| C-13 | 2.65 | 0.23 | — | — | 5.99 |
| C-14 | 2.65 | 0.27 | — | — | 6.11 |
| C-15 | 2.65 | — | 0.20 | — | 6.10 |
| C-16 | 2.65 | — | — | 0.16 | 6.10 |
| C-17 | 0.95 | 1.43 | — | — | 6.19 |
| C-18 | 1.65 | 0.97 | — | — | 6.21 |
| C-19 | 1.90 | — | 0.60 | — | 6.20 |
| C-20 | 2.00 | — | — | 0.44 | 6.20 |
| C-21 | 0.45 | 1.80 | — | — | 6.30 |
| C-22 | 1.25 | 1.27 | — | — | 6.31 |
| C-23 | 2.10 | — | 0.55 | — | 6.40 |
| C-24 | 1.15 | — | — | 0.85 | 6.55 |
| C-25 | 0.69 | 1.74 | — | — | 6.60 |
| C-26 | 0.35 | 2.03 | — | — | 6.79 |
| C-27 | 0.90 | 1.67 | — | — | 6.81 |
| C-28 | 1.35 | 1.37 | — | — | 6.81 |
| C-29 | 2.40 | — | — | 0.42 | 6.90 |
| C-30 | 0.65 | 1.90 | — | — | 7.00 |
| C-31 | 1.35 | — | — | 0.91 | 7.25 |
| C-32 | 1.05 | 1.73 | — | — | 7.29 |
| C-33 | 0.25 | 2.33 | — | — | 7.49 |
| C-34 | 0.55 | 2.13 | — | — | 7.49 |
| C-35 | 1.05 | 1.80 | — | — | 7.50 |
| C-36 | 1.85 | — | 0.95 | — | 7.50 |
| C-37 | 2.10 | — | — | 0.66 | 7.50 |
| C-38 | 0.10 | 2.60 | — | — | 8.00 |
| C-39 | 1.00 | — | 1.5 | — | 8.00 |
| C-40 | 1.20 | — | 1.65 | — | 9.00 |
| C-41 | 1.30 | — | — | 1.38 | 9.50 |

In Table 2, the Ac, Pr and Bu of the acyl group replacement ratio indicate the same groups as those of Table 1. “Pe” denotes n-pentanyl group. The total number of the carbon atoms in the acyl group was calculated in the same procedure as that of Table 1.

(Manufacturing the Film)

<Film F-1>

100 parts by mass of cellulose acylate C-1; 10 parts by mass of the aforementioned KA-61 as a plasticizer; 0.5 parts by mass of pentaerithritol tetrakis [3-(3,5-di-tert-butyl-4-hydroxy phenyl) propionate] (Irganox 1010 (made by Ciba Specialty Chemicals K.K. as a commercially available product) as a compound expressed by the aforementioned general formula (1); 0.25 parts by mass of the aforementioned HON-1 as a phosphoric acid compound; 1.5 parts by mass of 2-(2H-benzotriazole-2-yl)-6-(1-methyl-1-phenylethyl)-4-(1,1,3,3-tetramethyl butyl)phenol (TINUVIN 928 (made by Ciba Specialty Chemicals K.K.) as a commercially available product) as an ultraviolet absorber; and 0.3 parts by mass of particles silica (the average primary particle size 16 μm) (AEROSIL R972V (made by Nippon Aerosil Co., Ltd.) as a commercially available product) as a matting agent were mixed and were dried under reduced pressure at a temperature of 60° C. for five hours. This cellulose acylate composition was melted and mixed at 235° C. using a twin screw extruder, whereby pellets were obtained. In this case, to reduce heat generation due to shearing at the time of kneading, an all-screw type screw—not a kneading disk—was utilized. Further, vacuum was produced through a vent hole, and the volatile components generated during kneading were removed by vacuum suction. To avoid moisture absorption into the resin, a dry nitrogen atmosphere was used in the space between the feed and hopper for supply to the extruder, and the cooling tank from the extrusion dies.

The film was formed using the film manufacturing apparatus of FIG. 1.

The first cooling roll and second cooling roll were made of stainless steel having a diameter of 40 cm, and the surface was provided with hard chromium plating. A temperature adjusting oil (coolant fluid) was circulated inside to control the roll surface temperature. The elastic touch roll had a diameter of 20 cm and the inner sleeve and outer sleeve were made of stainless steel. The surface of the outer sleeve was provided with hard chromium plating. The outer sleeve had a wall thickness of 2 mm, and a temperature adjusting oil (coolant fluid) was circulated in the space between the inner sleeve and outer sleeve, whereby the surface temperature of the elastic touch roll was controlled.

Using a single screw extruder, the pellets having been obtained (moisture regain: 50 ppm) was melt-extruded in the form of a film at a melting temperature of 250° C. through the T-die onto the first cooling roll having a surface temperature of 100° C. This was drawn at a draw ratio of 20, whereby a cast film having a thickness of 80 μm was produced. In this case, the T-die used had a lip clearance of 1.5 mm and a lip section average surface roughness of Ra 0.01 μm. Further, silica particles as a lubricant were added in the amount equivalent to 0.1 parts by mass through the hopper opening of the extruder intermediate section.

Further, on the first cooling roll, an elastic touch roll having a 2 mm-thick metal surface was pressed against the film at a linear pressure of 10 kg/cm. The film temperature on the side of the touch roll at the time of pressing was 180° C.±1° C. (The film temperature on the touch roll side at the time of pressing in the sense in which it is used here refers to the average value of the film surface temperatures of the film at the position in contact with the touch roll on the first roll (cooling roll), wherein these temperatures were measured at 50 points by a non-contact thermometer across the width at a position 50 cm away by retracting the touch roll so that there was no touch roll. The glass transition temperature Tg of this film was 136° C. (The glass transition temperature of the film extruded by the die was measured according to the DSC method (temperature rise at 10° C. per minute in nitrogen) using the DSC6200 of Seiko Co., Ltd.

The surface temperature of the elastic touch roll was 100° C., and the surface temperature of the second cooling roll was 30° C. The surface temperatures of the elastic touch roll, the first cooling roll and second cooling roll were obtained as follows: The temperatures of the roll surface 90 degrees before in the direction of rotation from the position wherein the film contacts the roll for the first time were measured across the width at ten points using a non-contact thermometer. The average of these measurements was used as the surface temperature of each roll.

The film having been obtained was introduced into a tenter having a preheating zone, drawing zone, retaining zone, and cooling zone (as well as the neutral zones to ensure heat insulation between zones). It was drawn to 130% across the width. After that, the film was loosened 2% across the width and temperature was reduced to 70° C. Then the film was released from the clip and the clip holding section was trimmed off. Both ends of the film were knurled to a width of 10 mm and a height of 5 μm. The film was slit to a width of 1430 mm, whereby a film F-1 having a thickness of 80 μm was produced. In this case, the preheating temperature and retaining temperature were adjusted to avoid bowing resulting from the process of drawing. No residual solvent was detected from the film F-1 having been produced.

<Film F-2 through F-41>

Films F-2 through F-41 were produced by the same procedure as that of the film F-1, except that 100 parts by mass of cellulose acylate shown in Table 3; 10 parts by mass of plasticizer; 0.5 parts by mass of the compound expressed by the aforementioned general formula (1); 0.25 parts by mass of phosphoric acid compound; 0.3 parts by mass of other additives; 1.5 parts by mass of TINUVIN 928 (made by Ciba Specialty Chemicals K.K.) as an ultraviolet absorber; and 0.3 parts by mass of AEROSIL R972V as a matting agent were used at melting temperatures shown in Table 3, wherein the presence or absence of the elastic touch roll is as shown in Table 3. The amount of extrusion and take-up speed were adjusted to ensure that the thickness of the film was 80 μm.

TABLE 3

| | | | Compound of | | | | Elastic | |
|---|---|---|---|---|---|---|---|---|
| Film | Cellulose | | general | Phosphorus | Other | Film manufacturing | touch | |
| No. | acylate | Plasticizer | formula (1) | compound | additives | temperature | roll | Remarks |
| F-1 | C-1 | KA-61 | Irganox 1010 | HON-1 | — | 260 | Present | Inv. |
| F-2 | C-2 | KA-61 | Irganox 245 | HON-2 | — | 250 | Present | Inv. |
| F-3 | C-3 | KA-61 | Irganox 1010 | — | — | 240 | Present | Comp. |
| F-4 | C-4 | KA-61 | Irganox 259 | — | — | 250 | Present | Comp. |
| F-5 | C-5 | KA-61 | Irganox 1010 | HON-1 | — | 240 | Present | Inv. |
| F-6 | C-6 | KA-62 | Irganox 1010 | HON-2 | Compound 103 | 240 | Present | Inv. |
| F-7 | C-7 | KA-61 | Irganox 1076 | HIT-2 | — | 240 | Present | Inv. |
| F-8 | C-8 | KA-62 | Irganox 245 | HIT-5 | — | 230 | Present | Inv. |
| F-9 | C-9 | KA-61 | Irganox 1010 | HON-1 | — | 260 | Absent | Comp. |
| F-10 | C-10 | KA-62 | Irganox 1010 | HON-2 | — | 240 | Absent | Comp. |
| F-11 | C-11 | KA-61 | Irganox 1010 | HIF-6 | — | 230 | Present | Inv. |
| F-12 | C-12 | KA-62 | Irganox 1010 | HON-1 | Compound 103 | 240 | Present | Inv. |
| F-13 | C-13 | KA-61 | — | HON-1 | — | 250 | Present | Comp. |
| F-14 | C-14 | KA-61 | — | HAN-9 | — | 250 | Present | Comp. |
| F-15 | C-15 | KA-61 | Irganox 1010 | HIT-6 | — | 250 | Present | Inv. |
| F-16 | C-16 | KA-62 | Irganox 1010 | HON-2 | Compound 103 | 250 | Present | Inv. |
| F-17 | C-17 | KA-61 | Irganox 1010 | — | Compound 103 | 240 | Present | Comp. |
| F-18 | C-18 | KA-61 | — | HIT-6 | Compound 103 | 250 | Present | Comp. |
| F-19 | C-19 | KA-61 | Irganox 1010 | HON-1 | — | 250 | Present | Inv. |
| F-20 | C-20 | KA-62 | Irganox 1010 | HIT-6 | — | 250 | Present | Inv. |
| F-21 | C-21 | KA-61 | Irganox 1010 | HON-1 | — | 240 | Present | Inv. |
| F-22 | C-22 | KA-62 | Irganox 1010 | HON-1 | Compound 103 | 240 | Present | Inv. |
| F-23 | C-23 | KA-61 | Irganox 1010 | HON-1 | — | 240 | Present | Inv. |
| F-24 | C-24 | KA-62 | Irganox 1010 | HON-2 | — | 240 | Present | Inv. |
| F-25 | C-25 | KA-61 | Irganox 1010 | HIT-5 | — | 240 | Absent | Comp. |
| F-26 | C-26 | KA-61 | Irganox 1010 | HIT-6 | — | 240 | Absent | Comp. |
| F-27 | C-27 | KA-61 | Irganox 1010 | HON-1 | — | 240 | Present | Inv. |
| F-28 | C-28 | KA-62 | Irganox 1010 | HON-1 | Compound 103 | 240 | Present | Inv. |
| F-29 | C-29 | KA-61 | Irganox 1010 | HON-2 | — | 240 | Present | Inv. |
| F-30 | C-30 | KA-62 | Irganox 1010 | HIT-6 | — | 240 | Present | Inv. |
| F-31 | C-31 | KA-61 | Irganox 1010 | HON-1 | — | 240 | Present | Inv. |
| F-32 | C-32 | KA-62 | Irganox 1010 | HON-2 | — | 240 | Present | Inv. |
| F-33 | C-33 | KA-61 | Irganox 1010 | HON-1 | — | 240 | Absent | Comp. |
| F-34 | C-34 | KA-61 | Irganox 1010 | HON-2 | — | 240 | Absent | Comp. |
| F-35 | C-35 | KA-62 | Irganox 1010 | HIT-6 | — | 240 | Present | Inv. |
| F-36 | C-36 | KA-61 | Irganox 1010 | HON-1 | — | 240 | Present | Inv. |
| F-37 | C-37 | KA-62 | Irganox 1010 | HIT-2 | — | 240 | Present | Inv. |
| F-38 | C-38 | KA-61 | Irganox 1010 | HIN-7 | — | 240 | Present | Inv. |
| F-39 | C-39 | KA-62 | Irganox 1010 | HAN-10 | — | 240 | Present | Inv. |
| F-40 | C-40 | KA-61 | — | — | — | 240 | Absent | Comp. |
| F-41 | C-41 | KA-62 | — | — | — | 250 | Absent | Comp. |

Inv.: Present invention,
Comp.: Comparison

IRGANOX-245 (made by Ciba Specialty Chemicals K.K.): ethylene bis(oxyethylene) bis 3-(5-tert-butyl-4-hydroxy-m-tolyl) propionate]

IRGANOX-259 (made by Ciba Specialty Chemicals K.K.): hexamethylene bis 3-(3,5-di-tert-butyl-4-hydroxy phenyl) propionate]

IRGANOX-1010 (made by Ciba Specialty Chemicals K.K.): pentaerithritol tetrakis [3-(3,5-di-tert-butyl-4-hydroxy phenyl) propionate]

IRGANOX-1076 (made by Ciba Specialty Chemicals K.K.): octadesyl-3-(3,5-di-tert-butyl-4-hydroxy phenyl) propionate

(Alkaline Saponification of the Material)

In the saponification of the film having been produced, saponification, rinsing, neutralization and rinsing were carried out in that order under the following conditions. The film was dried at 80° C., whereby a saponified film was produced.

| | |
|---|---|
| Saponification process: | 2 mol/L of sodium hydroxide |

| | 50° C. | 90 seconds |
|---|---|---|
| Rinsing process: Water | 30° C. | 45 seconds |
| Neutralization process | 10% by mass of hydrochloric acid | |
| | 30° C. | 45 seconds |
| Rinsing process: Water | | |

(Evaluation)

The film was evaluated by rating the film mechanical strength, saponifiability and film melting film formation performances.

(Film Mechanical Strength)

The film elongation at break was measured in the film making direction at room temperature using a mechanical strength tester TESSILON. The evaluation was made according to the following criteria:

A: 30% or more

B: 20% or more through 30% exclusive

C: 10% or more through 20% exclusive

D: elongation at break is less than 10%.

(Saponifiability)

To evaluate the saponifiability, the static contact angle of the film surface with reference to water after saponification was measured. The static contact angle was measured according to the θ/2 method using an automatic surface tensiometer (CA-V made by Kyowa Kaimenkagaku Co., Ltd.). The average value of five measurements across the width was used as the evaluation value. The evaluation was made according to the following criteria for rating the static contact angle:

A: less than 35 degrees

B: 35 degrees or more through 45 degrees exclusive

C: 45 degrees or more through 50 degrees exclusive

D: 50 degrees or more

(Melting Formation Performance of Film)

The film thickness was measured at ten points at intervals of 5 cm along the length and cross the width, whereby the standard deviation of the film thickness was calculated. Evaluation was made according to the following criteria for standard deviation:

A: 2 μm less

B: 2 μm or more through 5 μm exclusive

C: 5 μm or more through 10 μm exclusive

D: 10 μm or more (moisture permeability was measured)

The moisture permeability was measured according to the procedure specified in the JIS Z0208. Measurement was made at a temperature of 40° C. with a relative humidity of 90% RH.

A: 500 g/m²/day or less

B: 500 g/m²/day or more through 600 g/m²/day exclusive

C: 600 g/m²/day or more through 700 g/m²/day exclusive

D: 700 g/m²/day or more

(Bleedout Evaluation)

After moisture conditioning was made at a temperature of 23° C. with a relative humidity of 55% RH, the film was subjected to a wiping test using rags. Then bleeding test was conducted using a felt tipped pen (Magic Marker).

D: Marks of rags remaining on the film surface after wiping

C: Bleeding remaining on the film after a felt tipped pen was applied thereon

B: Any one of these phenomena observed to a slight degree

A: None of these phenomena

(YI Measurement)

The absorption spectrum of the cellulose ester film having been produced was measured using a Spectrophotometer Model U-3310 (made by Hitachi High Technologies Co., Ltd.), and the tristimulus values X, Y and Z were calculated. Based on these tristimulus values X, Y and Z, the yellow index YI was calculated according to the JIS-K 7103.

A: 1.0 or less

B: 1.0 or more through 2.0 exclusive

C: 2.0 or more through 4.0 exclusive

D: 4.0 or more

(Flatness Evaluation)

Sampling was made one hour after the process of melting film formation was started, and a sample having a length of 100 cm with a width of 40 cm was cut out.

A sheet of black paper was applied on a flat desk and the aforementioned material film was placed thereon. The images of three fluorescent lamps placed in an upward slanting direction were reflected on the film, and the flatness was evaluated by checking how the images of the fluorescent lamps were bent. The flatness was evaluated according to the following criteria:

A: All images of the three fluorescent lamps appear straight and upright without being bent.

B: Fluorescent lamps appear slightly bent in some places.

C: Fluorescent lamps appear bent.

D: Fluorescent lamps appear winding.

(Horseback Failure)

The evaluation was made by following method. The cellulose ester film web material 120 wound onto the winding core 110. It was wrapped twice by the polyethylene sheet (not illustrated) and was put in the box with being held by the support plate 117 on the supporting counter 118 that support the winding core 110 as illustrated by FIG. 8(a)-8(c). Then the web was stored at a temperature of 25° C. with a relative humidity of 50% RH for 30 days. After that, the web was removed from the box. The polyethylene sheet was opened and the tube of the fluorescent lamp lighting on the surface of the cellulose ester film web material was reflected thereon so that distortion or minute irregularities were observed. Thus, the horseback failure was evaluated according to the following criteria:

A: Fluorescent lamps appear straight and upright without being bent.

B: Fluorescent lamps appear slightly bent in some places.

C: Fluorescent lamps appear partially bent.

D: Fluorescent lamps appear mottled.

TABLE 4

| | Evaluation | | | | | | | | |
|---|---|---|---|---|---|---|---|---|---|
| | | | Melt film | | | | | | |
| Film | Mechanical | | formation | | Moisture | | | Horseback | |
| No. | strength | Saponifiability | performance | Flatness | permeability | Bleedout | Y1 | failure | Remarks |
| F-1 | B | B | C | C | B | B | C | B | Inv. |
| F-2 | B | B | B | B | B | B | B | B | Inv. |
| F-3 | D | D | B | C | C | C | D | C | Comp. |
| F-4 | C | C | D | C | D | D | C | C | Comp. |
| F-5 | B | B | B | A | B | B | B | A | Inv. |
| F-6 | B | B | B | A | B | A | A | A | Inv. |
| F-7 | B | B | A | A | B | B | A | A | Inv. |
| F-8 | B | C | B | A | B | B | B | B | Inv. |
| F-9 | B | B | D | D | D | D | D | D | Comp. |
| F-10 | D | D | C | D | C | C | C | D | Comp. |
| F-11 | B | B | B | A | B | B | B | B | Inv. |
| F-12 | B | B | B | A | B | B | B | B | Inv. |
| F-13 | C | C | D | C | B | D | D | D | Comp. |
| F-14 | C | C | D | C | B | D | D | D | Comp. |
| F-15 | B | B | B | B | B | B | A | B | Inv. |
| F-16 | B | B | B | B | B | B | A | B | Inv. |
| F-17 | D | D | C | C | C | C | D | D | Comp. |
| F-18 | C | C | D | C | C | D | D | D | Comp. |
| F-19 | A | A | B | A | B | B | B | A | Inv. |
| F-20 | A | A | B | A | B | B | A | A | Inv. |
| F-21 | B | B | A | A | B | A | A | A | Inv. |
| F-22 | A | A | B | A | B | B | B | A | Inv. |
| F-23 | A | A | B | A | B | A | B | A | Inv. |
| F-24 | A | A | B | A | B | B | A | A | Inv. |
| F-25 | D | D | C | D | C | C | C | D | Comp. |
| F-26 | D | D | C | D | C | C | C | D | Comp. |
| F-27 | B | B | B | A | B | B | B | A | Inv. |
| F-28 | A | A | B | A | B | B | A | A | Inv. |
| F-29 | A | A | B | A | B | A | B | A | Inv. |
| F-30 | B | B | A | A | B | B | A | A | Inv. |
| F-31 | A | A | B | A | B | B | A | A | Inv. |
| F-32 | B | B | A | A | B | B | A | A | Inv. |
| F-33 | D | D | C | D | C | C | C | D | Comp. |
| F-34 | D | D | C | D | C | C | C | D | Comp. |
| F-35 | B | B | A | A | B | B | A | A | Inv. |
| F-36 | A | A | B | A | A | B | A | A | Inv. |
| F-37 | A | A | B | A | B | A | A | A | Inv. |
| F-38 | B | C | B | B | B | B | A | B | Inv. |
| F-39 | B | C | B | B | A | B | A | B | Inv. |
| F-40 | D | C | C | D | C | C | C | D | Comp. |
| F-41 | D | C | C | D | C | C | C | D | Comp. |

Inv.: Present invention,
Comp.: Comparison

It has been made clear that, as compared with the material of the Comparative example, the film produced by the film manufacturing method of the present invention shown in Table 4 is characterized by reduced coloring or deterioration of processing stability, and by superb flatness and excellent productivity, free from deformation trouble of film web. It has also been clarified that, when the production method of the present invention is applied to the acyl group of cellulose acylate with the total number of carbon atoms ranging 6.2 or more without exceeding 7.5, the film performance and productivity are further improved.

(Manufacturing the Polarizing Plate)

The cellulose acylate films F1 through F41 having been produced by the aforementioned procedure were subjected to the following treatment of alkaline saponification to produce polarizing plated 1 through 41, respectively.

(Alkaline Saponification Treatment)

| | |
|---|---|
| Saponification process | 2 mol/L of NaOH |

| | | |
|---|---|---|
| | 50° C. | 90 seconds |
| Rinsing process Water | 30° C. | 45 seconds |

| | |
|---|---|
| Neutralization process | 10% by mass of HCl |

| | | |
|---|---|---|
| | 30° C. | 45 seconds |
| Rinsing process Water | 30° C. | 45 seconds |

After saponification, the sample was subjected to the treatments of rinsing, neutralization and rinsing in that order, and was dried at 80° C.

(Manufacturing the Polarizer)

A longer roll polyvinyl alcohol film having a thickness of 120 μm was immersed in 100 parts by mass of aqueous solution containing 1 part by mass of iodine and 4 parts by mass of boric acid. It was drawn to a length of 600% at 50° C., whereby a polarizer was produced.

The cellulose acylate films having been produced by the aforementioned procedure were bonded on both sides of the polarizer from both surfaces wherein the surface treated by alkaline saponification was placed on the side of polarizer and aqueous solution containing 5% by mass of fully saponifiable polyvinyl alcohol was used as an adhesive, whereby a polarizing plate bonded with protective film for polarizing plate was produced.

(Evaluation of Characteristics as a Liquid Crystal Display Apparatus)

The polarizing plate of the 32 TFT Type color liquid crystal display VEGA (by Sony Corp.) was removed, and each of the polarizing plates produced in the aforementioned procedure was trimmed off according to the size of the liquid crystal cell. Two polarizing plates produced in the aforementioned procedure were bonded to be perpendicular to each other in such a way that the polarized axis of the polarizing plate does not change from the original axis so as to sandwich the liquid crystal cell, whereby the 32 TFT Type color liquid crystal display was produced. Then evaluation was made to check the characteristics as the polarizing plate of the cellulose acylate film. It was demonstrated that the polarizing plate manufactured from the cellulose acylate film of the present invention was characterized by excellent contrast and superb display performances. This has verified the excellent characteristics as a polarizing plate for such an image display apparatus as a liquid crystal display.

### Example 2

### Production of an Antireflection Film and a Polarizing Plate

By the use of cellulose acylate films F-1 to F-41 produced in Example 1, a hard coat layer and an antireflection layer were formed on one surface of these films, whereby antireflection films with a hard coat were produced. Further, by the use of these films, polarizing plates P-1 to P-41 were produced.

(Hard Coat Layer)

The following hard coat layer compositions were coated such that the thickness of a dried coated layer become 3.5 μm, and then the coated layer was dried for 1 minute at 80° C. Next, the layer was harden on the condition of 150 mJ/cm² with a high pressure mercury lamp (80 W), whereby hard coat films with a hard coat layer were produced. The refractive index of the hard coat layer was 1.50.

(Hard Coat Layer Composition (C-1))

| | |
|---|---|
| Dipenta erythritol hexa acrylate (including a | 108 parts by mass |
| component more than a dimer in an amount | |
| of about 20%) | |
| Irgacure 184 (manufactured by Ciba | 2 parts by mass |
| Specialty Chemicals Inc.) | |
| Propyleneglycolmonomethylether | 180 parts by mass |
| Ethylacetate | 120 parts by mass |

(Medium Refractive Index Layer)

On the hard coat layer of the above-mentioned hard court film, the following medium refractive-index layer compositions were coated with an extrusion coater, and were dried for 1 minute on the conditions of 80° C. and 0.1 m/second. At this time, until dry completion with finger contact (a condition that a dry status that the coated surface has been dried is sensed with a finger touching on the coated surface, a non-contact type floater was used. As the non-contact type floater, a horizontal floater type air dumper manufactured by Belmatick Co. was used in such a way that a floater inner static pressure was 9.8 kPa and the coated film was floated uniformly by about 2 mm in widthwise and conveyed. After the coated layer was dried, the layer was cured by the irradiation of ultraviolet rays with 130 mJ/cm² by a high pressure mercury lamp (80 W), whereby a medium refractive index layer film with the medium refractive index layer was produced. The medium refractive index layer of the medium refractive index layer film has a thickness of 84 nm and a refractive index of 1.66.

(Medium Refractive Index Layer Compositions)

| | |
|---|---|
| 20% ITO particle dispersion (the mean particle size of | 100 g |
| 70 nm, isopropyl alcohol solution) | |
| Dipenta erythritol hexa acrylate | 6.4 g |
| Irgacure 184 (manufactured by Ciba Specialty Chemicals | 1.6 g |
| Inc.) | |
| Tetrabutoxytitanium | 4.0 g |
| 10% FZ-2207 (manufactured by Nippon Unicar Company, | 3.0 g |
| propylene-glycol-monomethyl-ether solution) | |
| Isopropyl alcohol | 530 g |
| Methyl ethyl ketone | 90 g |
| Propyleneglycolmonomethylether | 265 g |

(High Refractive Index Layer)

On the medium refractive index layer, the following high refractive index layer compositions were coated with an extrusion coater, and were dried for 1 minute on the conditions of 80° C. and 0.1 m/second. At this time, until a dry completion with a finger contact (a condition that a dry status that the coated surface has been dried is sensed with a finger touching on the coated surface, a non-contact type floater was used. The non-contact type floater was used on the same condition of the medium refractive index layer. After the coated layer was dried, the layer was cured by the irradiation of ultraviolet rays with 130 mJ/cm² by a high pressure mercury lamp (80 W), whereby a high refractive index layer film with the high refractive index layer was produced.

(High Refractive Index Layer Compositions)

| | |
|---|---|
| Tetra(n)butoxytitanium | 95 parts by mass |
| Dimethylpolysiloxane (KF-96-1000CS | 1 parts by mass |
| manufactured by Shin-Etsu chemical company) | |
| γ-methacryloxypropyltrimethoxysilan (KBM503 | 5 parts by mass |
| manufactured by Shin-Etsu chemical company) | |
| Propylene glycol monomethyl ether | 1750 parts by mass |
| Isopropyl alcohol | 3450 parts by mass |
| Methyl ethyl ketone | 600 parts by mass |

In this connection, the high refractive index layer of this high refractive index layer film had a thickness of 50 μm and a refractive index of 1.82.

(Low Refractive Index Layer)

Firstly, silica type particles (hollow particles) were prepared.

(Preparation of Silica Type Particles P-1)

A mixture of 100 g of silicasol having an average particle size of 5 nm and a SiO₂ concentration of 20% by mass and 190 g of pure water was heated to 80° C. The result reaction mother solution had pH of 10.5. Into this reaction mother solution, 9000 g of a sodium silicate aqueous solution containing 0.98% by mass of silicate as SiO₂ and 9000 g of a sodium aluminate aqueous solution containing 1.02% by mass of aluminate as Al₂O₃ were added simultaneously. During this time, the temperature of the reaction solution was kept at 80° C. The pH of the reaction solution rose to 12.5 immediately after the addition of those solutions, thereafter, the pH hardly changed. After the completion of the addition, the reaction solution was cooled down to room temperature and was washed with a ultrafiltration membrane, whereby a SiO₂—Al₂O₃ core particle dispersion solution having a solid concentration of 20% by mass was prepared. (Process (a))

Into 500 g of this core particle dispersion solution, 1700 g of pure water was added, and the solution was warmed to 98° C. While keeping this temperature, 3000 g of silicic acid liquid (a SiO2 concentration of 3.5% by mass) obtained by the dealkalization of a sodium silicate aqueous solution with a cation exchange resin was added, thereby obtaining a dispersion solution of core particles on which a first silica covering layer was formed. (Process (b))

Next, a dealuminization treatment was conducted in such a way that into 500 g of the core particle dispersion solution in which the first silica covering layer washed with an ultrafiltration membrane so as to have a solid concentration of 13% by mass was formed, 1125 g of pure water was added, and further a concentrated hydrochloric acid (35.5%) was dropped so as to make the pH of the solution 1.0. Subsequently, while adding 10 L of a hydrochloric acid aqueous solution having pH of 3 and 5 L of pure water, aluminium salts dissolved by the ultrafiltration membrane was separated, whereby a part of constituting components of the core particles formed with the first silica covering layer was removed and a dispersion solution of SiO₂—Al₂O₃ porous particles was prepared. (Process (c))

A mixture of 1500 g of the above porous particle dispersion solution, 500 g of pure water, 1.750 g of ethanol and 626 g of a 28% aqueous ammonia was heated to 35° C., thereafter, 104 g of ethyl silicate (28% by mass of SiO₂) was added so as to cover the surface of the porous particles formed with the first silica covering layer with a hydrolysis polycondensation of the ethyl silicate, thereby forming a second silica covering layer. Subsequently, a silica type particle dispersion liquid whose solvent was substituted with ethanol by the use of an ultrafiltration membrane and which has a solid concentration of 20% by mass was prepared. The thickness of the first silica covering layer, the average particle size, MOx/SiO2 (mol ratio) and the refractive index of the silica type particles are indicated in Table 5. Here, the average particle size was measured by a dynamic-light-scattering method and the refractive index was measured by the following method with the use of Series A, AA produced by CARGILL company as a reference refractive liquid.

TABLE 5

| | | | Silica | | | | | |
|---|---|---|---|---|---|---|---|---|
| | | | Covering | | | | | |
| | | | Layer | | | Silica | | |
| | Core | | Thickness | Thickness | | Microparticle | | |
| | particle | | of | of | Outer | | Average | |
| | | MOₓ/SiO₂ | 1^{st} | 2^{nd} | Shell | MOₓ/SiO₂ | particle | |
| | | mol | Layer | Layer | Thickness | mol | diameter | Refractive |
| No. | Kinds | ratio | (nm) | (nm) | (nm) | ratio | (nm) | Index |
| P-1 | Al/Si | 0.5 | 3 | 5 | 8 | 0.0017 | 47 | 1.28 |

(Measuring Method for Refractive Index of Particle)

(1) taking a particle dispersion liquid into an evaporator and evaporating a dispersion medium;

(2) drying this at 120° C. to obtain a powder;

(3) dropping 2 or 3 drops of the reference refractive liquid having a known refractive index onto a glass plate and mixing the drops with the powder;

(4) conducting the operation (3) with various reference refractive index liquids, and the refractive index of a reference index liquid when the mixture becomes transparent, is made as a refractive index of colloidal particles.

(Formation of Low Refractive Index Layer)

In a matrix in which 95% by mol of Si(OC₂H₅)₄ and 5% by mol of C₃F₇— (OC₃F₆)₂₄—O—(CF₂)₂—C₂H₄—O—CH₂Si(OCH₃)₃ were mixed, 35% by mass of the above silica type particles P-1 having an average particle size of 60 nm was added, the resultant material was diluted with a solvent with the use of a catalyst of 1.0N—HCl, whereby a low refractive index coating agent was produced. A coating solution was coated with a layer thickness of 100 nm on the above actinic ray curable resin layer or the high refractive index layer with the use of a die coater method, was dried at 120° C. for one minute. Thereafter, by irradiation with ultraviolet rays, a low refractive index layer having a refractive index of 1.37 was formed.

By the above manners, an antireflection film was produced.

Subsequently, a polyvinyl alcohol film having a thickness of 120 μm was subjected to an uniaxial stretching process (temperature of 110° C., draw magnification of 5 times). The resultant film was immersed in an aqueous solution including 0.075 g of iodine, 5 g of potassium iodide and 100 g of water for 60 seconds, and then further immersed in an aqueous solution including 6 g of potassium iodide, 7.5 g of boric acid and 100 g of water and being 68° C. And then, this film was washed with water and dried, whereby a polarizing film was obtained.

Next, in accordance with the following processes 1 to 5, the polarizing film, the above antireflection film, and a cellulose acylate film at a back side were pasted together, whereby a polarizing plate was produced. As a polarizing plate protective film at a back surface side, cellulose acylate films F1 to F41 produced in Example 1 were used without change. And, polarizing plates P1 to P41 were prepared by combinations of one in which a hard coat layer and a antireflection film were formed at its another side or one in which a hard coat layer and a antireflection film were not formed at the another side.

Process 1: The above antireflection film was obtained in such a way that it was immersed in 2 mol/L of a sodium hydroxide solution being 60° C. for 90 seconds and then dried and washed with water and its one side to be pasted with a polarizer was saponified.

Process 2: The polarizing film was immersed in a bath of a polyvinyl alcohol adhesive having a solid component of 2% by mass for 1 to 2 seconds.

Process 3: An excessive amount of adhesive adhering on the polarizing film in Process 2 was removed by being lightly wiped and the polarizing film was laminated on the film processed in Process 1.

Process 4: The antireflection film sample laminated in Process 3, a polarizing film and a cellulose acylate film were pasted with a pressure of 20 to 30 N/cm² and a conveying speed of about 2 m/minute.

Process 5: Samples in which the polarizing film, the cellulose acylate film and the reflection protective film were pasted in Process 4 were dried for 2 minutes in a drying device at 80° C., whereby polarizing plates were produced.

The polarizing plates produced as mentioned above were subjected to a polarizing plate durability test mentioned below.

(Polarizing Plate Durability Test)

Samples of two sheets with dimensions of (10 cm×10 cm) of the polarizing plates P1 to P41 produced above were subjected to a heat treatment (80° C., 90% RH, 50 hours). On a vertical condition, the length of larger one among edge-whitened portions at a longitudinal or transverse center line portion was measured and the measurement results were judged on the following criterion.

The edge-whitened portion means that edge portions of a polarizing plate expected not to transmit light on a vertical condition becomes a situation to transmit light. This edge-whitened portion can be judged visually. On a condition as a polarizing plate, a situation that an indication on edge portions is not visible becomes a failure.

A: The edge-whitened portions are less than 5% (a level that there is no problem as a polarizing plate).

B: The edge-whitened portions are 5% or more and less than 10% (a level that there is no problem as a polarizing plate).

C: The edge-whitened portions are 10% or more and less than 20% (a level that there is a problem, but usable as a polarizing plate).

D: The edge-whitened portions are 20% or more (a level that there is a problem as a polarizing plate).

If the result is Grade C or higher, it is a level that there is no problem practically.

Test results are shown in Table 6.

TABLE 6

| Polarizing | Used Film | Polarizing plate | |
|---|---|---|---|
| Plate No. | No. | durability | Remarks |
| P-1 | F-1 | A | Inv. |
| P-2 | F-2 | B | Inv. |
| P-3 | F-3 | D | Comp. |
| P-4 | F-4 | D | Comp. |
| P-5 | F-5 | A | Inv. |
| P-6 | F-6 | B | Inv. |
| P-7 | F-7 | C | Inv. |
| P-8 | F-8 | C | Inv. |
| P-9 | F-9 | D | Comp. |
| P-10 | F-10 | D | Comp. |
| P-11 | F-11 | C | Inv. |
| P-12 | F-12 | A | Inv. |
| P-13 | F-13 | D | Comp. |
| P-14 | F-14 | D | Comp. |
| P-15 | F-15 | C | Inv. |
| P-16 | F-16 | B | Inv. |
| P-17 | F-17 | D | Comp. |
| P-18 | F-18 | D | Comp. |
| P-19 | F-19 | A | Inv. |
| P-20 | F-20 | C | Inv. |
| P-21 | F-21 | A | Inv. |
| P-22 | F-22 | A | Inv. |
| P-23 | F-23 | A | Inv. |
| P-24 | F-24 | B | Inv. |
| P-25 | F-25 | D | Comp. |
| P-26 | F-26 | D | Comp. |
| P-27 | F-27 | A | Inv. |
| P-28 | F-28 | A | Inv. |
| P-29 | F-29 | B | Inv. |
| P-30 | F-30 | C | Inv. |
| P-31 | F-31 | A | Inv. |
| P-32 | F-32 | B | Inv. |
| P-33 | F-33 | D | Comp. |
| P-34 | F-34 | D | Comp. |
| P-35 | F-35 | C | Inv. |
| P-36 | F-36 | A | Inv. |
| P-37 | F-37 | B | Inv. |
| P-38 | F-38 | B | Inv. |
| P-39 | F-39 | B | Inv. |
| P-40 | F-40 | D | Comp. |
| P-41 | F-41 | D | Comp. |

From Table 6, the polarizing plates of Inv. Example of the present invention are excellent in durability in comparison with Com. Examples. Especially, when phosphonite was used as a phosphorus compound used at the time of production, the durability becomes excellent.

(Production of Liquid Crystal Display Device)

The liquid crystal panel to conduct a view angle measurement was produced as follows and characteristics as a liquid crystal device was evaluated.

A polarizing plate previously pasted on a 15 type display VL-150SD manufactured by Fujitsu company was peeled off and the above-produced polarizing plates were pasted on a glass surface of a liquid crystal cell respectively.

At this time, the pasting orientation of the polarizing plates was determined such that the surface of the above antireflection film became a observed surface of the liquid crystal and an absorption axis is oriented to the same direction of the previously pasted polarizing plate, whereby each liquid crystal display device was produced respectively.

In the antireflection films produced by the used of the films of the present invention, there were few unevenness in hardness and few uneven streaks. Further, a polarizing plate and a liquid crystal display device which were applied with the film, had no problem in unevenness in reflection color, and showed a display quality excellent in contrast. In the antireflection film produced with the use of the films of Comp. Examples In Example 2, there were unevenness in hardness and uneven streaks, and a polarizing plate and a liquid crystal device which were applied with the film showed existence of unevenness in reflection color.

What is claimed is:

1. A cellulose acylate film manufacturing method, comprising the steps of:
extruding a heated and melted cellulose acylate material from a casting die in a form of a film, and
sandwiching the cellulose acylate film extruded from the casting die between an elastically deformable touch roll and a cooling roll with a pressure,
wherein the cellulose acylate film material includes at least one kind of a compound represented by the following general formula (1) and at least one kind of a phosphorus compound selected from a group consisting of phosphite, phosphonite, phosphinite and phosphane, 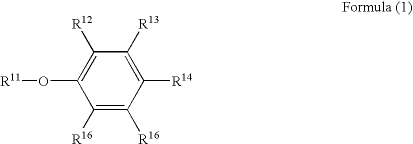
wherein R¹¹ through R¹⁶ each represents independently a hydrogen atom or substituents.

2. The cellulose acylate film manufacturing method described in claim 1, wherein the cellulose acylate in the cellulose acylate material used in the cellulose acylate film manufacturing method has an acyl group total carbon number of 6.2 or more and 7.5 or less, wherein the acyl group total carbon number is a total of a product of the substitution degree of each acyl group substituted into a glucose unit in the cellulose acylate and the number of carbons.

3. A cellulose acylate film manufactured by the manufacturing method described in claim 1.

4. The cellulose acylate film described in claim 3, wherein an actinic ray curable resin layer is provided on at least one surface of the cellulose acylate film.

5. The cellulose acylate film described in claim 4, wherein an antireflection layer is provided on the actinic ray curable resin layer.

6. A polarizing plate, comprising:
a polarizer, and
a polarizing plate protective film structured with the cellulose acylate film described in claim 1.

7. A liquid crystal display device, comprising:
a liquid crystal cell, and
the polarizing plate described in claim 6.
